(19) United States
(12) Patent Application Publication
(10) Pub. No.: US 2015/0195858 A1
(43) Pub. Date: Jul. 9, 2015

(54) METHODS, APPARATUS AND SYSTEMS FOR IMPLEMENTING HIERARCHICAL POLICY SERVERS AND FOR CONTROL OF COORDINATED FEMTOCELL-WIFI OPERATION IN CO-SITED DEPLOYMENTS

(71) Applicant: INTERDIGITAL PATENT HOLDINGS, INC., Wilmington, DE (US)

(72) Inventors: Hao Jin, King of Prussia, PA (US); John L Tomici, Southold, NY (US); Prabhakar R Chitrapu, Blue Bell, PA (US); Alexander Reznik, Titusville, NJ (US); John Cartmell, North Massapequa, NY (US); Bartosz Balazinski, Montreal (CA); Mario Hudon, Ste-Julie (CA); Samir Ferdi, Kirkland (CA)

(21) Appl. No.: 14/408,133

(22) PCT Filed: Jun. 17, 2013
(86) PCT No.: PCT/US2013/046174

§ 371 Date: Dec. 15, 2014

Related U.S. Application Data
(60) Provisional application No. 61/823,204, filed on May 14, 2013.
(60) Provisional application No. 61/662,997, filed on Jun. 22, 2012.

(51) Int. Cl. H04W 76/02; H04W 28/02

(52) U.S. Cl. CPC H04W 76/02; H04W 28/0268

(57) ABSTRACT

Systems, methods, and instrumentalities are disclosed to implement hierarchical policies for local networks. In one representative method, a first local node may establish a dedicated local IP access (LIPA) packet data network (PDN) connection for a local service provided via a local network. The method may include responsive to a request for access to the local service, the first local node receiving a quality of service (QoS) requirement for the requested local service; sending, to a second local node, a dedicated bearer request with a specified QoS level based on a global policy and network-information specific to the local network; and receiving a dedicated bearer response with the specified QoS level.

### CROSS REFERENCE TO RELATED APPLICATIONS

This Application claims the benefit of U.S. Provisional Application 61/662,997, filed Jun. 22, 2012 and U.S. Provisional Application 61/823,204, filed May 14, 2013, the content of each being incorporated by reference herein

### FIELD OF DISCLOSURE

This application relates to wireless communications and, in particular, methods, apparatus, and systems for implementing a hierarchical policy server and for control of coordinated femtocell-WiFi operation in co-sited deployments.

### BACKGROUND

In its initial response to an ever increasing bandwidth crunch, the wireless industry has been experimenting with a number of ad-hoc data offloading and tariffing schemes, which may offer partial and/or temporary relief.

Moreover, policies for such ad-hoc offloading and tariffing are generally supplied by a Central Policy Server (CPS) that may be used for the entire network and may have the role of distributing policies to UEs. The policies may contain sets of rules for routing the UE traffic through available interfaces.

### SUMMARY OF THE INVENTION

Systems, methods, and instrumentalities are disclosed to implement hierarchical policies for local networks. In one representative method, a first local node may establish a dedicated local IP access (LIPA) packet data network (PDN) connection for a local service provided via a local network. The method may include responsive to a request for access to the local service, the first local node receiving a quality of service (QoS) requirement for the requested local service; sending, to a second local node, a dedicated bearer request with a specified QoS level based on a global policy and network-information specific to the local network; and receiving a dedicated bearer response with the specified QoS level.

In another representative method, a local policy server (LPS) collocated with a local network may use a central policy server (CPS). The method may include the LPS receiving central policy information for operation of a wireless transmit/receive unit (WTRU); and generating, from the received central policy information, a local policy for operation of the WTRU, the local policy being based on at least the central policy information and information associated with the local network.

In a further representative method, a local node located in a local network may use a central node. The method may include the local node receiving a notification that a wireless transmit/receive unit (WTRU) is in a vicinity of the local network, determining whether a policy record or profile associated with the WTRU exists in the local network; and on a condition that the policy record or profile for the WTRU does not exist in the local network: requesting, from the central node, a policy record or profile associated with the WTRU, and receiving, from the central node, a response including the policy information or profile information associated with the WTRU.

### BRIEF DESCRIPTION OF THE DRAWINGS

A more detailed understanding may be had from the Detailed Description below, given by way of example in conjunction with drawings appended hereto. Figures in such drawings, like the detailed description, are examples. As such, the Figures and the detailed description are not to be considered limiting, and other equally effective examples are possible and likely. Furthermore, like reference numerals in the Figures indicate like elements, and wherein:

FIG. 1 is a system diagram illustrating an example communications system in which one or more disclosed embodiments may be implemented;

FIG. 2 is a system diagram illustrating an example wireless transmit/receive unit (WTRU) that may be used within the communications system illustrated in FIG. 1;

FIG. 3 is a system diagram illustrating an example radio access network and another example core network that may be used within the communications system illustrated in FIG. 1;

FIG. 4 is a system diagram illustrating another example radio access network and another example core network that may be used within the communications system illustrated in FIG. 1;

FIG. 5 is a system diagram illustrating a further example radio access network and a further example core network that may be used within the communications system illustrated in FIG. 1;

FIG. 6 is a diagram illustrating a representative multi-access network architecture/system;

FIG. 7 is a diagram illustrating a representative reference architecture/system;

FIG. 8 is a diagram illustrating a representative enterprise access network discovery and selection function (E-ANDSF) database update;

FIG. 9 is a diagram illustrating a representative E-ANDSF and policy and enterprise charging rules function (E-PCRF) database update;

FIG. 10 is a diagram illustrating a representative E-ANDSF assisted access selection for a WTRU initiated update;

FIG. 11 is a diagram illustrating a representative E-ANDSF assisted access selection for a network initiated update;

FIG. 12 is a diagram illustrating a representative dedicated LIPA PDN connection setup procedure;

FIG. 13 is a diagram illustrating a representative multi-RAT flow management procedure;

FIG. 14 is a diagram illustrating deployment of the CGW collocated with a local policy server (LPS);

FIG. 15 is a diagram illustrating integration of the ANDSF over a SOAP transport layer;

FIG. 16 is a diagram illustrating an interaction (e.g., a SOAP interaction) between a WTRU and a policy server;

FIG. 17 is a diagram illustrating a representative hierarchical policy server system using LPSs with validity areas;

FIG. 18 is a diagram illustrating a representative procedure for registration and redirection;

FIG. 19 is a flowchart illustrating a representative method implemented by a LPS;

FIG. 20 is a flowchart illustrating another representative method implemented by a LPS;

FIG. 21 is a flowchart illustrating a representative method implemented by a local node;

FIG. 22 is a flowchart illustrating a representative method implemented by an enterprise node;

FIG. 23 is a flowchart illustrating a representative method implemented by a WTRU;

FIG. 24 is a flowchart illustrating a further representative method implemented by a LPS;

FIG. 25 is a flowchart illustrating another representative method implemented by an enterprise node;

FIG. 26 is a flowchart illustrating a representative method implemented by an E-PCRF;

FIG. 27 is a flowchart illustrating a representative bandwidth assignment method;

FIG. 28 is a flowchart illustrating a representative method of local policy server discovery;

FIG. 29 is a flowchart illustrating a representative method using a central entity;

FIG. 30 is a flowchart illustrating another representative method using a central entity;

FIG. 31 is a flowchart illustrating a further representative method using a central entity;

FIG. 32 is a flowchart illustrating a representative method using a hierarchical policy server system; and

FIG. 33 is a flowchart illustrating a representative method using a local node.

### DETAILED DESCRIPTION

A detailed description of illustrative embodiments may now be described with reference to the figures. However, while the present invention may be described in connection with representative embodiments, it is not limited thereto and it is to be understood that other embodiments may be used or modifications and additions may be made to the described embodiments for performing the same function of the present invention without deviating therefrom.

Although the representative embodiments are generally shown hereafter using wireless network architectures, any number of different network architectures may be used including networks with wired components and/or wireless components, for example.

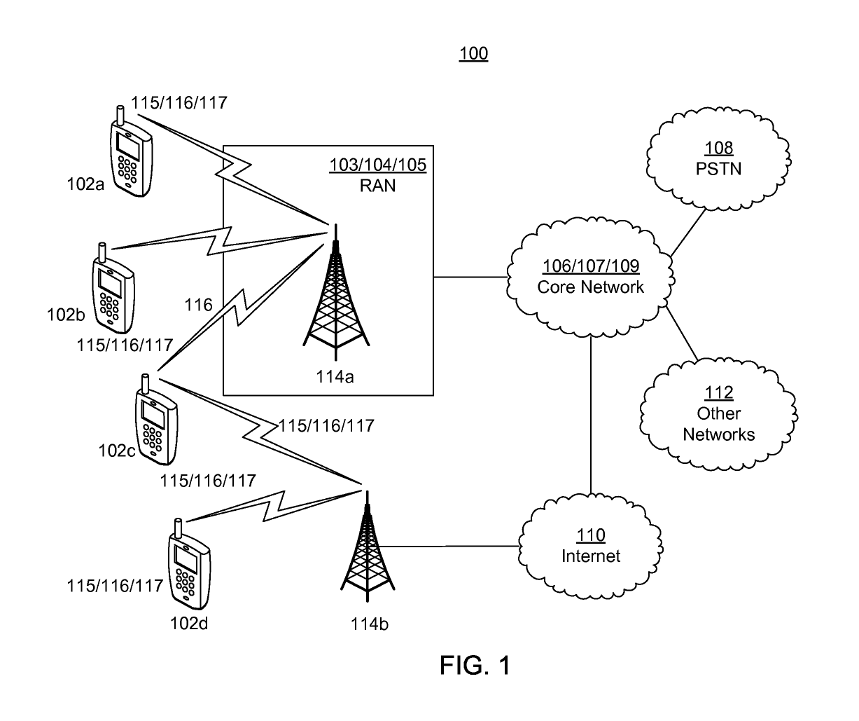

FIG. 1 is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), and the like.

As shown in FIG. 1, the communications system 100 may include wireless transmit/receive units (WTRUs) 102a, 102b, 102c, 102d, a radio access network (RAN) 104, a core network 106/107/109, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d may be configured to transmit and/or receive wireless signals and may include user equipment (UE), a mobile station, a fixed or mobile subscriber unit, a pager, a cellular telephone, a personal digital assistant (PDA), a smartphone, a laptop, a netbook, a personal computer, a wireless sensor, consumer electronics, and the like.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the core network 106/107/109, the Internet 110, and/or the other networks 112. By way of example, the base stations 114a, 114b may be a base transceiver station (BTS), a Node-B, an eNode B, a Home Node B, a Home eNode B, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 103/104/105, which may also include other base stations and/or network elements (not shown), such as a base station controller (BSC), a radio network controller (RNC), relay nodes, etc. The base station 114a and/or the base station 114b may be configured to transmit and/or receive wireless signals within a particular geographic region, which may be referred to as a cell (not shown). The cell may further be divided into cell sectors. For example, the cell associated with the base station 114a may be divided into three sectors. Thus, in one embodiment, the base station 114a may include three transceivers, i.e., one for each sector of the cell. In another embodiment, the base station 114a may employ multiple-input multiple output (MIMO) technology and may utilize multiple transceivers for each sector of the cell.

The base stations 114a, 114b may communicate with one or more of the WTRUs 102a, 102b, 102c, 102d over an air interface 115/116/117, which may be any suitable wireless communication link (e.g., radio frequency (RF), microwave, infrared (IR), ultraviolet (UV), visible light, etc.). The air interface 115/116/117 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 103/104/105 and the WTRUs 102a, 102b, 102c may implement a radio technology such as Universal Mobile Telecommunications System (UMTS) Terrestrial Radio Access (UTRA), which may establish the air interface 115/116/117 using wideband CDMA (WCDMA). WCDMA may include communication protocols such as High-Speed Packet Access (HSPA) and/or Evolved HSPA (HSPA+). HSPA may include High-Speed Downlink Packet Access (HSDPA) and/or High-Speed Uplink Packet Access (HSUPA).

In another embodiment, the base station 114a and the WTRUs 102a, 102b, 102c may implement a radio technology such as Evolved UMTS Terrestrial Radio Access (E-UTRA), which may establish the air interface 115/116/117 using Long Term Evolution (LTE) and/or LTE-Advanced (LTE-A).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1 may be a wireless router, Home Node B, Home eNode B, or access point, for example, and may utilize any suitable RAT for facilitating wireless connectivity in a localized area, such as a place of business, a home, a vehicle, a campus, and the like. In one embodiment, the base station 114b and the WTRUs 102c, 102d may implement a radio technology such as IEEE 802.11 to establish a wireless local area network (WLAN). In another embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, etc.) to establish a picocell or femtocell. As shown in FIG. 1, the base station 114b may have a direct connection to the Internet 110. Thus, the base station 114b may not be required to access the Internet 110 via the core network 106/107/109.

The RAN 103/104/105 may be in communication with the core network 106/107/109, which may be any type of network configured to provide voice, data, applications, and/or voice over internet protocol (VoIP) services to one or more of the WTRUs 102a, 102b, 102c, 102d. For example, the core network 106/107/109 may provide call control, billing services, mobile location-based services, pre-paid calling, Internet connectivity, video distribution, etc., and/or perform high-level security functions, such as user authentication. Although not shown in FIG. 1, it will be appreciated that the RAN 103/104/105 and/or the core network 106/107/109 may be in direct or indirect communication with other RANs that employ the same RAT as the RAN 103/104/105 or a different RAT. For example, in addition to being connected to the RAN 103/104/105, which may be utilizing an E-UTRA radio technology, the core network 106/107/109 may also be in communication with another RAN (not shown) employing a GSM, UMTS, CDMA 2000, WiMAX, or WiFi radio technology.

The core network 106/107/109 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another core network connected to one or more RANs, which may employ the same RAT as the RAN 103/104/105 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1 may be configured to communicate with the base station 114a, which may employ a cellular-based radio technology, and with the base station 114b, which may employ an IEEE 802 radio technology.

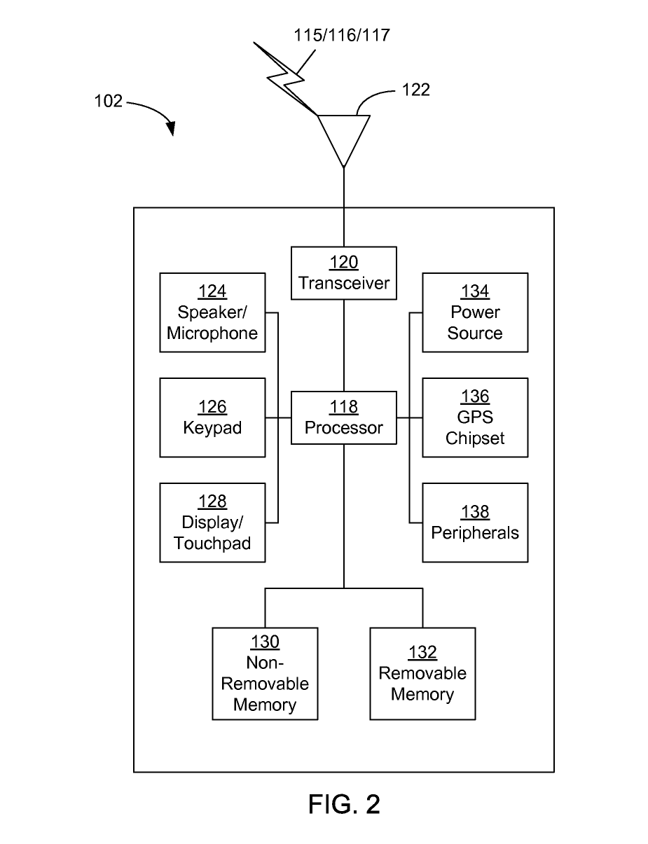

FIG. 2 is a system diagram illustrating an example WTRU 102. As shown in FIG. 2, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Array (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 2 depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 115/116/117. For example, in one embodiment, the transmit/receive element 122 may be an antenna configured to transmit and/or receive RF signals. In another embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 2 as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 115/116/117.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as UTRA and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 115/116/117 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, and the like.

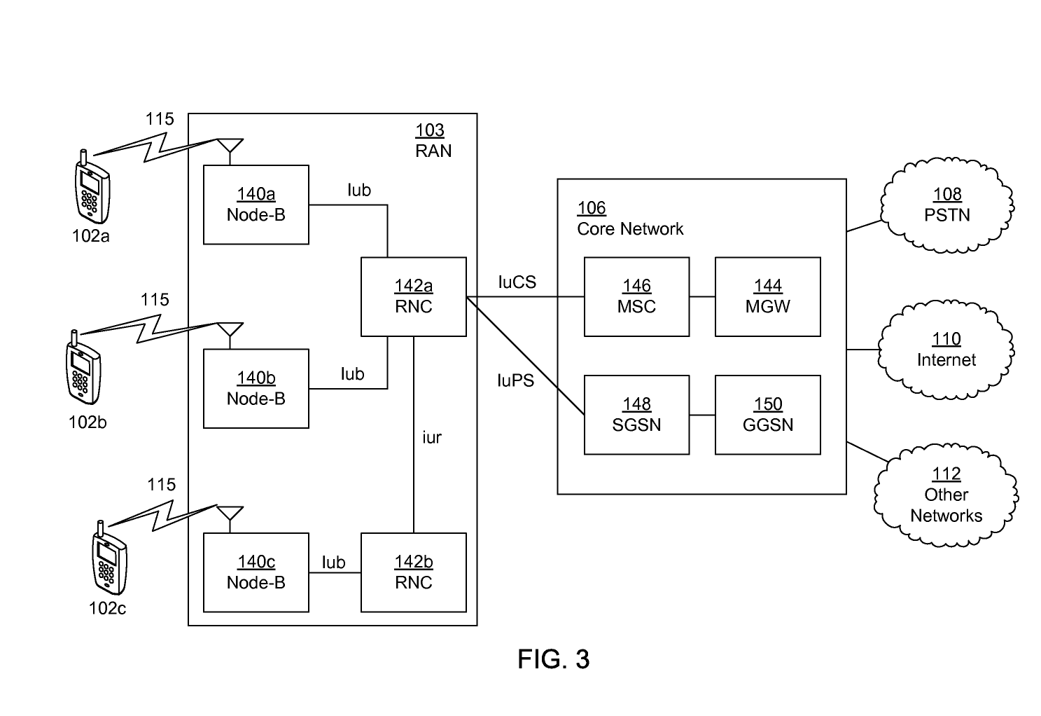

FIG. 3 is a system diagram illustrating the RAN 103 and the core network 106 according to another embodiment. As noted above, the RAN 103 may employ a UTRA radio technology to communicate with the WTRUs 102a, 102b, 102c over the air interface 115. The RAN 103 may also be in communication with the core network 106. As shown in FIG. 3, the RAN 103 may include Node-Bs 140a, 140b, 140c, which may each include one or more transceivers for communicating with the WTRUs 102a, 102b, 102c over the air interface 115. The Node-Bs 140a, 140b, 140c may each be associated with a particular cell (not shown) within the RAN 103. The RAN 103 may also include RNCs 142a, 142b. It will be appreciated that the RAN 103 may include any number of Node-Bs and RNCs while remaining consistent with an embodiment.

As shown in FIG. 3, the Node-Bs 140a, 140b may be in communication with the RNC 142a. Additionally, the Node-B 140c may be in communication with the RNC 142b. The Node-Bs 140a, 140b, 140c may communicate with the respective RNCs 142a, 142b via an Iub interface. The RNCs 142a, 142b may be in communication with one another via an Iur interface. Each of the RNCs 142a, 142b may be configured to control the respective Node-Bs 140a, 140b, 140c to which it is connected. In addition, each of the RNCs 142a, 142b may be configured to carry out or support other functionality, such as outer loop power control, load control, admission control, packet scheduling, handover control, macrodiversity, security functions, data encryption, and the like.

The core network 106 shown in FIG. 3 may include a media gateway (MGW) 144, a mobile switching center (MSC) 146, a serving GPRS support node (SGSN) 148, and/or a gateway GPRS support node (GGSN) 150. While each of the foregoing elements are depicted as part of the core network 106, it will be appreciated that any one of these elements may be owned and/or operated by an entity other than the core network operator.

The RNC 142a in the RAN 103 may be connected to the MSC 146 in the core network 106 via an IuCS interface. The MSC 146 may be connected to the MGW 144. The MSC 146 and the MGW 144 may provide the WTRUs 102a, 102b, 102c with access to circuit-switched networks, such as the PSTN 108, to facilitate communications between the WTRUs 102a, 102b, 102c and traditional land-line communications devices.

The RNC 142a in the RAN 103 may also be connected to the SGSN 148 in the core network 106 via an IuPS interface. The SGSN 148 may be connected to the GGSN 150. The SGSN 148 and the GGSN 150 may provide the WTRUs 102a, 102b, 102c with access to packet-switched networks, such as the Internet 110, to facilitate communications between and the WTRUs 102a, 102b, 102c and IP-enabled devices.

As noted above, the core network 106 may also be connected to the other networks 112, which may include other wired and/or wireless networks that are owned and/or operated by other service providers.

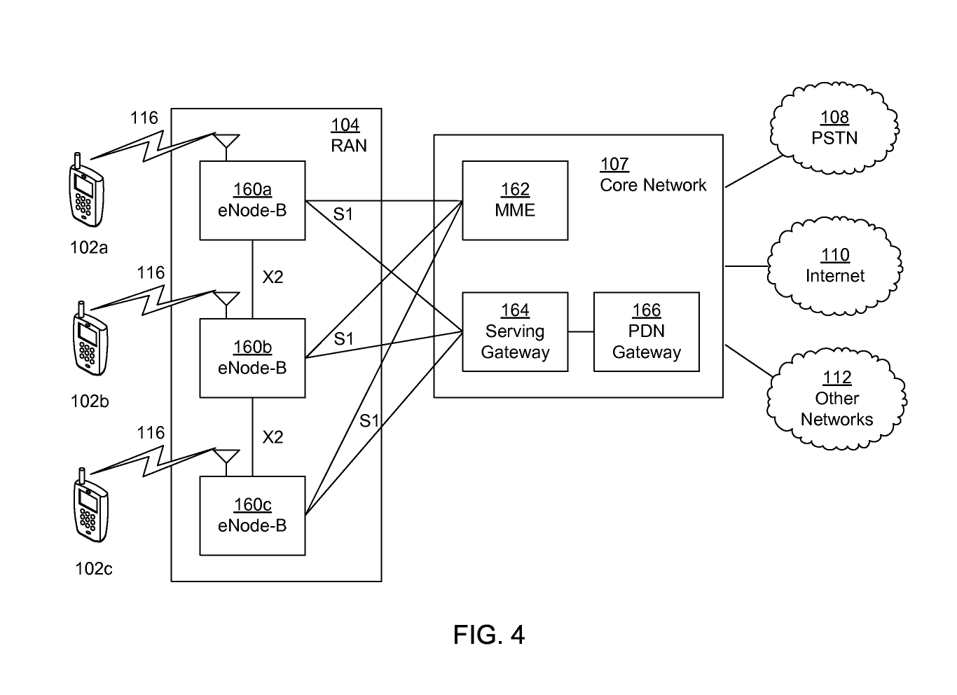

FIG. 4 is a system diagram illustrating the RAN 104 and the core network 107 according to an embodiment. As noted above, the RAN 104 may employ an E-UTRA radio technology to communicate with the WTRUs 102a, 102b, 102c over the air interface 116. The RAN 104 may also be in communication with the core network 107.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the uplink and/or downlink, and the like. As shown in FIG. 4, the eNode-Bs 160a, 160b, 160c may communicate with one another over an X2 interface.

The core network 107 shown in FIG. 4 may include a mobility management entity (MME) 162, a serving gateway (SGW) 164, and a packet data network (PDN) gateway (or PGW) 166. While each of the foregoing elements are depicted as part of the core network 107, it will be appreciated that any of these elements may be owned and/or operated by an entity other than the core network operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The serving gateway 164 may be connected to each of the eNode Bs 160a, 160b, 160c in the RAN 104 via the S1 interface. The serving gateway 164 may generally route and forward user data packets to/from the WTRUs 102a, 102b, 102c. The serving gateway 164 may perform other functions, such as anchoring user planes during inter-eNode B handovers, triggering paging when downlink data is available for the WTRUs 102a, 102b, 102c, managing and storing contexts of the WTRUs 102a, 102b, 102c, and the like.

The serving gateway 164 may be connected to the PDN gateway 166, which may provide the WTRUs 102a, 102b, 102c with access to packet-switched networks, such as the Internet 110, to facilitate communications between the WTRUs 102a, 102b, 102c and IP-enabled devices.

The core network 107 may facilitate communications with other networks. For example, the core network 107 may provide the WTRUs 102a, 102b, 102c with access to circuit-switched networks, such as the PSTN 108, to facilitate communications between the WTRUs 102a, 102b, 102c and traditional land-line communications devices. For example, the core network 107 may include, or may communicate with, an IP gateway (e.g., an IP multimedia subsystem (IMS) server) that serves as an interface between the core network 107 and the PSTN 108. In addition, the core network 107 may provide the WTRUs 102a, 102b, 102c with access to the other networks 112, which may include other wired and/or wireless networks that are owned and/or operated by other service providers.

FIG. 5 is a system diagram illustrating the RAN 105 and the core network 109 according to an embodiment. The RAN 105 may be an access service network (ASN) that employs IEEE 802.16 radio technology to communicate with the WTRUs 102a, 102b, 102c over the air interface 117. As will be further discussed below, the communication links between the different functional entities of the WTRUs 102a, 102b, 102c, the RAN 105, and the core network 109 may be defined as reference points.

As shown in FIG. 5, the RAN 105 may include base stations 180a, 180b, 180c, and an ASN gateway 182, though it will be appreciated that the RAN 105 may include any number of base stations and ASN gateways while remaining consistent with an embodiment. The base stations 180a, 180b, 180c may each be associated with a particular cell (not shown) in the RAN 105 and may each include one or more transceivers for communicating with the WTRUs 102a, 102b, 102c over the air interface 117. In one embodiment, the base stations 180a, 180b, 180c may implement MIMO technology. The base station 180a, for example, may use multiple antennas to transmit wireless signals to, and/or receive wireless signals from, the WTRU 102a. The base stations 180a, 180b, 180c may also provide mobility management functions, such as handoff triggering, tunnel establishment, radio resource management, traffic classification, quality of service (QoS) policy enforcement, and the like. The ASN gateway 182 may serve as a traffic aggregation point and may be responsible for paging, caching of subscriber profiles, routing to the core network 109, and the like.

The air interface 117 between the WTRUs 102a, 102b, 102c and the RAN 105 may be defined as an R1 reference point that implements the IEEE 802.16 specification. In addition, each of the WTRUs 102a, 102b, 102c may establish a logical interface (not shown) with the core network 109. The logical interface between the WTRUs 102a, 102b, 102c and the core network 109 may be defined as an R2 reference point, which may be used for authentication, authorization, IP host configuration management, and/or mobility management.

The communication link between each of the base stations 180a, 180b, 180c may be defined as an R8 reference point that includes protocols for facilitating WTRU handovers and the transfer of data between base stations. The communication link between the base stations 180a, 180b, 180c and the ASN gateway 182 may be defined as an R6 reference point. The R6 reference point may include protocols for facilitating mobility management based on mobility events associated with each of the WTRUs 102a, 102b, 100c.

As shown in FIG. 5, the RAN 105 may be connected to the core network 109. The communication link between the RAN 105 and the core network 109 may be defined as an R3 reference point that includes protocols for facilitating data transfer and mobility management capabilities, for example. The core network 109 may include a mobile IP home agent (MIP-HA) 184, an authentication, authorization, accounting (AAA) server 186, and a gateway 188. While each of the foregoing elements are depicted as part of the core network 109, it will be appreciated that any of these elements may be owned and/or operated by an entity other than the core network operator.

The MIP-HA 184 may be responsible for IP address management, and may enable the WTRUs 102a, 102b, 102c to roam between different ASNs and/or different core networks. The MIP-HA 184 may provide the WTRUs 102a, 102b, 102c with access to packet-switched networks, such as the Internet 110, to facilitate communications between the WTRUs 102a, 102b, 102c and IP-enabled devices. The AAA server 186 may be responsible for user authentication and for supporting user services. The gateway 188 may facilitate interworking with other networks. For example, the gateway 188 may provide the WTRUs 102a, 102b, 102c with access to circuit-switched networks, such as the PSTN 108, to facilitate communications between the WTRUs 102a, 102b, 102c and traditional land-line communications devices. The gateway 188 may provide the WTRUs 102a, 102b, 102c with access to the other networks 112, which may include other wired and/or wireless networks that are owned and/or operated by other service providers.

Although not shown in FIG. 5, it will be appreciated that the RAN 105 may be connected to other ASNs, other RANS (e.g., RANs 103 and/or 104) and/or the core network 109 may be connected to other core networks (e.g., core network 106 and/or 107. The communication link between the RAN 105 and the other ASNs may be defined as an R4 reference point, which may include protocols for coordinating the mobility of the WTRUs 102a, 102b, 102c between the RAN 105 and the other ASNs. The communication link between the core network 109 and the other core networks may be defined as an R5 reference, which may include protocols for facilitating interworking between home core networks and visited core networks.

Although the WTRU is described in FIGS. 1-5 as a wireless terminal, it is contemplated that in certain representative embodiments that such a terminal may use (e.g., temporarily or permanently) wired communication interfaces with the communication network.

Systems, apparatus, and methods are disclosed to implement hierarchical policy control and hierarchical policy servers. An enterprise network may receive a mobile network operator (MNO) policy and an enterprise policy. For example, an enterprise policy center may receive and store the policies. The enterprise network may maintain a wireless connection with a WTRU 102 (e.g., an enterprise WTRU and/or another UE) and may include obtaining and/or maintaining one or more of: a user identity (e.g., associated with the user of the enterprise WTRU or UE) or a type of activity associated with the enterprise WTRU and/or UE. For example, the type of activity may be either business related or personal. The enterprise network may assign bandwidth to the enterprise WTRU to maintain a quality of service (QoS) level. The QoS level may be based on an activity type associated with the enterprise WTRU and/or the user identity. The assigned bandwidth may include one or more of cellular or WiFi resources.

The enterprise network may implement the policies in a hierarchical manner. The bandwidth may be assigned according to the enterprise policy, when the enterprise policy does not conflict with the Mobile Network Operator (MNO) policy (e.g., in response to the enterprise policy not conflicting with the MNO policy). Such assignment may include enforcing both policies. The bandwidth may be assigned according to the MNO policy, when the enterprise policy conflicts with the MNO policy. Such assignment may include enforcing both policies, e.g., the MNO policy and the enterprise policy to the extent, the enterprise policy does not conflict with the MNO policy. The MNO policy may be or may be referred to as a mobile core network policy.

In certain representative embodiments, mechanisms may be implemented for distribution and/or coordination of local and/or remote policies, for example, for wireless network access and/or service delivery (e.g., via co-located femtocell/WiFi access points).

For example, the central (and/or remote) supply of policies may not adequately address scenarios where a local network owner and/or lessee (e.g., an enterprise) may have its own policies (e.g., it own local policies on how data may be or is to be handled). These local policies may be different from the remote (e.g., centralized) policies (e.g., associated with a MNO) and may be supplied via a different mechanism to the WTRU.

The distribution and/or coordination may relate to management of distributed policies between the mobile core network (MCN) nodes and potential network edge nodes, e.g., those within enterprise customer premises. Associated signaling enhancements for coordination between local and central MNO policies may be implemented.

Representative deployments for hierarchical coordinated femtocell/WiFi policy-based mechanisms may include one or more of the following. A femtocell may be managed by an MNO with some control (e.g., some local control, for example over certain services, activities and/or functions) granted to certain customers (e.g., local network operators and/or enterprise customers). For example, an enterprise may limit femtocell access to authorized members of a closed subscriber group (CSG). The enterprise may offer guest access via hybrid and/or supplementary open mode femtocells. The enterprise may allow femtocell access to the MNO core network, enterprise intranet, and/or public Internet (e.g., based on MNO and/or enterprise policies). For example, WiFi may be managed by an enterprise customer with authorized user access provided into the MNO core network, enterprise intranet, and/or public Internet. Restricted WiFi access to the Internet and/or to specific enterprise services may be provided, for example via an enterprise or local policy (e.g., independent of the MNO). Open femtocell and/or WiFi access management may be controlled by the MNO. In such a case, the deployment may be generalized as an operator managed small cell network with carrier WiFi. Open deployments may apply to metro or rural environments.

Using a metro deployment, as an example, greater user densities may exist relative to other deployments. Deployments that use hierarchical and/or more granular policy-based implementations (e.g., distributed policy control) may help capacity issues for a metro deployment (e.g., as opposed to merely filling coverage holes in a rural deployment).

Depending on the architecture/systems deployed, distributed policy control may provide network improvements in enterprise, metro, and/or residential scenarios (deployments and/or implementations). For example, the distinction between enterprise and metro implementations may pertain to the organization initiating the femto/WiFi deployment. Metro deployments may be initiated by a MNO. Enterprise deployments may be initiated by a non-operator entity, e.g., a commercial business, university campus, government agency, factory, warehouse, shopping mall, coffee shop, sports arena, hotel, and/or airport, among others. Such enterprise deployments may cover private, semi-private, and/or public institutions. The enterprise deployments may also cover indoor, outdoor or hybrid indoor/outdoor regions or venues, among others.

In certain representative embodiments, the distributed policy mechanisms may be illustrated using representative metro and/or enterprise reference architectures, but may not be limited thereto.

Metro deployments may be managed by MNOs or other network operators and operator policies may be tightly integrated. In representative embodiments, the policy mechanisms may enable (e.g., apply) policy distribution at the edge of the network, and may include deployments where femto and/or WiFi are operator managed, WiFi is shared by multiple MNOs, and/or WiFi is managed by a third-party provider. An example of such a deployment may include the integration of content delivery networks (CDNs) that form part of a local IP network using a femto/WiFi access point. Enterprise organizations may have technical and/or financial resources at their disposal, and may adopt a combination of in-house and/or outsourced network management. The combination of in-house and/or outsourced network management may include operator hosted services and/or operator management of wide area network transport between sites, among others. Residential customers may have different requirements (or uses) than enterprise organizations and/or metro operators (e.g., fewer users and/or smaller localized coverage areas for residential user relative to enterprise users). Customer interest and return on operator investment may be less in residential deployments than for the enterprise and/or metro deployments.

Enterprises may increasingly adopt femtocells as part of their network infrastructure for wireless access. Enterprise use of femtocells may improve productivity for employees using cellular devices for business applications within the enterprise. For instance, femtocells may enhance the wireless QoS for demanding applications used in financial institutions and/or medical facilities, among others. Femtocells may enable enterprise-specific services for cellular and multi-mode (e.g., using cellular and WiFi) guests in the femtocell (e.g., passengers in an airport, customers in a shopping mall, and/or spectators in a sports arena, among others). Such services may be originated by the MNO, the enterprise, or by a third party service provider, for example, on the Internet.

Femtocells may complement WiFi access, for example, already in use in an enterprise network. Multi-mode devices may capitalize on such implementations. Services provided over a network may be delivered more efficiently and/or economically by exploiting a device's multi-connection capability when available. This may apply to enterprise deployments, and/or metro deployments, among others.

In certain representative embodiments, policy-based multi-RAT traffic management mechanisms may be implemented and, for example, may depend on terminal and network capabilities. As an example, policy-based multi-RAT traffic management may be used in one or more of the following ways: (1) to identify and/or segregate IP data flows based on a type of service in use (e.g., “flow identification” and/or “flow filtering,” respectively); and/or (2) to apply policies to assign specific flows or sub-flows over available RATs (e.g., “flow routing” and/or “sub-flow routing,” respectively). Hierarchical policy management at network operator edge nodes and/or within enterprise customer premises may be implemented, which may include associated signaling (e.g., signaling enhancements) for small cell coordination with central MNO or MCN policies.

In certain representative embodiments, a policy and charging control (PCC) architecture may extend dynamic PCC for IP flow mobility across multiple 3GPP and/or non-3GPP access connections (e.g., such that they may occur concurrently and/or simultaneously).

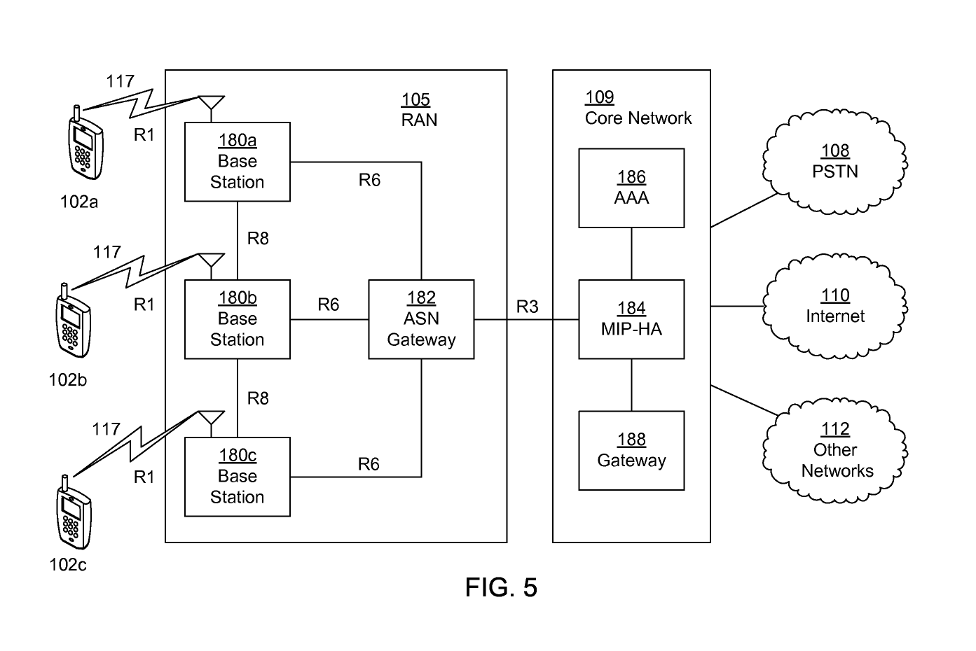

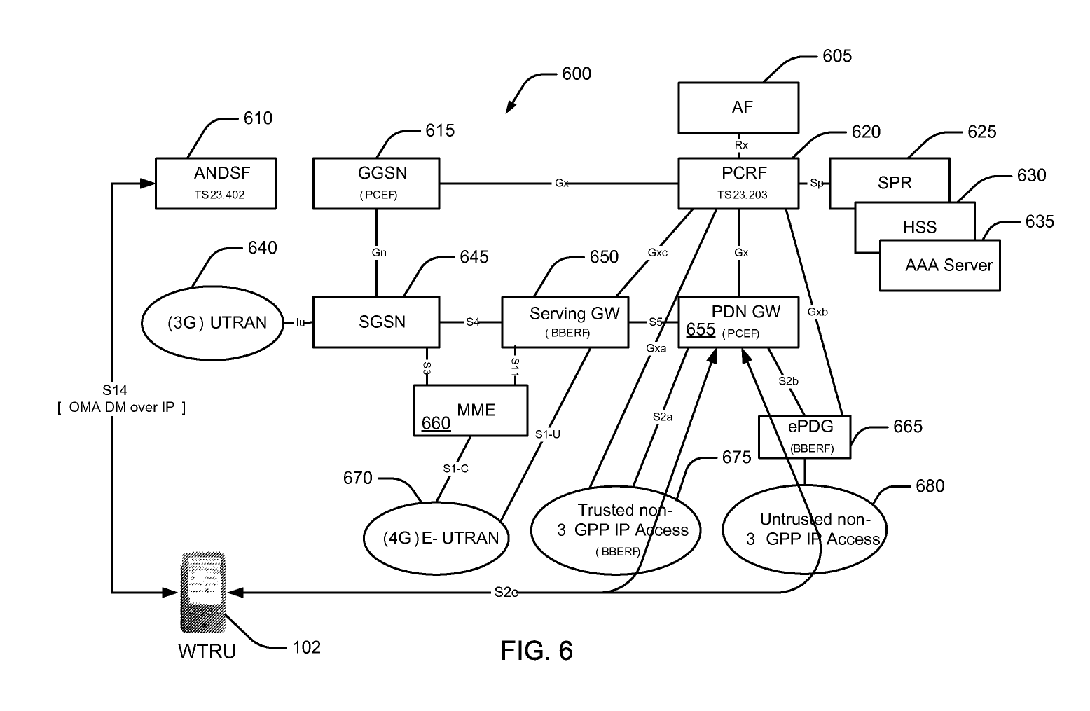

FIG. 6 is a diagram illustrating a representative multi-access network system or architecture, and may relate to a 3GPP multi-RAT PCC architecture with an access network discovery and selection function (ANDSF).

Referring to FIG. 6, a multi-access network system (e.g., or architecture) 600 may include an application function (AF) 605, an ANDSF 610, a GGSN 615, a policy and charging rules function (PCRF) 620, a subscription profile repository (SPR) 625, a home subscriber server (HSS) 630, an authentication, authorization and accounting (AAA) server 635, a UTRAN (e.g., 3G RAN) 640, a SGSN 645, a SGW 650, a PGW 655, an MME 660, an evolved packet data gateway (ePDG) 665, an eUTRAN (e.g., 4G RAN) 670, a trusted non 3GPP IP Access (e.g., trusted access point) 675, and/or an untrusted non-3GPP IP Access (e.g., untrusted access point) 680.

The PCRF 620 may communicate with: (1) the AF 605 via a Rx interface, (2) the SPR 625 via a Sp interface; (3) the PGW 655 via a Gx interface; (4) the GGSN 615 via a Gx interface; (5) the SGW 650 via a Gxc interface; (6) the ePDG 665 via a Gxb interface; and/or (7) the Trusted non-3GPP IP Access 675 via a Gxa interface, among others.

The PGW 655 may communicate with: (1) the PCRF 620 via the Gx interface; (2) the ePDG 665 via a S2b interface; (3) the SGW 650 via a S5 interface; and/or (4) the Trusted non-3GPP IP Access 675 via a S2a interface, among others.

The SGW 650 may communicate with: (1) the PCRF 620 via the Gxc interface; (2) the PGW 655 via the S5 interface; (3) the SGSN 645 via a S4 interface; (4) the eUTRAN 670 via a S1-U interface and/or (5) the MME 660 via a S11 interface, among others.

The SGSN 645 may communicate with: (1) the GGSN 615 via a Gn interface; (2) the UTRAN 640 via a lu interface; (3) the SGW 650 via the S4 interface; and/or (4) the MME 660 via a S3 interface, among others. The MME 660 may communicate with: (1) the SGSN 645 via the S3 interface; (2) the SGW 650 via the S11 interface; and/or (3) the eUTRAN 670 via a S1-C interface, among others. The ePDG 665 may communicate with the untrusted non-3PP IP Access 680 via an interface and the WTRU 102 may communicate with: (1) the ANDSF 610 via a S14 interface; and/or (2) the PGW 655 via an S2c interface through the trusted and/or untrusted non-3GPP IP access 675 and/or 680.

The PCRF 620 may implement QoS policy and flow based charging control. The PCRF 620 may receive media level information about a requested flow from the AF 605 over the Rx interface. The PCRF 620 may analyze characteristics about the requested flow against one or more operator stored policies. The PCRF 620 may: (1) authorize a QoS reservation; or (2) reject the request from the AF 605 (e.g., based on the result of the analysis). The PCRF 620 may download specific service and/or subscriber related information from the SPR 625 over the Sp interface.

The PCRF 620 may provide rules (e.g., for QoS policies, charging control, and/or event report triggers, among others) over the Gx interface to the policy and charging enforcement function (PCEF) located in the PGW 655. If PMIPv6 is used for mobility management, e.g., instead of GPRS tunnelling protocol (GTP), the PCRF 620 may provide the QoS portion of the PCC rules and associated event triggers to the bearer binding and event reporting function (BBERF) over the Gxa, Gxb, and/or Gxc interface. The BBERF may be located in the SGW 650 in case PMIPv6 is used between the PGW 655 and the 3GPP access 640 and/or 670, and/or in an access gateway in case PMIPv6 is used between the PGW 655 and the non-3GPP access 675 and/or 680.

The ANDSF 610 may enable operators to balance subscribers between available access networks, e.g., by choosing an access network based on the current location of a mobile device (e.g., the WTRU 102). The ANDSF information may be shared between the WTRU 102 and the ANDSF server through the S14 interface using an OMA DM based protocol. The ANDS information may be stored in the ANDSF managed object (MO).

In certain representative embodiments, networks may support prioritized QoS at the user and service level and/or enabling flexible network control for user access (e.g., for service differentiation and security). For example, business applications in an enterprise network may receive better QoS and security protection than personal/leisure activities. In certain representative embodiments, for proper QoS control, the enterprise may have accurate knowledge of (e.g., information about) the type of traffic for some or for each requested network service and/or an identity of the user who is requesting the service and/or a priority level of the user. The former (e.g., accurate knowledge of the type of traffic) may be determined when the service is requested (e.g., via service type information retrieved from packet protocol headers). To obtain information for the latter (e.g., the identity of the user and/or a priority level), the enterprise may maintain a database that may store the identity of users (e.g., each user) and/or corresponding network policies.

In enterprise networks comprising cellular and non-cellular wireless services, the enterprise QoS control may consider (e.g., use) the user's MNO subscription and corresponding MNO policy. In certain representative embodiments, the enterprise user database may interact with policy functions of the MCN, e.g., to provide this functionality. For example, mechanisms are disclosed herein for enterprise policy control which may cooperate with MCN policies.

In a network (e.g., an enterprise network) with coordinated femtocell and WiFi operations, the intra-network (e.g., intra-enterprise network) services may be accessed via local IP access (LIPA) or selective IP traffic offload (SIPTO). In certain representative embodiments, mechanisms are implemented for controlling the local QoS using cellular access and/or WiFi access.

Although the representative systems and/or architecture described herein for hierarchical policy control may be described and shown in relation to an enterprise context, the methods, apparatus and systems may be used in other contexts such as in metro and rural contexts, for example, for multiple levels of policy control. One or more of the following examples may apply, for example to: (1) ‘edge-cloud’ networks (e.g., in which intelligent edge nodes implement location-specific policies in coordination with macro network policies); (2) ‘HetNets’; (3) integrated femto-WiFi networks; and/or (4) small cell networks.

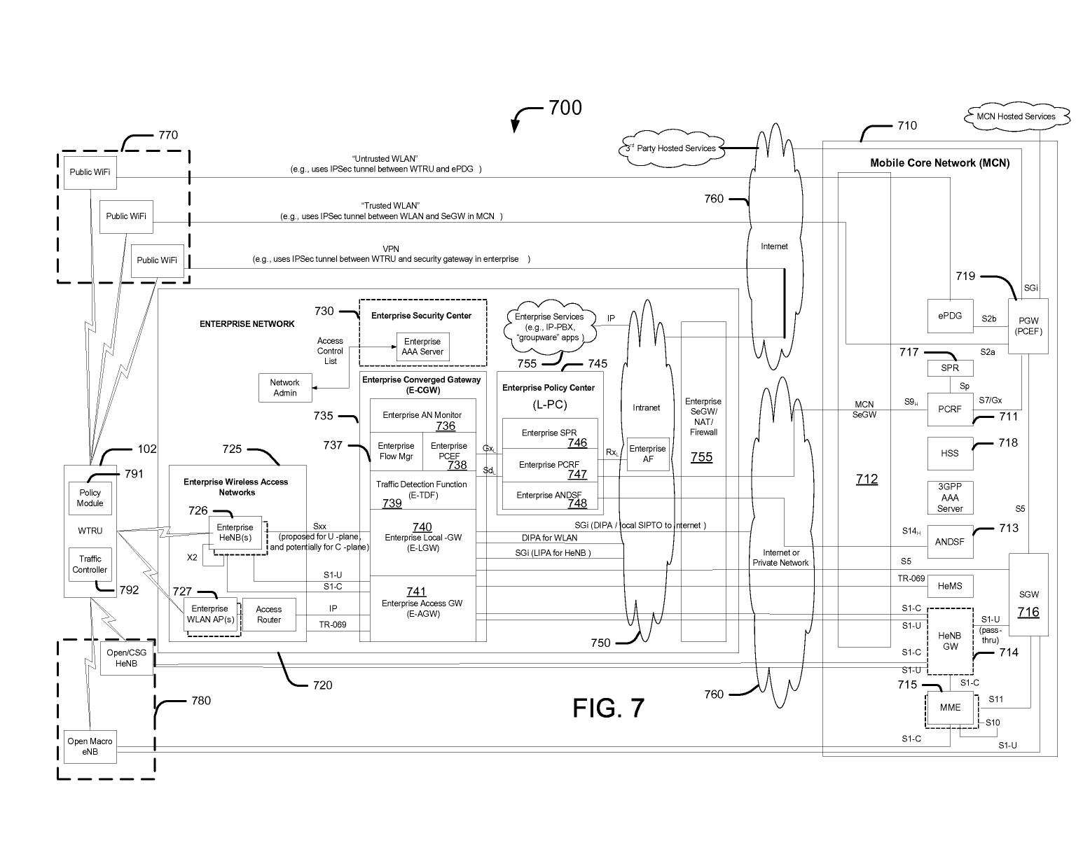

FIG. 7 is a diagram illustrating a representative reference architecture (e.g., system) 700 for hierarchical policy control. The representative architecture uses the concept of an “enterprise” to illustrate the concepts here and therefore refers to “enterprise” functional blocks. However, this is an example and other “localized” notions may be used in place of enterprise, such as “home,” “mall,” “metro,” “urban,” “stadium,” “airport” etc. The representative reference architecture (e.g., system) 700 may include a MCN 710, an enterprise network 720, the internet and/or a private network 760, one or more public WiFis 770, and/or other open/CSG Home eNBs and/or open macro eNBs 780 (which are not part of the enterprise network 720), among others.

The enterprise network 720 may include one or more enterprise wireless access networks (E-WANs) 725, an enterprise security center (E-SC) 730, an enterprise converged gateway (E-CGW) 735, an enterprise and/or local policy center (L-EP) 745, an intranet 750 and/or an enterprise firewall 755, among others. The E-CGW 735 may include an enterprise AN monitor 736, an enterprise flow manager 737, an enterprise PCEF 738, a enterprise traffic detection function (E-TDF) 739, an enterprise local gateway (E-LGW) 740 and/or an enterprise access gateway (E-AGW) 741, among others. The L-PC 745 may include an enterprise SPR (E-SPR) 746, an enterprise PCRF (E-PCRF) 747, and/or an enterprise ANDSF (E-ANDSF) 748, among others. The intranet 750 may include an enterprise AF 751, among others. The MCN 710 may include any number of different apparatus and/or modules. For brevity only a few are emphasized including a PCRF 711, a MCN secure gateway (SeGW) 712, an ANDSF 713, a HeNB gateway (HeNB GW) 714, an MME 715, a SGW 716, a SPR 717, a HSS 718, and/or a PGW 719, among others.

The hierarchical policy control mechanisms may be implemented by the system 700 (e.g., using an enterprise deployment). “Local” variants of 3GPP interfaces are denoted with the subscript “L” (e.g., as shown for Gx_{L}, Sd_{L}, and/or Rx_{L}). For example, the E-PCRF 747 may communicate with: (1) the E-PCEF 738 via the Gx_{L} interface; (2) the E-TDF 739 via the Sd_{L} interface and/or (3) the enterprise AF 751 via the Rx_{L} interface. “Hierarchical” variants of 3GPP interfaces are denoted with the subscript “H,” e.g., as shown for S9_{H} and S14_{H}. For example, the PCRF 711 may communicate with the E-PCRF 747 via the S9_{H} interface and the ANDSF may communicate with the E-ANDSF 748 via the S14_{H} interface.

The enterprise may appear as a trusted network to the MCN 710 (e.g., interfacing via the SeGW 712 using IPSec), and may also be possible for metro deployments managed by the MNO.

The WTRU 102 may maintain network policies within managed objects (MOs). 3GPP may include an OMA-DM based ANDSF MO. In certain representative embodiments, E-ANDSF policies may be defined (and/or set) as an extension to the macro-network ANDSF MO. It is also contemplated that the E-ANDSF may use its own ANDSF MO (with a different name then the macro-network MO) or that it may utilize a non-ANDSF MO. ANDSF and/or E-ANDSF extensions may, for example, include femtocell access point discovery information. This information may include one or more LIPA APNs for identifying local networks accessible through the femtocell.

Although LTE-based radio accesses and an evolved Packet Core (ePC) based MCN are set forth, the hierarchical policy mechanisms disclosed herein may apply to UMTS-based radio access, as well.

It is contemplated that each enterprise femtocell access point (FAP) may support a certain maximum number of simultaneous packet data users (e.g., 8, 16, or 32). FAPs may support different cellular air interface technologies such as LTE, UMTS, CDMA, and/or WiMAX, as well as combinations of the different air interfaces. For illustration, the EWANs 725 may include, for example, LTE FAPs (e.g., single-mode LTE FAPs), which may be referred to hereafter as enterprise home eNodeBs (E-HeNBs) 726 and/or E-WLAN access points (WLAN APs) 727. The E-HeNBs 726 may operate in closed subscriber group (CSG) mode or hybrid mode (e.g., in a limited CSG mode allowing CSG users access with limited open access for non-CSG users). For a metro deployment, the HeNBs 726 may operate in open mode in which user access to the HeNBs 726 may not be restricted.

The E-HeNBs 726 may be interconnected via X2-based interfaces, which may be implemented via Ethernet, e.g., using enterprise IT installation procedures. The initialization of an E-HeNB X2 interface may begin with identification of neighboring E-HeNBs 726 suitable for handover and/or other features such as inter E-HeNB flow mobility and/or aggregation. This configuration may be provided manually by the IT department and/or via an autoconfiguration process. For example, the configuration may be performed via advanced LTE self optimizing network (SON) features and/or E-ANDSF visibility mechanisms disclosed herein (e.g., whereby the E-HeNB 726, the E-CGW 735, and/or the L-PC 745 may request the WTRU 102 to identify and/or report candidate neighbor E-HeNBs 726, among other). After or responsive to a suitable neighbor E-HeNB 726 being identified, the E-HeNB 726 may set up a transport network layer (TNL) using the identified IP address of the neighbor E-HeNB 726. When the TNL has been set up, the E-HeNB 726 may initiate the X2 Setup procedure with the neighbor E-HeNB 726 to establish the X2 connections and tunnels.

Although X2 handover based procedures may be supported, in certain representative embodiments, gateway based handover procedures may be implemented between the E-HeNBs 726 and the E-AGW 741, which may facilitate management of features such as flow mobility and/or aggregation across multiple HeNBs 726 by enabling the monitoring and/or manipulation of S1 and X2 signaling connections and/or S1 and X2 user plane tunnels. For example, the E-HeNBs 726 may be configured with the IP address of the E-AGW 741.

The WLAN APs 727 may interface with the enterprise network 720 via an IP access router through the E-CGW 735. Inter-AP mobility procedures may be setup and/or centralized handover procedures may be setup via the E-AGW 741. The E-AGW 741 may facilitate management of flow mobility and/or aggregation with the E-HeNBs 726.

The E-CGW 735 may be tailored for enterprise networks. As understood by one of skill in the art, the E-CGW 735 may include a number of entities that may be shown as separate modules, but may be integrated on a common platform. The functional modules may include one or more of the following: the E-AGW 741, which may act as an enterprise mobility controller and/or gateway to the MCN 710; the E-LGW 740, which may act as a gateway to the local intranet and/or to the Internet (e.g., bypassing the MCN 710); the E-TDF 739; the inter-access enterprise flow manager (E-FM) 737; the E-PCEF 738, and/or the enterprise access network monitor (E-ANM) 736.

The E-AGW 741 function may act as the gateway from the EWAN 725 to the MCN 710, and may handle optimized local user mobility between the E-HeNBs 726 within the enterprise. The E-AGW 741 may be similar to a “local” version of a HeNB Gateway. The E-AGW 741 may concentrate S1-C control signaling from each E-HeNB 726 toward the MCN 710, and may perform local mobility procedures and exchange information with the MCN HeNB GW 714 and/or the MME 715. The E-AGW 741may appear as a HeNB to the HeNB GW 714 or the MME 715. The E-AGW function may be included as part of the E-CGW 735 or may be separate from the E-CGW 735.

The S1-U interface from the E-HeNB 726 may be terminated at the E-AGW 741 where tunnel manipulation may be performed (e.g., to support mobility across E-HeNBs 726). This may provide local mobility support. The E-AGW function may handle optimized local user mobility between the WLAN APs 727 and the HeNBs 726 within the enterprise.

The E-LGW function may set up and maintain the S5 interface (e.g., connection) to the SGW 716 in the MCN 710 for support of (e.g., to enable) LIPA PDN connectivity (e.g., when MCN paging is to be triggered by a device on the enterprise network 720 to reach an idle WTRU 102 in the enterprise. The E-LGW 740 may support (e.g., enable) user plane connectivity with one or more E-HeNBs 726 via direct GTP-U tunnels established via control signaling. It is contemplated that the user plane exists on a created interface depicted as “Sxx” in FIG. 7.

Although not shown as a separate interface in FIG. 7, the E-LGW 740 may handle routing to and/or from the enterprise WLAN 727 via the E-AGW 741. The E-LGW 740 may also support (e.g., enable) the S5 interface with the SGW 716 (e.g., and for PGW 719) and the Ski interface with the local packet data network.

The E-TDF 739 may be a functional entity that performs traffic identification for IP packet flows traversing the enterprise, and may report detected applications and their data flow descriptions to the E-PCRF 747.

The E-FM 737 may handle IP flow management tasks. The IP flow management tasks may include one or more of the following: (1) assigning flows to different accesses; (2) moving a flow from one access to another; (3) adding more connections based on a policy; (4) splitting one flow among multiple accesses; and/or aggregating sub-flows from multiple accesses, among others.

The E-PCEF 738 may ensure that the users and/or the services managed by the E-CGW 735 receive the expected QoS within the enterprise with the appropriate charging and billing considerations. For example, the E-PCEF 738 may monitor usage of enterprise resources (e.g., and together with the E-TDF 739) may identify which flows may to be billed under the enterprise bulk plan and which may be billed to an individual subscriber.

The E-ANM 736 may monitor network usage and channel conditions (e.g., current and/or previous network usage and channel conditions). The network usage and channel conditions may include one or more of the following: (1) available bandwidth of one, a plurality or each link; (2) signal strength of one, a plurality or each channel; (3) congestion status; and/or (4) packet latency, among others. When the network condition falls below and/or rises above specified thresholds, the E-ANM 736 may inform the corresponding module (e.g., the E-PCEF 738) by sending a network condition update (NCU) (e.g., a NCU message or signaling). Other modules may request a NCU from the E-ANM 736.

The L-PC 745 may provide policy support for the E-CGW 735 and authorized enterprise WTRUs 102 (e.g., acceptance of an enterprise service request and/or acceptance of a specified quality level (e.g., QoS) for a requested enterprise service. An L-PC 745 (e.g., local E-PC) may: (1) integrate the enterprise policy and operator's policy; and/or (2) shorten the response time of requests and may reduce the signaling and/or traffic volume sent to the core network. For example, the L-PC 745 may define (and/or establish) enterprise-specific WiFi offload and/or inter-RAT flow mobility policies.

The E-ANDSF 748 may provide local policies to wireless enterprise users regarding the access points the wireless enterprise users may connect to for particular services based on the status (e.g., current status) of the enterprise network 720 (e.g., the overall wireless enterprise network). The E-ANDSF 748 may provide a “local” ANDSF function in the enterprise. For example, for services provided through the MCN 710, the E-ANDSF 748 may communicate with the ANDSF 713 in the MCN 710, as a WTRU proxy via the S14_{H} interface.

The E-ANDSF 748 may synchronize with the global policy in the MCN ANDSF 713. The E-ANDSF may update its policy database with applicable ANDSF information from the MCN 710 (e.g., via the S14_{H} interface). In certain representative embodiments, the E-ANDSF service may be limited to users within the enterprise and the E-ANDSF 748 may be limited to updating a portion of the policies (e.g., relevant to users in a vicinity of the enterprise). Synchronization with the MCN ANDSF 713 may be used (and/or established) when the WTRU 102 is to establish radio access outside the enterprise. The E-ANDSF 748 may configure the local enterprise policy. The configuration of the local policy may be accomplished via: (1) a manual configuration by the enterprise network administrator and/or (2) via an automated configuration (e.g., without human intervention). For example, the manual configuration of local policies may be established when the enterprise network is initialized or when some fundamental policy of the enterprise is changed. As another example, the autoconfiguration of policies may be provided by the E-ANDSF 748, which may update its local policy based on network condition information conveyed by the E-CGW 735 (e.g., via the E-PCRF 747).

The final policy (e.g., the autoconfigured or manually configured policies) may be generated based on global and local policies. If there is no conflict between the global and local policies, the E-ANDSF 748 may combine the two policies to generate the final policy. If there is a conflict, the E-ANDSF 748 follows a well-defined policy priority scheme to establish policy hierarchy.

A WTRU 102 may be assisted on the access selection or selections. When the WTRU 102 or network initiates a network service for the WTRU 102, the E-ANDSF 748 may guide the access selection so that network resources such as bandwidth may be optimized and the user's quality of service (QoS) may be protected.

Pre-fetched policies for enterprise users may be provided. When a network administrator updates the list of permitted users in the enterprise, the E-ANDSF 748 may pre-fetch the MCN-based policies for the permitted users from the ANDSF 713 (e.g., ANDSF server) located in the MCN 710. The policies may have an expiration date (e.g., an expiration period). The E-ANDSF 748 may fetch the MCN-based policies for the permitted users from the ANDSF server upon expiry of the policies previously fetched. The E-ANDSF 748 (e.g., E-ANDSF server) may update policies (e.g., continually or periodically, among others), which may reduce the amount of time for an end-user device to receive the updated policies since the E-ANDSF server may already have the network-based policies. For example, the E-ANDSF 748 may not have to establish a connection with the MCN-based ANDSF server to download policy upon initiation by the end-user device. Having pre-fetched MCN-based policies may be useful for (and more efficiently enable) network-based (NB) IP flow mobility (NB-IFOM). For NB-IFOM, the E-CGW 735 may require or use the policy. The end-user device may not require or use the policies and may not need to or use the request policies from the E-ANDSF server. The E-ANDSF server may already be pre-configured with the policies for a user that is permitted to use the enterprise network 720.

The E-PCRF 747 may assign QoS rules to be applied by various components of the enterprise network 720. The E-PCRF 747 may provide a local PCRF function in the enterprise. For services provided through the MCN 710, the E-PCRF 747 may communicate with the MCN PCRF 711 via the S9_{H} interface.

Although the S9_{H} interface between the E-PCRF 747 and the MCN PCRF 711 may be based on the 3GPP S9 roaming interface, the enterprise may or may not be considered a visited network by the enterprise WTRUs 102 accessing MCN services. The enterprise network 720 may not be considered a separate PLMN from a MCN perspective.

The E-SPR 746 may include relevant information regarding the users authorized to access the enterprise wireless network or networks 725. The E-SPR 746 may support (or enable) additional enterprise-specific elements not required (e.g., not used) for MCN use, and may interact with the E-PCRF 747 via a direct interface within the L-PC 745. Relevant information from the MCN SPR 717 may be included and/or reflected (e.g., implicitly reflected) in the PCRF information received via the S9_{H} interface (e.g., a direct interface between the E-SPR 746 and the MCN SPR 717 may not be implemented). The MCN SPR information may be cached in the PCRF 717 and may be conveyed to the E-PCRF 747 (e.g., via the S9_{H} interface). The SPR information may include a local version of the CSG list for the HeNBs 726 in a domain of the SPR 717.

Enterprise WTRUs 102 may include a policy module function (PMF) 791 and a traffic controller (TC) or TC function (TFC) 792 and may use features and/or functions of the enterprise architecture/system 700. The PMF 791 may serve as a local policy database of, at, and/or for the enterprise WTRU 102, which may provide policy information when the enterprise WTRU 102 is making a decision. The enterprise WTRU 102 may update its policy rules with enterprise and MCN's policies, as appropriate (e.g., via an evolved ANDSF client).

The TCF 792 may handle traffic adjustment tasks on the WTRU side. The TCF 792 may adjust the traffic sent from the WTRU 102 (e.g., based on information received from the policy module). The received information may include the total amount of traffic the WTRU 102 is allowed to send, the ratio of traffic received on different accesses, the increase in the received information and/or current traffic and/or the decrease in the percentage of the received information and/or current traffic, among others.

The representative reference architecture/system may include: (1) the E-SC 730, which may handle security related issues, for example, authentication, authorization and accounting (AAA); (2) the enterprise intranet 750, which may include a local IP network including one or more devices on the local subnets; (3) an IP-PBX functions and the enterprise AF that may support and/or enable the Rx_{L} interface to the E-PCRF 747. The MCN 710 may provide certain functionalities to support and/or enable an evolved enterprise network.

The network administrator may have an interface into the E-SC 730. The interface may be used for the network administrator to control and/or manage access to the enterprise network 720 (e.g., who is allowed access to the enterprise network 720), which may include one or more of the following interfaces: (1) the S9_{H} interface between the MCN PCRF/SPR 711/717 and the E-PCRF/E-SPR 747/746 (e.g., which contemplates an SPR/E-SPR interaction may take place indirectly via the PCRF/E-PCRF 711/747 over the S9_{H} interface); and/or (2) the S14_{H} interface between the MCN ANDSF 713 and the E-ANDSF 748.

E-ANDSF discovery and/or MCN ANDSF discovery may be implemented. The E-ANDSF 748 may be configured with MCN ANDSF discovery information (e.g., by the MCN 710, the IT department and/or the network administrator based on information provided by the MCN 710. The provided information may include a fully qualified domain name (FQDN) and/or IP address for the MCN ANDSF 713. The E-ANDSF 748 may be able to query the MCN ANDSF 713 over the S14_{H} interface.

The enterprise WTRUs 102 may be configured with MCN ANDSF discovery information (e.g., by the MCN 710). The discovery information may include the FQDN or IP address for the MCN ANDSF 713. The WTRU 102 may be configured to query the MCN ANDSF 713 (e.g., after establishing a default PDN connection with the MCN 710).

The enterprise WTRUs 102 may be configured with E-ANDSF discovery information (e.g., by the IT department and/or network administrator). The discovery information may include an FQDN or IP address for the E-ANDSF 748. The WTRU 102 may be configured to query the E-ANDSF 748 (e.g., after establishing a LIPA PDN connection with an enterprise LAN).

The L-PC policies may be established within the enterprise. E-ANDSF initialization may be based on start-up or subsequent event triggers. The E-ANDSF 748 may include a client function supporting and/or enabling the ANDSF MO (e.g., a 3GPP MO). The MNO may provide the enterprise with configuration information for the E-ANDSF 748 to access the MCN ANDSF 713 (e.g., its FQDN and/or the IP address). For example, at least a standard set of ANDSF MO parameters may be supported and/or enabled. Additional parameters may be defined as appropriate, including those modified by future standards updates.

Upon initialization of the E-ANDSF 748, and subsequently if used, the E-ANDSF 748 may provide its location to the MCN ANDSF 713 and may request relevant global inter-system policies. The requested information may be used to supplement the E-ANDSF database (e.g., to support or configure enterprise or macro mobility and/or simultaneous enterprise/macro connectivity). The requested information may provide the bounds within which the enterprise may set its autonomous policies. When the enterprise network 720 is configured or reconfigured, the E-ANDSF 748 may request global information from the MCN ANDSF 713 via the S14_{H} interface. The E-ANDSF 748 may provide its location to the MCN ANDSF 713 such that a subset (e.g., a smaller subset) of relevant local information may be provided. The MCN ANDSF 713 may provide the requested information to the E-ANDSF 748 via the S14_{H} interface. The E-ANDSF 748 may update its MO, accordingly, and may use this information to set the bounds for the autonomous policies for users of the enterprise network 720.

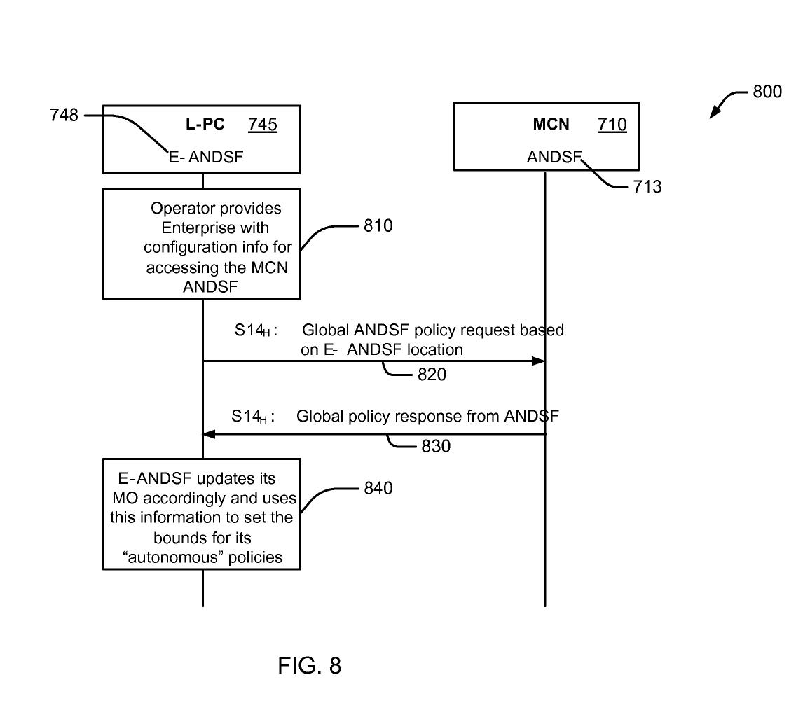

FIG. 8 illustrates a representative E-ANDSF database update 800 (e.g., an initial E-ANDSF database update) for a local ANDSF.

Referring to FIG. 8, at 810, the operator may provide the enterprise (e.g., enterprise network 720) with configuration information for accessing the MCN ANDSF 713. At 820, the E-ANDSF 748 may send a Global ANDSF policy request (e.g., based on the location of the E-ANDSF 748) via the S14_{H} interface to the MCN ANDSF 713. The address of the MCN ANDSF 713 may be provided via the operator in a pre-configuration. At 830, the MCN ANDSF 713 may send (e.g., respond with) a Global policy response via the S14_{H} interface to the E-ANDSF 748. At 840, the E-ANDSF 748 may update its MO, accordingly, based on information in the Global policy response, and may use the updated information to set the bounds for the E-ANDSF autonomous policies.

For example, the E-ANDSF 748 and the E-PCRF/E-SPR 747/746 may be updated when a WTRU 102 joins the network (e.g., enterprise network 720). In certain representative embodiments, an idle WTRU 102 may detect that the WTRU 102 is in a vicinity of the enterprise based on location information (e.g., via GPS and/or enterprise resources, among others). For example, when the WTRU 102 enters the enterprise, the WTRU 102 may re-register with the MCN 710 via one of the E-HeNBs 726. The E-CGW 735 may detect the signaling associated with the re-registration and may notify the E-ANDSF 748 and E-PCRF/E-SPR 747/746 that the WTRU 102 has entered the network (e.g., enterprise network 720). The E-ANDSF 748 and E-PCRF/E-SPR 747/746 may check the policy record of the WTRU 102 in their database. If there is no profile or corresponding policy record for the WTRU 102, the E-ANDSF 748 and E-PCRF/E-SPR 747/746 may send a WTRU-specific update request to the ANDSF 713 and PCRF/SPR 711/717 in the MCN 710 via the S14_{H} and S9_{H} interfaces, respectively, requesting the latest profile and policy of the WTRU 102. The ANDSF 713 and PCRF/SPR 711/717 may send the requested information to the E-ANDSF 748 and the E-PCRF/E-SPR 747/746 via the S14_{H} and S9_{H} interfaces, respectively.

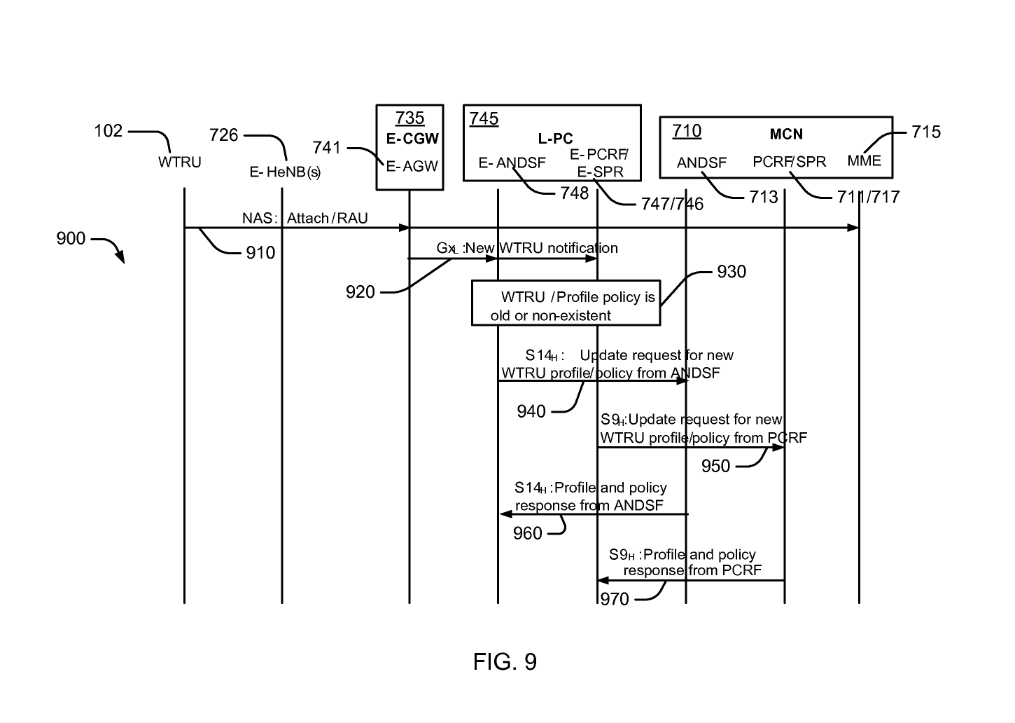

FIG. 9 is a diagram illustrating a representative E-ANDSF and E-PCRF database update 900 for a local ANDSF and local PCRF.

Referring to FIG. 9, at 910, the WTRU 102 may send a non-access stratus (NAS) attach/routing area update message via the E-AGW 741 of the E-CGW 735 to the core network. At 920, the E-CGW 735 may send or forward the notification (e.g., a new WTRU notification) via the Gx_{L} interface to the L-PC 745. For example, the E-CGW 735 may send a notification to the E-PCRF 747 and the E-PCRF 747 may notify the E-ANDSF 748. At 930, the L-PC 745 may determine that the WTRU profile and/or WTRU related policy is either old (e.g., is older than a threshold) or does not exist in the E-ANDSF database. Responsive to or when the L-PC 745 determines the WTRU profile and/or WTRU related policy is old or non-existent, at 940, the E-ANDSF 748 may send an update request for a new or updated WTRU profile/policy to the ANDSF 713 via the S1_{4H} interface. Responsive to or when the L-PC determines the WTRU profile and/or WTRU related policy is old or non-existent, at 950, the E-PCRF/E-SPR 747/746 may send an update request for a new or updated WTRU profile/policy to the PCRF 711 via the S_{9H} interface. At 960, the ANDSF 713 may send a response to the update request from the E-ANDSF 748 (e.g., a profile and/or policy response) to the E-ANDSF 748 via the S1_{4H} interface. At 970, the PCRF 711 may send a response to the update request from the E-PCRF 747 (e.g., a profile and/or policy response) to the E-PCRF 747 via the S_{9H} interface.

The L-PC policies may be used for access selection within the enterprise. While in range of an E-HeNB 726, the WTRU 102 may maintain a default PDN connection with the MCN 710 and a LIPA PDN connection with the enterprise LAN.

A WTRU-initiated local network access update may be implemented or provided. The enterprise WTRUs 102 may be pre-configured (e.g., by the IT department) with E-ANDSF discovery information. When a WTRU enters the enterprise and attaches or re-registers with the MCN 710 via an E-HeNB 726, the WTRU 102 may establish a default LIPA connection within the enterprise and request enterprise-specific Access Point (AP) selection and IP flow routing policies from the E-ANDSF 748.

When the WTRU 102 wants or desires to establish a session, the WTRU 102 may use the policy information to influence the AP selection for a particular service. The WTRU 102 may coordinate with the enterprise network 720 to select the appropriate access for the user and service priority (e.g., based on additional information known by the E-CGW 735 (e.g., load on enterprise resources, congestion between or among enterprise resources, service priorities, user priorities, and/or QoS restrictions, among others).

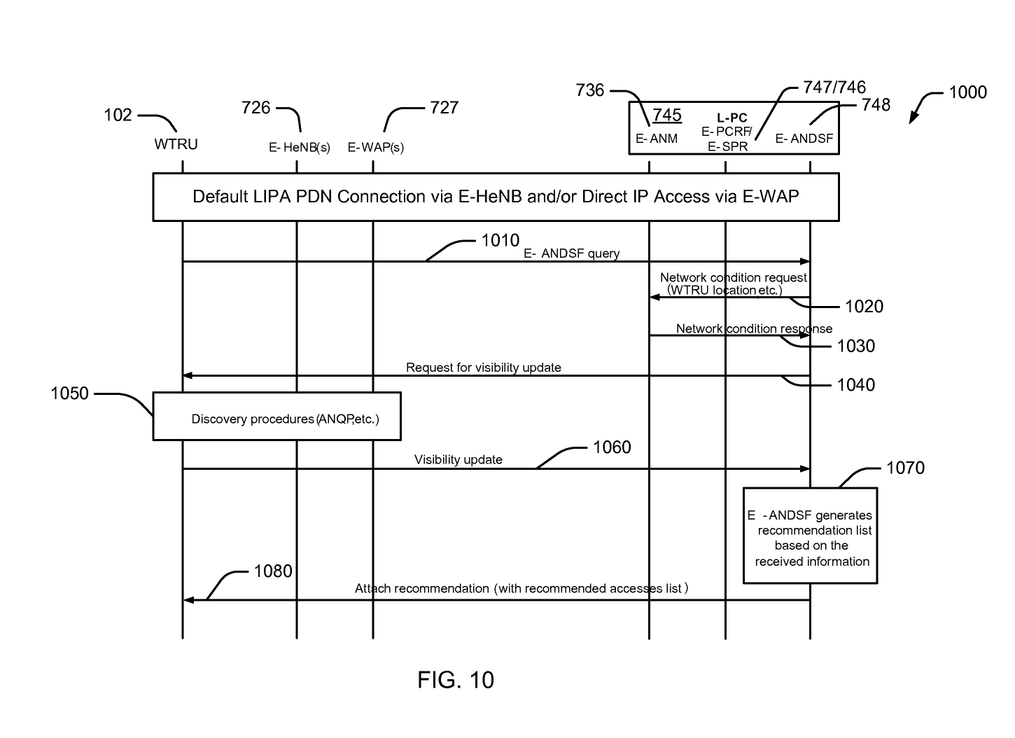

FIG. 10 is a diagram illustrating a representative E-ANDSF assisted access or accesses selection 1000 for a WTRU-initiated update and may include one or more of the following. A default LIPA PDN connection via the E-HeNB 726 and/or direct IP via the E-WAP may be established. At 1010, the WTRU 102 may request, via an E-ANDSF query, enterprise-specific AP selection and IP flow routing policies from the E-ANDSF 748. At 1020, the E-ANDSF 748 may send a network condition request to the E-ANM 736, for example, including WTRU context information such as the WTRU's location. At 1030, the E-ANM 736 may respond by sending a network condition response to the E-ANDSF 748. At 1040, the E-ANDSF 748 may request an access network visibility list from the WTRU 102. At 1050, the WTRU 102 may perform access network discovery procedures, as directed by the visibility update (e.g., via scanning, by using access network discovery protocol (ANQP), among others). At 1060, the WTRU 102 may send its visibility list, as a visibility update, to the E-ANDSF 748. At 1070, the E-ANDSF 748 may generate a recommendation list based on the received information. At 1080, the E-ANDSF 748 may send the recommendation list (e.g., including an attach recommendation with the recommended accesses list) to the WTRU 102. The WTRU 102 may follow the recommendation and may send attach requests and/or association requests to those E-HeNB(s) 726 and/or enterprise WLAN APs 727, e.g., if not attached to them.

In certain embodiments, the E-ANM 736 may be included in the E-CGW 735 while in other embodiments it may be included in the L-PC 745.

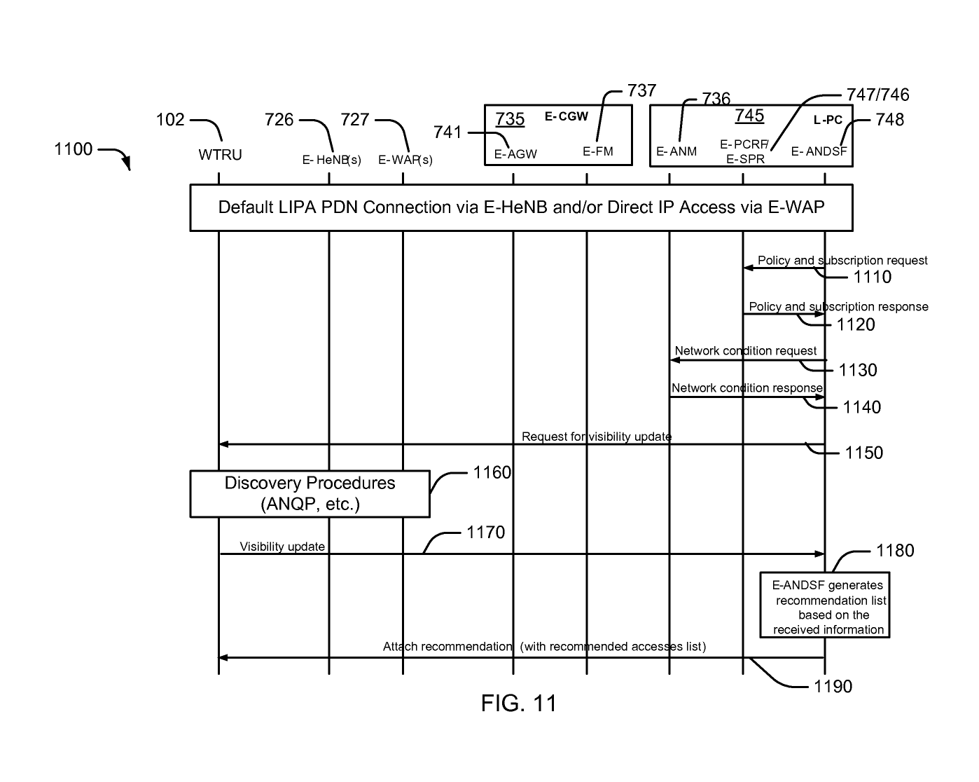

A network-initiated local network access update may be implements or provided. FIG. 11 is a diagram illustrating a representative E-ANDSF assisted access or accesses selection 1100 for a network initiated update.

Referring to FIG. 11, a default LIPA PDN connection via the E-HeNB 726 and/or direct IP access via the E-WAP may be established. At 1110, the E-ANDSF 748 may consult with (e.g., send a policy and subscription request to) the E-PCRF/E-SPR 747/746 for a WTRU 102. At 1120, the E-PCRF/E-SPR 746/747 may provide the E-ANDSF 748 with this user's subscription and corresponding policies (e.g. respond with a policy and subscription response). At 1130, the E-ANDSF 748 may send a network condition request to the E-ANM 736. At 1140, the E-ANM 736 may send a network condition response to the E-ANDSF 748. At 1150, the E-ANDSF 748 may request an access network visibility list from the WTRU 102 via a visibility update request. At 1160, the WTRU 102 may perform access network discovery procedures, as directed by the visibility update request (e.g., via scanning by using the access network discovery protocol (ANQP), among others). At 1170, the WTRU 102 may send its visibility list, as a visibility update, to the E-ANDSF 748. At 1180, the E-ANDSF 748 may generate a recommendation list based on the received information. At 1190, the E-ANDSF 748 may send the recommendation list (e.g., (e.g., including an attach recommendation with a recommended accesses list) to the WTRU 102. The WTRU 102 may follow the attach recommendation and may send attach requests and/or association requests to those E-HeNB(s) 726 and/or enterprise WLAN APs 727, e.g., if not attached to them.

In certain representative embodiments, L-PC policies for service delivery within the enterprise may be implemented. When within range of the enterprise network 720, the enterprise WTRU 102 may establish and/or maintain a default connection with the MCN 710 and a separate default connection with the enterprise network 720. This may be initiated by client software installed in the WTRU 102. The initial QoS for these default connections may be derived from the user's subscription information in the MCN HSS 718.

In certain representative embodiments, dedicated bearer control for LIPA may be implemented. When accessing local enterprise network services, a local application function (AF) may convey the QoS (e.g., QoS requirements) for the requested service to the E-PCRF 747. The E-PCRF 747 may initiate a dedicated bearer request with appropriate QoS and charging rules to the E-PCEF 738 in the E-CGW 735. This may be conveyed via an internal interface to the E-LGW 740, which may request the dedicated bearer setup via an Sxx interface with the HeNB 726. If successful, the HeNB 726 may respond to the E-LGW 740 and a dedicated LIPA PDN connection may be established for the local service.

The MCN 710 may enable or disable this local capability. The MCN 710 may request notification of dedicated LIPA PDN bearer establishment/modification/release events. In such cases, the information may be conveyed between the PCRF 711 and the E-PCRF 747 via the S9_{H} interface.

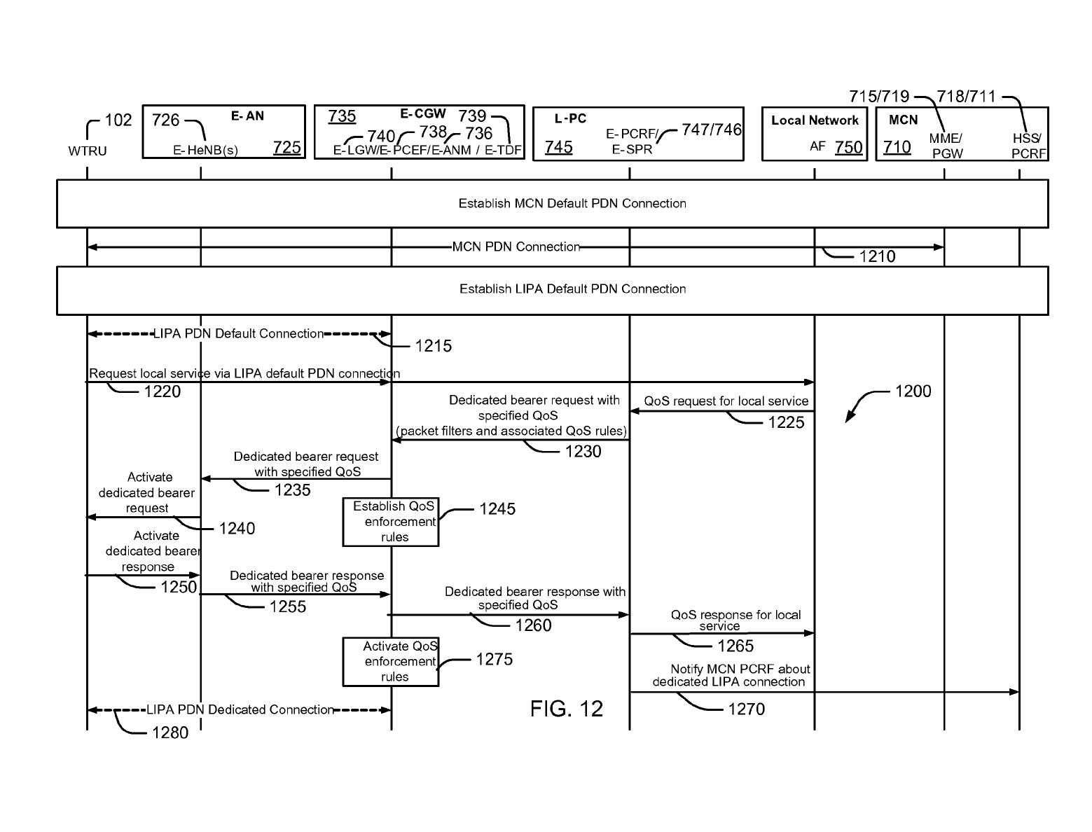

FIG. 12 is a diagram illustrating a representative dedicated LIPA PDN connection setup procedure 1200 with QoS (e.g., QoS requirements).

Referring to FIG. 12, at 1210, a MCN PDN default connection may be established between the MME/PGW 715/719 and the WTRU 102. At 1215, a local IP access (LIPA) PDN default connection may be established between the E-CGW 735 and the WTRU 102. At 1220, the WTRU may request local service via the LIPA PDN connection to the E-CGW 735, which may send or forward the request to the application function (AF) of the local network 750. At 1225, the AF may send a QoS request for local service to the L-PC 745. At 1230, the L-PC 745 may send a dedicated bearer request (e.g., with a specified QoS) to the E-CGW 735. The dedicated bearer request may include one or more packet filters (e.g., traffic flow templates) and their associated QoS rules. At 1235, the E-CGW 745 may send the dedicated bearer request (e.g., with the specified QoS) to the E-AN 725. At 1240, the E-AN 725 may send an activate dedicated bearer request to the WTRU 102. At 1245, the E-CGW 735 may establish QoS enforcement rules, for example, based on the information received in the dedicated bearer request. At 1250, the WTRU 102 may send an activate dedicated bearer response to the E-AN 725. At 1255, the E-AN 725 may send a dedicated bearer response (e.g., with the specified QoS) to the E-CGW 735. At 1260, the E-CGW 735 may send the dedicated bearer response (e.g., with the specified QoS to the L-PC 745. At 1265, the L-PC 745 may send the QoS response for local service to the local network 750. At 1270, the L-PC 745 may send a notification to the MCN PCRF 711 about the dedicated LIPA connection. At 1275, the E-CGW 735 may activate the QoS enforcement rules. At 1280, a LIPA PDN dedicated connection may be established between the E-CGW 735 and the WTRU 102.

In certain representative embodiments, multi-radio access technology (multi-RAT) flow management for LIPA may be implemented. The E-PCRF 747 may provide packet filters and/or QoS (e.g., QoS requirements) to the E-PCEF 738, for example, based on policies maintained for active users in the E-SPR 746. Such policies may discriminate between users and/or the traffic flows they are using. Access rules and QoS (e.g., QoS requirements) may be assigned, accordingly. The E-PCEF 738 may utilize the combined resources of the E-CGW 735 to maintain the QoS using cellular and WiFi accesses.

In addition to or besides receiving user profile information from the E-SPR 746, the E-PCRF 747 may receive access network condition information from the E-ANM 736 and access network discovery information from the E-ANDSF 748. The E-PCRF 747 may receive traffic detection information from the E-PCEF/E-TDF 738/739.

In certain representative embodiments, control for multiple LIPA services over a single default LIPA PDN connection may be implemented.

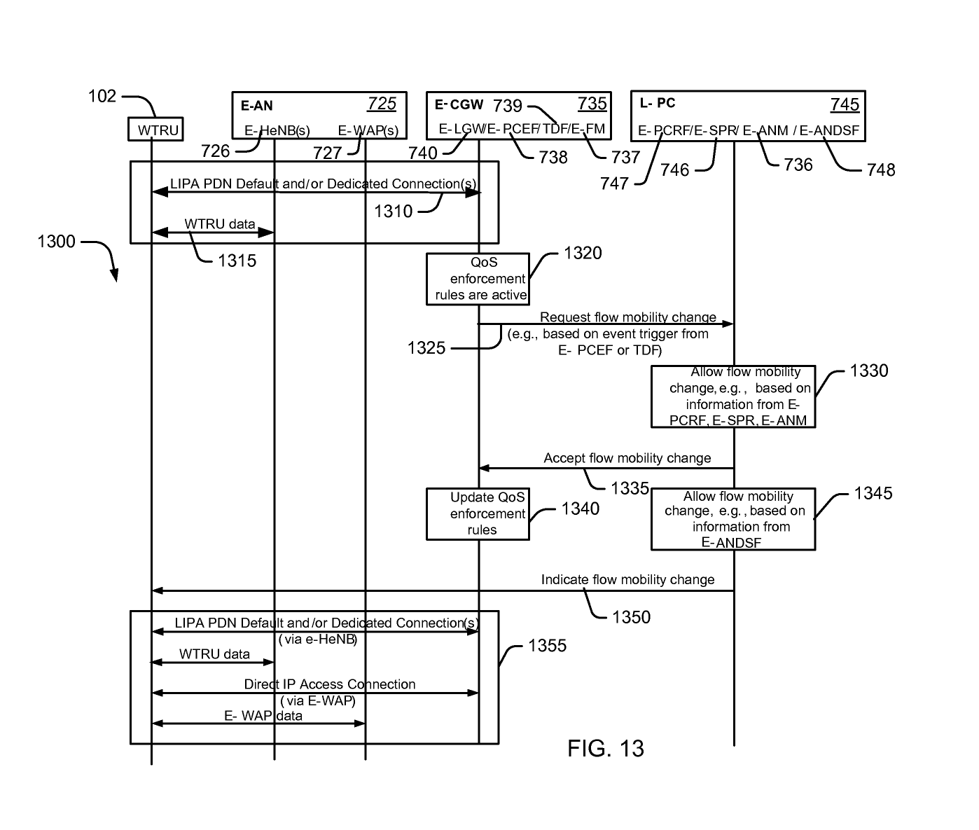

FIG. 13 is a diagram illustrating a representative multi-RAT flow management procedure 1300 based on enforcement of local QoS policy rules. Since the individual flows on the default PDN connections may each receive the same non-guaranteed QoS treatment, the E-CGW 735 may divert some of the flows to a WiFi connection. For example, in FIG. 13, this may be accomplished using “in-line” E-LGW functionality.

FIG. 13 is a diagram illustrating a representative multi-RAT flow management procedure 1300 based on enforcement of local QoS policy rules. Since the individual flows on the default PDN connections may each receive the same non-guaranteed QoS treatment, the E-CGW 735 may divert some of the flows to a WiFi connection. For example, in FIG. 13, this may be accomplished using “in-line” E-LGW functionality.

Referring to FIG. 13, at 1310, a LIPA PDN default and/or dedicated connection or connections may be established between the E-CGW 735 and the WTRU 102. At 1315, a 3GPP RAN connection may be established with WRTU data being exchanged between the WTRU 102 and HeNB 726. This WRTU data is destined to traverse through the mobile core network. A WRTU 102 many have two or more connections, including f the LIPA PDN default connection at 1310 and the 3GPP RAN connection at 1315. It may have other connections established including a direct IP Access Connection to the E-CGW 735 via the E-WAP 727 and/or a WLAN connection to the E-AN 725. For example, any one or more of these connections (e.g., the LIPA PDN connection, the 3GPP connection, the Direct IP connection, and/or the E-WAP connection) may be established or pre-established.

At 1320, QoS enforcement rules may be activated at the E-CGW 735. At 1325, the E-CGW may send a flow mobility change request to the L-PC 745. The timing of the flow mobility change request may be based on an event trigger from the E-PCEF 738 or E-TDF 739. At 1330, the L-PC 745 may allow the flow mobility change (e.g., based on information from the E-PCRF 747, E-SPR 746 and/or E-ANM 736) For example the information may be triggered by congestion related information and/or QoS related information, among others. At 1335, the L-PC 745 may send an accept flow mobility change notification to the E-CGW 735. At 1340, the E-CGW 735 may update the QoS enforcement rules. At 1345, the L-PC 745 may allow the flow mobility change, for example, based on information from the E-ANDSF 748. At 1350, the L-PC 745 may send to the WTRU 102 an indication indicating one or more flow mobility changes. At 1355, any flow over one of the existing connections may be modified to any other one of the connections to modify the path of the flows based on the indicated flow mobility changes sent to the WTRU 102. For example, the flows sent over the LIPA PDN default connection may be changed and sent over the WLAN connection.

Based on the WTRU request for services, the E-PCRF 747 may consult, for example, the employee profile and may adjust the QoS (QoS requirements and/or level), e.g., based on the employee's department (e.g., Engineering, HR, etc.), and/or real-time status (e.g., congestion due to ongoing meetings in a certain location, etc), among others. If non-business traffic is detected for a particular user based on the profile stored in the E-SPR 746, the E-PCRF 747 may update the E-PCEF 738 and the E-ANDSF 748, for example forcing the user onto the macro-cellular network such that personal usage does not congest the enterprise network 720.

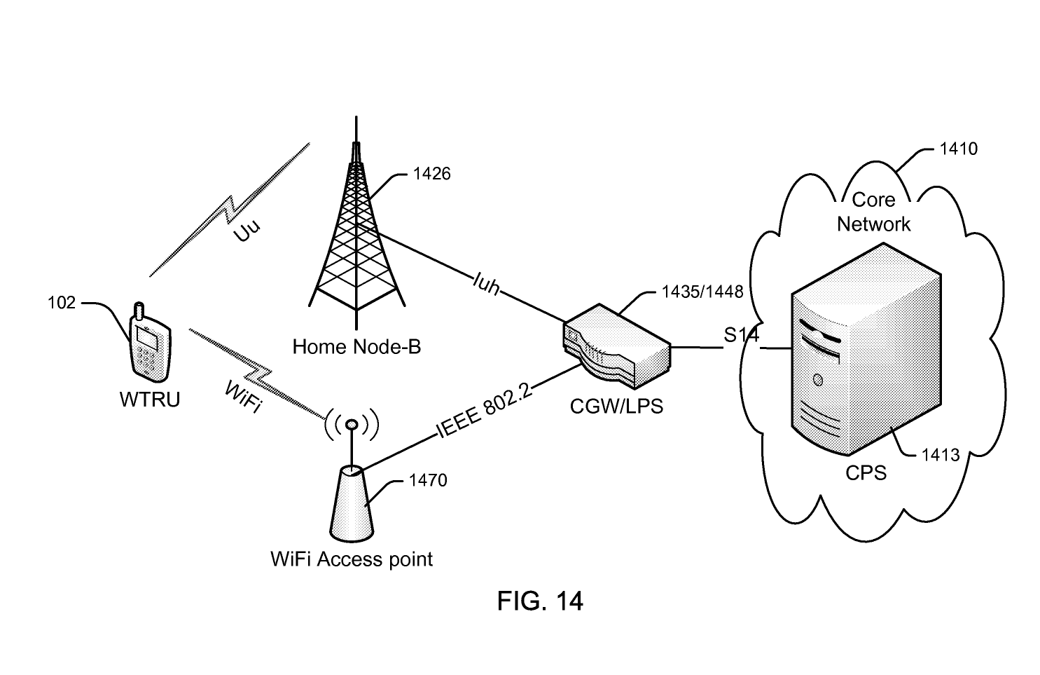

FIG. 14 is a diagram illustrating the deployment of the CGW (e.g., a local gateway or E-CGW) 1435 collocated with a local policy server (LPS or E-PC) 1448.

Referring to FIG. 14, the CGW 1435 along with the LPS 1448 may be positioned logically between Home NodeB (or HeNB) 1426 and WiFi access points 1470 and the core network 1410. The core network 1410 may include a central policy server CPS (e.g., an ANDSF) 1413 coupled to the CGW/LPS 1435/1448 via a S14 interface or reference point. The CGW 1435 may be coupled to the Home Node-B 1426 via a luh interface and the WiFi access point 1470 via an IEEE 802.2 interface. The CGW 1435 may permit dual mode (HSPA/LTE and WiFi) WTRUs 102 to benefit from locally available WiFi Local Area Network (LAN) to increase the available HSPA or Long Term Evolution (LTE) bandwidth. From a network topology, the CGW 1435 may be positioned between the Home Node B (HNB) 1426 and the Home Node B Gateway in the GPRS/HSPA context and between the eNode B or the HeNB and the MME and the SGW in the LTE context. The CGW 1435 may have direct access to the local WiFi subnet.

Although a single LPS 1448 is shown in FIG. 14, it is contemplated that more than one LPS may be implemented, each having an overlapping or non-overlapping area which it serves based on location of a WTRU 102 (e.g., which may be roaming).

Although a LPS 1448 and a CPS 1413 are shown in FIG.14, which may respectively represent first and second level policy servers, it is contemplated that the policy servers may be hierarchical and may include any number of levels of servers and any number of servers in a level with a single server as the CPS 1413. For example, a first hierarchical policy server system may include N first level (local) policy servers, M second level (intermediate) policy servers and one third level (central) policy server, where M and N are integer numbers.

The CPS 1413 and one or more LPSs 1448 (e.g., that may be associated with different portions or subsets of the global cellular network) may form a hierarchical structure to enable policy provisioning at the CPS 1413 (e.g., the top level policy server) or another level policy server (e.g., a lower level policy server) based on the location of the WTRU 102.

Although the LPS 1448 and the CGW 1435 are shown in FIG. 14 as collocated, it is contemplated that LPSs 1448 may be located anywhere and may have a communication interface (e.g., link) to a corresponding CGW 1435 or a group of CGWs 1435.

Although the CGW 1435 is shown with a Home NodeB 1426 in an LTE/HSPA network environment, it is contemplated that the CGW 1435 may be deployed with any number of different types of networks and/or radio access technologies.

In the Third Generation Partnership Project (3GPP) standard, a policy server is provided (e.g., a single Central Policy Server (CPS) for the entire network or a significant subset thereof) that may either have the role of a home policy server or the role of a visiting policy server, depending on whether the WTRU 102 is located in its home network or located in a visiting network. The policies may include sets of routing rules and network discovery information that may enable the WTRU 102 to find and connect to various wireless networks. The policy server (e.g., CPS) approach may not be appropriate when portions of the networks are managed by intermediate nodes and the network layout (e.g., full network layout) may not be known and/or visible to the CPS 1413.

The CGW 1435 may be a node that is located (e.g., placed) between the core network 1410 and one or more evolved Node-Bs and/or one or more WiFi Access Points (AP) 1470. The CGW 1435 may offer various bandwidth management services (e.g., functionalities) for or on a subset of a wireless cellular network. One component to offering bandwidth management services may be delivery of appropriate policies (e.g., rules) to enable control of policy content at a local bandwidth management server (e.g., policy content may be managed at a local level via a Local Policy Server (LPS) 1448 and/or at a central location via a CPS 1413.

Certain representative methods, apparatus and/or system may include structures and/or procedures to integrate the LPS 1448 (e.g., that may be collocated with an intermediate node, for example, the CGW 1435 or another network node) with a wireless and/or wired network. The intermediate node may be the CGW 1435 or any node capable of hosting the LPS 1448. The LPS 1448 may rely on the CPS 1413 to retrieve the WTRU policies that may be subsequently delivered to the WTRU 102. The retrieved WTRU policies may be customized for each WTRU 102 depending on the local network conditions. For example, a CPS 1413 may provide a first set of policies associated with the entire network. The first set of policies may address operations based on the entire network topology and/or operations. A LPS 1448 may provide a second set of policies associated with a particular subset of the entire network and may have an associated validity area (region and/or location) in which the policies of the LPS 1413 are valid. The second set of policies may address operations based on the particular subset of the network (e.g., corresponding to when the WTRU 102 is in the validity area, region, or location). The LPS policies may be used to perform bandwidth management activities/services. In certain exemplary embodiments, the validity area (e.g., registration validity area) may be implemented to permit the WTRU 102 to distinguish the jurisdictions of different policy servers.

The CGW server 1435 may be installed at a home, an office (e.g., small office) and/or a metro location and may perform various bandwidth management services by managing (e.g., aggregating and/or splitting flows and/or communications packets between or among) one or more H(e)NB 1426 and/or one or more WiFi access points 1470 (and/or WiFi hot spots). The CGW 1435 may integrate with a LPS 1448 and/or the LPS 1448 may be standalone (e.g., completely standalone) and may be provisioned independently of other devices (e.g., the CGW 1435). The LPS 1448 may act to provide local policies to intermediate nodes, such as the CGW 1435. The CPS 1413, which may provide an interface (e.g., only a S14 interface) between the WTRU 102 and the CPS 1413 (e.g., policy server), may not offer any provisions for policy propagation from the CPS 1413 into any intermediate node.

In certain representative embodiments, the policy server implementation may include a CPS 1413 (e.g., an Access Network Discovery and Selection Function (ANDSF)) that may communicate with the WTRU 102 through an S14 reference point. The ANDSF 1413 may provide via the S14 reference point the WTRU 102 with a set of policies (e.g., central and/or ANDSF policies) for attaching to the cellular network via the H(e)NBs 1426 and/or the WiFi network via the WiFi access points 1470 and for routing IP flow. The ANDSF 1413 may permit provisioning of the WTRU 102 with network discovery information. The ANDSF and/or CPS 1413 may follow procedures/protocols set forth by the Open Mobile Alliance (OMA) Device Management (DM) group.

### Representative Protocol Structure

The reference point between the WTRU 102 and the ANDSF (e.g., ANDSF server) may include an S14 interface as set forth in the 3GPP TS 24.302 standard entitled, “Access to the 3GPP Evolved Packet Core (EPC) via non-3GPP access networks Stage 3 (Release 10)”, V 10.4.0 and the 3GPP TS 23.402 standard entitled “Architecture enhancements for non-3GPP accesses (Release 10)”, V 10.2.1. The contents of each of these standards are incorporated by reference herein.

The S14 interface may be IP based and may permit both pull and push mechanisms (e.g., for policy dissemination). The ANDSF protocol may be established using Open Mobile Alliance (OMA) Device Management (DM). In certain representative embodiments, differing procedure and/or differing protocols for delivering the ANDSF messages are possible. For example, a Simple Object Access Protocol (SOAP) based transport protocol may be implemented.

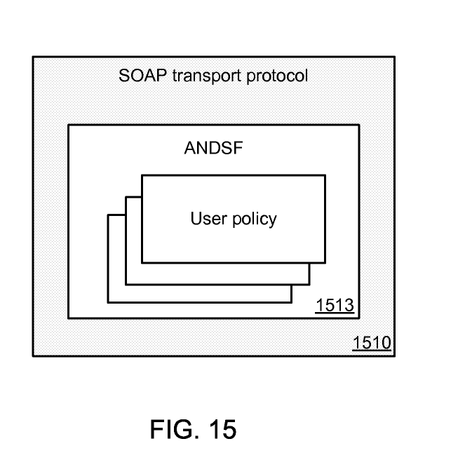

FIG. 15 is a diagram illustrating the integration of the ANDSF 1513 over a SOAP transport layer 1510.

Referring to FIG. 15, the protocol may be specified in two or more parts. A first part may include a Web Services Description Language (WSDL) (e.g., a typical WSDL) that may define the SOAP protocol messages. A second part may correspond to the Extensible Markup Language (XML) Schema Description (XSD) of the ANDSF Managed Object (MO) 3GPP extensions. For example, the MO 3GPP extensions may be as set forth in the 3GPP TS 24.312 standard entitled “Access Network Discover and Selection Function (ANDSF) Management Object (MO) (Release 11)”, V11.5.0, the contents of which are incorporated by reference herein.

### Representative Messages

The following SOAP messages/information elements may be defined (and/or implemented). For brevity, only certain information elements/messages are discussed below. One of skill understands that other SOAP messages, features, functions, and/or commands exist and may be used with the information elements discussed below to generate new procedures. In certain representative embodiments, new fields may be implemented.

A RegisterRequest message may permits the WTRU 102 to register with the policy server and may include any of the following information and/or fields: (1) a Mobile Subscriber Integrated Service Digital Network-Number (MSISDN) (e.g., for User identification); (2) an International Mobile Subscriber Identity (IMSI) (e.g., for User identification); (3) an International Mobile Equipment Identity (IMEI) (e.g., for User identification); (4) a Temporary_id (e.g., for temporary WTRU identification to provided for redirecting a server (e.g. for certain representative embodiments, it is contemplated that if and/or when the field is present, no other identification fields are used); and/or (5) Redirected_by (e.g., that may contain or include the identification, for example the name and/or address (IP address or other address)), of the CPS 1413 that is redirecting the WTRU 102), among others.

A RegisterResponse message may confirm the registration of the WTRU 102 and may include any of the following information and/or fields: (1) a SessionId (e.g., a session identification that may be used in any further communication with the policy server; (2) SessionTimeOut (e.g., a duration of the registration validity); (3) a validity_area (e.g., a list of locations (e.g., all of the locations) where the session is valid (and the content of this field may comport to (e.g., be defined by) XSD); (4) Redirected_to (e.g., that may contain or include the identification, for example of the name and/or address (IP address or other address) of the LPS that the WTRU 102 should or is to attempt to register with; and/or (5) Temporary_id (e.g., a temporary WTRU identification that may be provided by the redirecting server), among others.

An UnregisterRequest message may permit the WTRU 102 to unregister from the policy server and may include any of the following information and/or fields: (1) sessionId (e.g., the identification of a registration to be terminated); and/or (2) other information to identify the session or session attributes, among others.

An UnregisterResponse message may confirm that the WTRU 102 has unregistered from the policy server and may include any of the following information and/or fields: (1) IsUnregistered (that may contain or include the WTRU registration status) and/or other information, among others.

A SendAndReceive request message may permit the WTRU 102 to send requests to the policy server and may include any of the following: (1) a SessionId that may indicate a session identification; and/or (2) a read_set that may include the content of the ANDSF request message, for example as defined in 3GPP TS 24.312 and specified in XSD as the ReadSet element, among others.

A SendAndReceive response message may permit the policy server to return a response to the request issued by the WTRU 102 and may include any of the following: (1) a write_set that may include the contents of the ANDSF response message, for example as defined in 3GPP TS 24.312 and specified in XSD as the WriteSet element; (2) a Redirected_to that may contain or include the identification, e.g., name and/or address (for example IP address or other address) of the LPS 1448 that the WTRU 102 should or is to attempt to register with; and/or (3) the Temporary_id that may include the temporary WTRU identification provided by the redirecting server.

### Representative Message Exchange Using the Existing Scheme

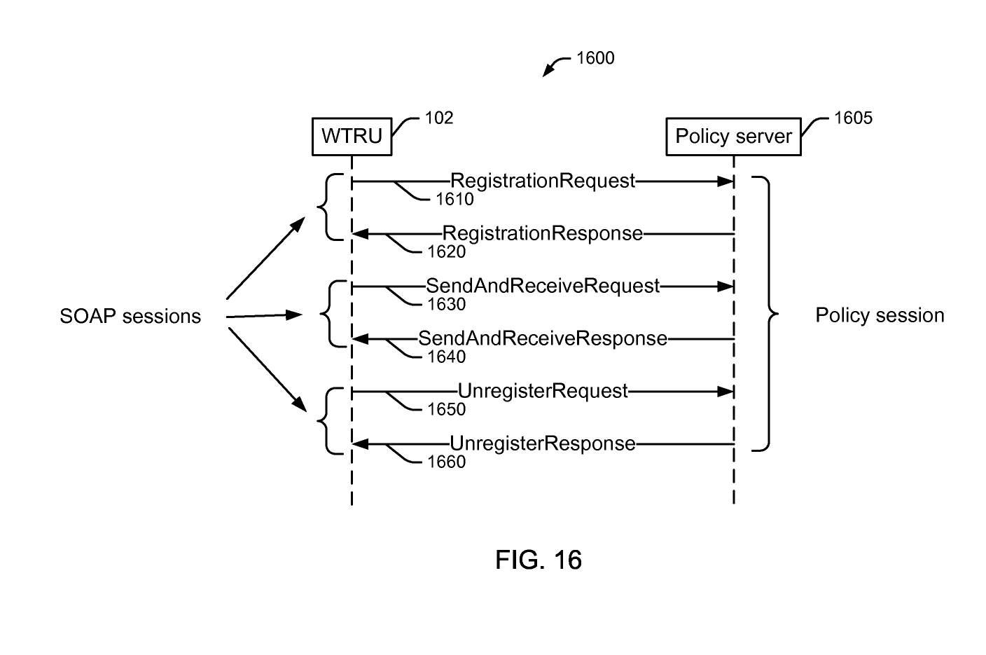

FIG. 16 is a diagram illustrating an interaction 1600 (e.g., a SOAP interaction) between a WTRU 102 and a policy server 1605.

Referring to FIG. 16, the interaction 1600 may include, at 1610, that the WTRU 102 may issue a RegistrationRequest message to the policy server 1605. Creation of a user session may be triggered by the RegistrationRequest message. At 1620, the policy server 1605 may reply via a RegistrationResponse message. The RegistrationResponse message may contain or include, for example, a SessionId, indentifying of a session (e.g., a unique session or a unique user session) that may be used by the WTRU 102 in subsequent messages (e.g., that may be used for messages associated with the identified session between the policy server 1605 and the WTRU 102). At 1630, the WTRU 102 may issue and/or send (e.g., periodically or aperiodically issue and/or send) a SendAndReceiveRequest message. These messages (e.g., the SendAndReceiveRequest messages) may be triggered for various reasons such as periodic analytics, reports, alarms and/or location updates (e.g., WTRU location updates), among others. At 1640, each SendAndReceiveRequest message (e.g., that is received by the policy server 1605) may trigger a SendAndReceiveResponse message that may contain or include the most current (e.g., latest) policy or policies (for example, stored by the policy server 1605). In certain representative embodiments, with hierarchical policy servers, the policy server 1605 may request an update from a higher-level policy server prior to sending the SendAndReceiveResponse message. At 1650, when the WTRU 102 is about to detach, the WTRU 102 may or may not send an UnregisterRequest message indicating deregistration of the WTRU 102, for example, from a cellular network and/or WiFi network (e.g., the H(e)NB 1426 and/or WiFi AP 1470). At 1660, if the UnregisterRequest message is sent, the policy server 1605 may reply to the UnregisterRequest message with an UnregisterResponse message to confirm the UnregisterRequest message.

It is contemplated that SOAP sessions may be established for each request message. A response message may be sent within or during the same SOAP session created for the request message. In certain representative embodiments, a session may be created based on one or more first type of messages (e.g., a first type of SOAP messages) and sessions may to terminated based on one or more second type of messages (a second type of SOAP messages).

Representative procedures associated with 1630 and/or 1640 (e.g., Send and Receive Request and Send and Receive Responses) may be repeated on a periodic (and/or aperiodic) basis during a session lifetime (e.g., a policy session lifetime).

In certain representative embodiments, the UnregisterRequest message may or may not be used as each session (e.g., policy session) may be assigned a lifetime such that termination of the session may be automatic (e.g., without the use of the UnregisterRequest message) after the lifetime of the policy has expired. For example, to maintain the policy session when a lifetime is assigned, the WTRU 102 is to issue a RegistrationRequest message within the specified time limit (e.g., lifetime) or the session will expire (e.g., and the WTRU 102 may detach with no further RegistrationRequest messages being issued by the WTRU 102).

A policy session referred to as a “session” herein may be created at the policy server 1605 after receiving a well-formed RegistrationRequest message (e.g., a complete or substantially complete RegistrationRequest message). At the WTRU 102, the session (e.g., policy session) may be created after receiving a well-formed RegistrationResponse message (e.g., a complete or substantially complete RegistrationResponse message). The session may last until the expiration of the validity time present in the RegistrationResponse or after an explicit unregister request (e.g., an UnregisterRequest message) from the WTRU 102. One of skill understands the difference between that a SOAP session established for the exchange of a single request response message and a policy session setup at the policy server 1605 and/or the WTRU 102.

### Representative Hierarchical Policy Server Deployment

A single policy server may be used per network for a home policy server or a visiting policy server. The WTRU 102 in this topology is to register with that policy server to retrieve policies.

In certain representative embodiments, the policy server topology may include, for example, a CPS and one or more LPSs. Each LPS may be responsible for a subset (e.g., overlaying or non-overlapping) of the cellular network, for example that may be managed by a CGW and/or other intermediary network node. Certain representative embodiments may implement a hierarchy of policy servers that may each use a registration validity area (e.g., the CGW and/or intermediary node being responsible for serving the WTRUs 102 in the registration validity area) as a registration constraint, as well as the session timeout value (e.g., lifetime).

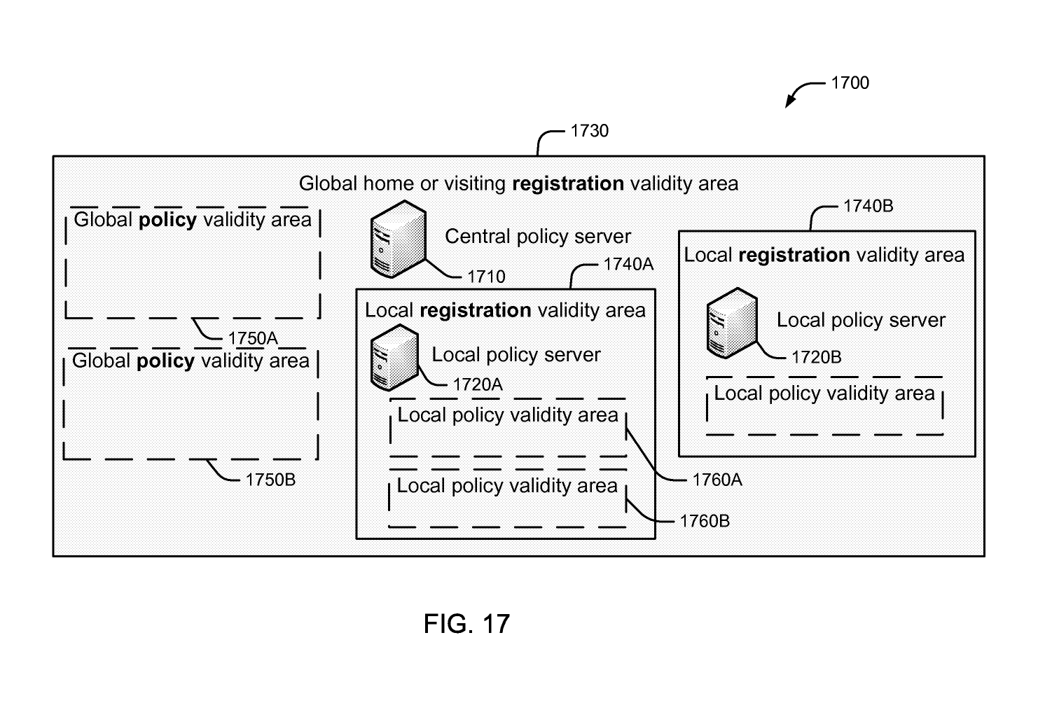

FIG. 17 is a diagram illustrating a representative hierarchical policy server system 1700 using LPSs with validity areas.

Referring to FIG. 17, the representative hierarchical policy server system 1700 may include a central home or visiting policy server (e.g. a CPS) 1710 and a plurality of LPS (e.g., two or more LPSs, such as a first LPS 1720A and a second LPS 1720B). The CPS (e.g., CPS server) 1710 may be responsible for providing policies to the WTRUs 102 roaming anywhere in the cellular network (e.g., the global area or global home or visiting registration validity area 1730), while the first and second LPSs 1720A/1720B may be responsible for providing policies to WTRUs 102 roaming, for example, in respective subsets of the global area (e.g., the first LPS 1720A may serve and/or manage a first subset of the global area (e.g., a first local registration validity area 1740A and the second LPS 1720B may serve and/or manage a second subset of the global area (e.g., a second local registration validity area 1740B). To receive the policies from a policy server (the CPS 1710 or one of the first or second LPSs 1720A or 1720B), the WTRUs 102 is to first register with that policy server 1710/1720A/1720B. The area served, managed, and/or covered by the CPS 1710 is the global registration validity area 1730. The global registration area 1730 may be subdivided into a plurality of global policy validity areas (for example, first and second global policy validity areas 1750A and 1750B). Each local registration area 1740A and 1740B may be subdivided into a plurality of local policy validity areas (for example, first and second local policy validity areas 1760A and 1760B associated with the local registration validity area 1740A).

The registration and/or the policies may be subject to validity area constraints. For example, a LPS 1720A corresponding to a first local registration validity area 1740A may not register and/or provide policies for a WTRU 102 roaming in a different, second local registration validity area 1740B. In certain representative embodiments, a validity area information element may be used with local and/or central policies (e.g., ANDSF policies or other policies), among others to identify a policy validity area (e.g., a local policy validity area and/or a global policy validity area).

### Representative Policy Validity Area and Registration Validity Area

A policy validity area may identify when a policy is valid. For example, a policy may be valid when the WTRU 102 is located in a specific area (e.g. the validity area). A validity area may contain or include one or more location identifications. The policy may be considered and/or determined as valid if the WTRU 102 is located in any of the associated locations (e.g., based on a logical OR operation).

The validity area information element (IE) may contain or include any of the following fields: (1) a 3GPP Location that may be, for example (i) a PLMN, (ii) a Tracking Area Code (TAC), (iii) a Location Area Code (LAC), (iv) a GERAN Cell Identification (GERAN_CI), (v) a UTRAN Cell Identification (UTRAN_CI), and/or (vi) an EUTRA Cell Identification (EUTRA_CI), among others; (2) a 3GPP2 Location that may be, for example (i) a System ID (1× SID), (ii) a Network ID (1× NID), (iii) a Base Station ID (1× Base ID), (iv) a High Rate Packet Data (HRPD) Sector ID, and/or (v) a HRPD Netmask, among others; (3) a WiMAX Location that may be, for example (i) a Network Access Provider ID (NAP-ID) and/or (ii) a Base Station ID (BS-ID), among others; (4) a WLAN Location that may be, for example (i) a Homogenous Extended Service Set Identifier (HESSID), (ii) a Service Set ID (SSID), and/or (iii) a Basic Service Set ID (BSSID), among others; (5) a Geo-location (circular definition) that may be, for example (i) a latitude (ii) a longitude and/or (iii) a radius, among others.

For example, the associated locations may contain or include two SSIDs, one BSSID, and five GENRAN_CIs.

The validity area IE may be associated with and/or sent with the WTRU RegistrationResponse message. Any policy server may return a validity area in the RegistrationResponse message which identifies to the WTRU 102 that when the WTRU 102 leaves a given area the registration is no longer valid and that the WTRU 102 is to or shall attempt to register with a CPS 1710. During the attempt, a LPS (e.g., first LPS 1720A may be discovered and the WTRU 102 may register with the discovered first LPS 1720A.

### Representative Implementations

The WTRU 102 may be registered with a CPS 1710 and may roam around a network. The CPS 1710 may not or does not provide any registration request validity. If the CPS 1710 is reachable (e.g., always reachable), every time the WTRU 102 changes location (e.g., Cell ID, PLMN, and/or SAID, among others), the WTRU 102 may send a SendAndReceived request to the CPS 1710 that indicates its new location.

The WTRU 102 may roam into an area where a LPS 1720 is present. The WTRU 102 may send a SendAndReceived message to the CPS 1710 (e.g., because of the location change). During the message exchange, the LPS 1720 may be discovered. The CPS 1710 may refer the WTRU 102 to the LPS 1720.

The WTRU 102 may register with the LPS 1720. The RegistrationResponse may contain or include a validity area IE that may specify the identifications of the locations (e.g., all the locations) covered by the LPS 1720.

As the WTRU 102 roams between the different locations specified in the policy validity area associated to RegistrationResponse message, the WTRU 102 may send location update messages to the LPS (e.g., via SendAndReceive messages).

The WTRU 102 may roam into a new area that is not listed in the local validity area 1740 and/or 1760 that the WTRU 102 has received with the RegistrationResponse message. The WTRU 102 may not or will not send a location update. The WTRU 102 may trigger a CPS registration request message. During the registration process, a LPS 1720 may be discovered.

When the LPS 1720 provides a policy to the WTRU 102, the associated policy validity area 1760 is to be a subset of the registration area. In this situation, the LPS 1720 does not provide any policy validity area (e.g., any validity area information elements) with a policy and the WTRU 102 may assume or determine that the policy validity area is equivalent to the current registration validity area.

The SOAP RegistrationResponse message may contain or include a validity area information element, for example as defined in TS 24.312 for the policy validity area. Each information element of the validity area may contain or include the identification of either a cellular or a Wireless Local Area Network (WLAN) location.

In the case of the registration with the CPS 1710, the registration validity area IE may not have to be included and/or present in the RegistrationResponse message, as the global validity area may be a default (e.g., considered as the default setting). This is justified by the fact that the CPS may provide policies to a very large amount of location and, hence, the validity area information may be very large. In the case of registration with a local policy server 1720, the validity area list is to be present and/or included in the RegistrationResponse message because the validity area may define (or may set) the subset of the global network that is serviced (e.g., served or managed) by the LPS 1720. The validity area IE may cause (e.g., may force) the WTRU 102 to trigger a new registration with the LPS 1720 and/or the CPS 1710 as soon as (or when) the WTRU 102 leaves or is determined to have left the location that is managed (e.g., served) by the LPS 1710.

### Representative Policy Server Priority

During the registration procedure, the WTRU 102 may receive a response message containing or including redirection information from the CPS 1710. The redirection information may point to the LPS 1720. The WTRU 102 may choose to register with the pointed to LPS 1720 (established in the redirection information) or the CPS 1710. The WTRU 102 may already be registered with the CPS 1710 and may receive a response message that may contain or include redirection information after issuing any other request to the CPS 1710 (e.g. a location update request). Even though the WTRU 102 may use either the LPS 1720 or CPS 1710, the LPS 1720 may (e.g., may always or shall always) be preferred because it may have a better knowledge of the topology and operating conditions (and/or other conditions) of the network that the WTRU 102 is roaming into.

### Representative Security Procedures

The security implementation for the S14 interface (reference point) between the CPS 1710 (e.g., ANDSF) and the WTRU 102 may include the following: (1) The WTRU 102 may (e.g., should or is to) be able to verify that the ANDSF 1710 is authorized to serve it; (2) signaling over the S14 reference point may (e.g., shall or is to) be integrity protected; (3) signaling over the S14 reference point may (e.g., shall or is to) be confidentiality protected; and/or (4) signaling over the S14 reference point may (e.g., shall or is to) be protected against possible replay attacks.

One of skill understands that the above may define a security mechanism that implies a trust relation between the policy server 1710 (e.g., CPS) and the WTRU 102 that may authenticate each side. In certain representative embodiments, the WTRU 102 may be permitted to access a Network Application Function (NAF) using HTTPS and may rely on a Generic Bootstrapping method, for example as described in 3GPP TS 33.222 V10.0.1 entitled “Generic Authentication Architecture (GAA) Access to network application function using HTTPS (Release 10)” and 3GPP TS 33.220 V10.1.0 entitled “Generic Authentication Architecture (GAA) Generic Bootstrapping Architecture (GBA) (Release 10)”, the contents of each being incorporated by reference herein.

Representative Operation with Hierarchical Policy Servers

The WTRU 102 may have the capability to connect to the closest available policy server in a hierarchical policy server system. In certain representative embodiments, a LPS discovery mechanism may be implemented.

### Policy Server Discovery for the CPS

The CPS name may be derived based on the network identity (e.g., a Mobile Network Code and/or a Mobile Country Code, among others). A DNS server may be queried based on the derived name (e.g., and/or values/codes). Other procedures may include querying the DHCP server during the IP stack configuration to obtain the IP address of the policy server. These procedures may not be adequate for discovery of the LPSs 1720, because it is contemplated that the areas managed by a LPS 1720 may not have a different identity and/or that the IP stack configuration may not be triggered based on the WTRU 102 roaming into an area managed by a LPS 1720.

### Representative LPS Discovery Procedures

In certain representative embodiments, LPS discovery procedures may be implemented, and may include any of the following: (1) the LPS discovery may be triggered by a global registration or by any update (e.g., a periodic update or other update) issued by the WTRU 102 and/or other communication between the CPS 1710 and WTRU 102, among others; (2) the discovery mechanism/procedure may be transparent; (3) the discovery mechanism may not use a dedicated configuration (e.g., any dedicated configuration) on the WTRU 102 and may operate in each WTRU state including connected mode and/or idle mode states; (4) the WTRU 102 may not use a preconfigured security association (e.g., any preconfigured security association) with the LPS 1720; (5) the security association between the WTRU 102 and LPS 1720 may be established and/or changed dynamically (e.g., before and/or during a LPS session; (6) the redirection to the LPS 1720 may be authorized and/or monitored by the CPS 1710; and/or (7) the WTRU 102 may not disclose its identity to the LPS 1720, for example by establishing a temporary identity for the WTRU 102.

### Representative Redirection to the LPS

In a CGW or intermediary node implementation, WTRU traffic may be forwarded by the CGW (or intermediary node, for example CGW 1435) that may acts as a local gateway. The CGW 1435 may perform deep packet inspection (DPI) of the traffic sent to, from, or by the WTRU 102 to perform, for example, flow-based load balancing tasks. The CGW 1435 may host and/or may work in conjunction with the LPS 1448. The LPS 1448 may generate one or more policies that control, permit and/or influence the traffic routing and the WTRU network connectivity (e.g., which RAT the WTRU 102 may attached to), for example, to enhance the user experience.

The policy signaling issued by the WTRU 102 may be detected by the CGW 1435 (e.g., using a protocol type and/or a port number). Because of security concerns, other than detection of the communication itself between the WTRU 102 and the CPS 1413, the communication between the WTRU 102 and the CPS 1413 may not be inspected and/or tampered with by the CGW 1435 and/or the LPS 1448. The CGW 1435 may not be able to transparently redirect the WTRU request to the LPS 1448 without explicitly involving both the WTRU 102 and the CPS 1413. The CPS 1413 may be notified about the location of the WTRU 102 to issue the appropriate redirection message.

In certain representative embodiments, the registration message may include location information (e.g., may be augmented with the location information) that may be provided by a client in a location update message. The CPS 1413 may be configured to associate the location with a respective LPS 1448 (e.g., that manages the subset of the global network at that location). Upon or after receiving the registration request message, the CPS 1435 may send a redirection message to the WTRU 102 specifying an appropriate LPS 1448.

In certain representative embodiments, the messages sent through the intermediary node (e.g., the CGW) 1435 may be embedded by the CGW/LPS 1435/1448 into another message. In certain representative embodiments, the session established by or via the WTRU 102 to communicate with the CPS 1413 may be embedded in another session established by the CGW 1435 with the CPS 1413. These tunneling procedures may permit the CPS 1413 to distinguish which CGW/LPS 1435/1448 the message request is coming through.

The CPS 1435 may use the above representative procedures to redirect the WTRU 102 request to the appropriate LPS 1448. One of skill understands that many options are available for implementing the CGW—policy server secure tunnel A few examples include Secure Shell (SSH) tunneling, IPSec tunneling and/or Transport Level Security (TLS).

The above representative procedures may ensure that the use of the LPS 1448 is enforced (or enforceable) by the CPS 1413. The representative procedures that include augmentation of the location information may include a policy server having a database of locations (e.g., all locations) associated to the CGWs 1435 (e.g., all of the CGWs 1435 in the global network).

The CGW 1435 and the LPS 1448 may be implemented to hide the local network configurations and to permit organizations to manage their networks (e.g., autonomously manage their networks). The representative procedures using an embedded message and/or session may not use augmented location information, the CPS 1413 with a location database and/or knowledge of the network serviced by the CPS 1413.

In certain representative embodiments, transport protocol may be used to issue a redirection request. In one example, a SOAP protocol may be used to implement the redirection request. Because SOAP uses a Hyper Text Transfer Protocol (HTTP) transport layer, the server may respond with a 302 HTTP response code referring to the IP address of the LPS 1448.

In certain representative embodiments, the application level protocol may be used to issue the redirection request by adding redirection information at that application level protocol, for example, to the content of SOAP messages. For example, the registration response message may be modified to add one or more fields indicating the redirection decision and/or to provide the location of the LPS 1448.

In certain representative embodiments, the WTRU 102 may avoid disclosing its identity to the LPS 1448 by having the CPS 1413 provide a temporary identity to the WTRU 102 that is to be used when registering with the LPS 1448. The temporary identity may be added to the application level protocol; however, it may be added to other layers in place of or in addition to the application level protocol, as well.

In certain representative embodiments, the redirection information along with the temporary WTRU identification may be added to the application level protocol, for example, by adding “Redirected_to” and “Temporary_id” fields. These fields may be added to the response messages that are issued by the policy server. The “Redirected_to” field may contain or include the IP address of the LPS 1448 and the “Temporary_id” field may contain or include the temporary identification of the WTRU 102. The relation between the temporary and permanent WTRU identifications may be managed at the CPS 1413. A temporary identification may be created by the CPS 1413 upon or after the first redirection of the WTRU 102. The WTRU 102 may use the temporary identity for the registration attempts with a given LPS 1448. The temporary identity may be used by the LPS 1448 (e.g., local server) when the LPS 1448 performs requests for a given WTRU 102.

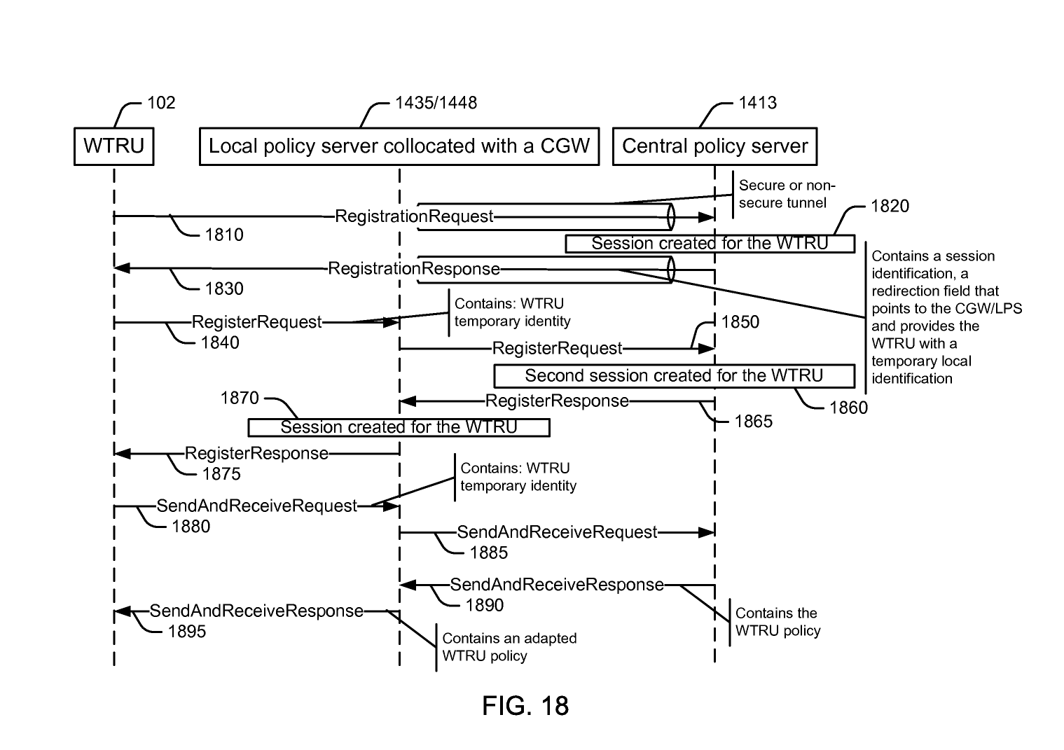

FIG. 18 is a diagram illustrating a representative procedure 1800 for registration and redirection.

Referring to FIG. 18, the representative procedure for registration and redirection may include the WTRU 102 in communication with a LPS collocated with the CGW (e.g., CGW/LPS 1435/1448). At 1810, the WTRU 102 may send a registration request to the CPS 1413 through the CGW/LPS 1435/1448. The CGW/LPS 1435/1448 may detect the CPS policy request. The CGW/LPS 1435/1448 may establish a secure tunnel or a non-secure tunnel toward the CPS 1413 and may forward the WTRU 102 request toward the CPS 1413 through the established tunnel At 1820, the CPS 1413 may create or generate a session for the WTRU 102. Based on the tunnel (e.g., thanks to the tunnel), the CPS 1413 may understand, determine and/or know which LPS 1448 has forwarded the WTRU 102 request. The CPS 1413 may create or generate a temporary WTRU identification and may add redirection information. The redirection target may be sent to the IP address of the LPS 1448 that may correspond to the other end of the tunnel between the LPS 1448 and the CPS 1413. At 1830, the CPS 1413 may send a response to the WTRU 102 through (or via) the tunnel The response may be de-tunneled at the LPS 1448 and may be forwarded to the WTRU 102. The WTRU 102 may attempt to create a session with the LPS 1448 or ignore the redirection information and may continue the session with the CPS 1413. At 1840, the WTRU 102 may issue or send a registration request to the LPS 1448 using the temporary WTRU identification obtained at 1820. At 1850, upon or after the reception of the registration request, the LPS 1448 may generate a registration request to the CPS 1413. The WTRU 102 may be identified by the temporary identification for the LPS 1448. At 1860, the CPS 1413 may create a second session for the WTRU 102. The second session may be maintained by the LPS 1448 (e.g., the LPS 1448 may track the time and may send the appropriate requests to keep alive (and/or maintain) the session). At 1865, the CPS 1413 may issue a registration response to the LPS 1448. At 1870, the LPS 1448 may create a local session for the WTRU 102. At 1875, the LPS 1448 may send a successful registration response to the WTRU 102 that contains or includes a registration policy validity area. At 1880, the WTRU 102 may issue a request to the LPS 1448 that may trigger a policy download. At 1885, the LPS 1448 may issue the same request to the CPS 1413 using the established session at 1830. At 1890, the CPS 1413 may provide a WTRU policy to the LPS 1448 in a SendAndReceive Response message. The LPS 1448 may adapt the received policy to its local network conditions before passing the received policy to the WTRU 102. The LPS 1448 may provide the policy to the CGW 1435 (e.g., which may apply the policy on the downlink traffic). At 1895, the LPS 1448 may send the adapted policy to the WTRU 102.

Although in FIG. 18, the redirection may be triggered by the initial registration sequence, it is contemplated that the redirection may be triggered by any request issued by the WTRU 102 toward the CPS 1413 and may occur (e.g., may be more likely to happen) on a WTRU location update or a periodic message issued by the WTRU 102.

The discovery process may include the following sessions:
(1) a WTRU 102—CPS session may be established during the LPS discovery (The WTRU 102 may have a choice to use this WTRU—CPS session (e.g., WTRU to CPS session) and may not attempt to register with the CPS 1413. If the WTRU 102 establishes a session with the LPS 1448, the WTRU —CPS session may be abandoned by the WTRU 102 (e.g., the WTRU 102 may fail to re-register after the session has expired));
(2) a WTRU—LPS session may be established by the WTRU 102, if the WTRU 102 accepts to follow the redirection issued by the CPS 1413; and
(3) a LPS—CPS session may be established by the LPS 1448 using a WTRU temporary identification to: (i) validate the WTRU temporary identification; and/or (ii) fetch the WTRU 102 policies from the CPS 1413; (These policies may be modified (or further modified) before being sent to the WTRU 102. As the CPS 1413 is aware that the session is not established with the WTRU 102, but with an intermediate agent (e.g., the LPS), it may provide more generic policies to the LPS 1448).

### WTRU Authentication at the LPS

In certain representative embodiments, the WTRU 102 may not share any credentials with the LPS 1448 and the LPS 1448 may rely on the CPS 1413 or the Enhance Packet Core for validating the WTRU 102. As shown in FIG. 18, the LPS 1448 may forward the registration request that contains or includes the temporary WTRU identification to the CPS 1413. Upon or after a successful response, the LPS 1448 may assume the validity of the WTRU 102 and its temporary identity.

In certain representative embodiments, each WTRU 102 may be authenticated by the LPS 1448 and the CGW 1435 may be aware of the different bearers setup by the WTRU 102. The CGW 1435 may be aware of the WTRU IP address assignment. At the CGW 1435, the WTRU cellular traffic (e.g., all of the WTRU cellular traffic) may be intercepted directly from the bearers. Since the bearers are already authenticated, this architecture/system can ensure the legitimacy of the traffic and may implicitly certify the IP address assignment to the different WTRUs 102. The LPS 1448 may assume and/or determine that the IP address information of the WTRU 102 obtained from the CGW 1435 is legitimate. Where the LPS is configured to provide generic policies generated or pre-configured locally without input from (e.g., any input from) the CPS 1413 (e.g., for the WTRUs 102 (all of the WTRUs)) that are attached to the cellular RAT, the LPS 1448 may avoid establishing any sessions with the CPS 1413. The WTRUs 102 (e.g., that support multiple simultaneous RAT attachments (e.g., WiFi and cellular)) may utilize their cellular IP address for the communication with the policy server and may issue, for example, a request message through or via the cellular bearers.

In the case of WTRUs 102 that do not support simultaneous multiple RAT attachments, when these WTRUs 102 are attached using WiFi, the LPS 1448 may confirm their identity by issuing requests to the CPS 1413.

### Other Representative Security Considerations

The signaling between the WTRU 102 and the policy server may be encrypted. In certain representative embodiments, the communications protocol may use a SOAP protocol that relies on Hyper Text Transfer Protocol (HTTP) for the transport layer. In certain representative embodiments, the HTTP transport layer may be augmented with TLS protocol (or an equivalent protocol). For example, the generic authentication architecture (e.g., described in 3GPP TS 33.222 V10.0.1, 3GPP TS 33.220 V10.1.0 and 3GPP TS 33.221 entitled “Generic Authentication Architecture (GAA) Support for subscriber certificates” (Release 10)”, the contents of which are incorporated by reference herein) may be integrated with or ancillary to the policy server communication process. The integrated approach may consist of or include the CPS 1413 acting as bootstrapping server function (BSF) and the LPS 1448 acting as a network application function (NAF). In the ancillary approach, the BSF function may be separated from the policy server information process and both the LPS 1435 and CPS 1413 may act as NAFs.

It is also possible to ensure that exchanges (e.g., all of the exchanges) between the WTRU 102 and the LPS 1448 may be performed through the CPS 1413.

### Representative Operation Modes

The LPS 1448 may allow for localized management of IP traffic and may permit a more appropriate usage of the local resources (e.g., without forcing the WTRU 102 to establish a session with the LPS 1448). The following operation modes may be used.

Localized mode in which the SendAndReceive requests (e.g., all of the SendAndReceive requests) may be handled (e.g., exclusively handled) by the LPS 1448. For example, after the WTRU registration request, there may be no further message exchanges between the LPS 1448 and the CPS 1413. The LPS 1448 may fetch the initial policy from the CPS 1413 by sending the first SendAndReceive request to the CPS 1413.

Centralized mode in which the SendAndReceive requests (e.g., all of the SendAndReceive requests) may be handled (e.g., exclusively handled) by the CPS 1413. For example, for each SendAndReceive request received from the WTRU 102, the LPS 1448 may generate an equivalent SendAndReceive request that is sent to the CPS 1413.

Hybrid mode in which, for all or selected WTRUs 102, SendAndReceive requests may be forwarded to the CPS 1413. The LPS 1448 may modify the content of the SendAndReceive responses to satisfy some local load balancing conditions.

Bypass mode in which the WTRU 102 may ignore redirection information and may only rely on the session established with the CPS 1413.

Each of the above-mentioned modes may be applied to a different subset of WTRUs 102 by a given LPS 1448. The selected mode of operation depends on the configuration and/or the implementation of the LPS 1448.

### Representative LPS Failure

If the LPS fails to answer (e.g., respond to) the WTRU requests, the WTRU 102 may fallback on the established session with the CPS 1413 (e.g., the session may be re-established). In that case, the WTRU messages may continue to be tunneled by the CGW/LPS 1435/1448, causing the CPS 1413 to add redirection information to the response messages. The WTRU 102 may attempt (e.g., periodically attempt) to register with the LPS 1448. The CPS 1413 may answer to (e.g., respond to) the WTRU requests, as if operating without the LPS 1448.

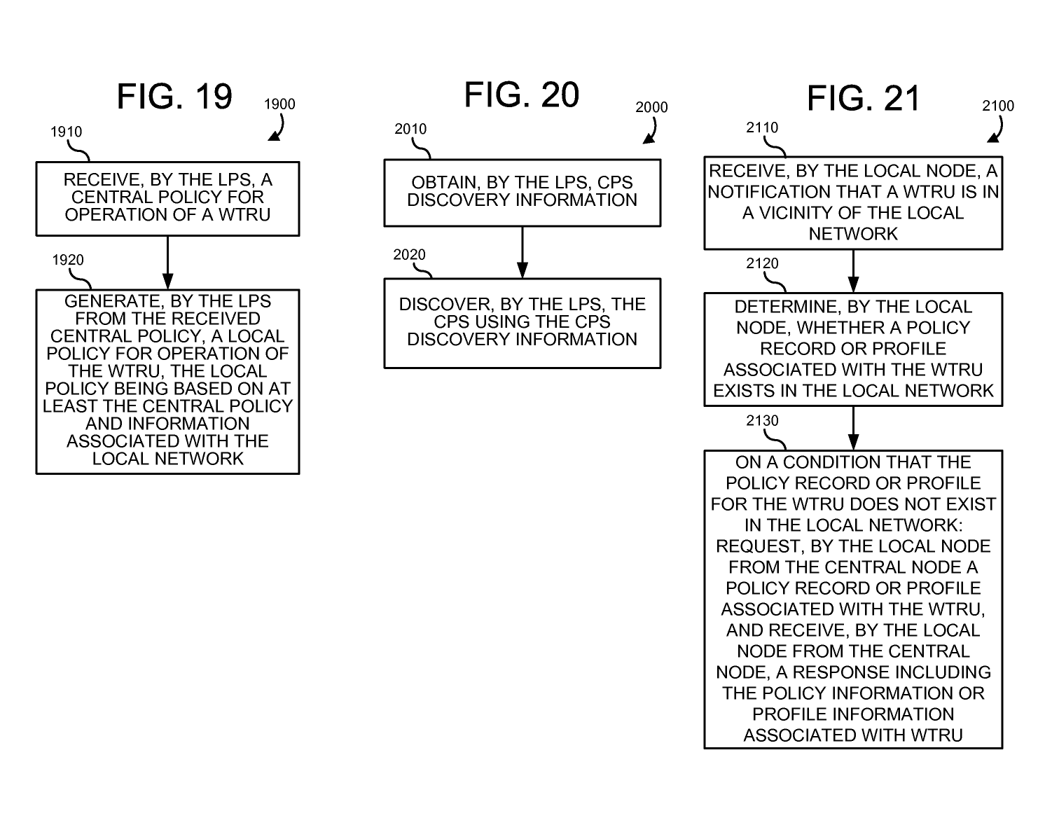

FIG. 19 is a flowchart illustrating a representative method 1900 implemented by a LPS 1448.

Referring to FIG. 19, the representative method 1900 may include the LPS 1448 being collocated with a local network. At block 1910, the LPS 1448 may receive a central policy for operation of a WTRU 102. At block 1920, the LPS 1448 may generate, from the received central policy, a local policy for operation of the WTRU 102. The local policy may be based on at least the central policy and information associated with the local network.

In certain representative embodiments, the CPS 1413 may include an ANDSF and/or the LPS 1448 may include an enterprise ANDSF.

In certain representative embodiments, the LPS 1448 may receive from the WTRU 102, a request for policy information and may send to the WTRU 102, the generated local policy for operation of the WTRU 102 when served by the local network.

In certain representative embodiments, the central policy may be for operation of the WTRU in a first region (e.g., the global registration and/or validity area) and/or the local policy may be for operation of the WTRU 102 in a second region, which is a portion of the first region (e.g., a local registration and/or validity area).

In certain representative embodiments, the first region may include a mobile operator network and/or the second region may include an enterprise network.

FIG. 20 is a flowchart illustrating another representative method 2000 implemented by a LPS 748.

Referring to FIG. 20, the representative method 2000 may include the LPS (e.g., E-ANDSF 748) being collocated with an enterprise network 720. At block 2010, the LPS 748 may obtain CPS discovery information. At block 2020, the LPS 748 may discover the CPS (e.g., ANDSF 713) using the CPS discovery information.

In certain representative embodiments, the LPS 748 may request from the CPS 713 central policy information (and/or central policies), may receive from a WTRU 102 a request for policy information and/or may send to the WTRU 102, an enterprise policy associated with the WTRU 102. For example, the enterprise policy may be based on the central policy information and may be further based on operational information associated with the enterprise network 720.

It is contemplated that the operation associated with FIG. 20 may occur in any order such that the central policy information may be pre-fetch or fetch in response to a request from the WTRU 102.

In certain representative embodiments, the enterprise policy may be generated using the central policy information and at least operational information associated with the enterprise network 720.

In certain representative embodiments, the LPS 748 may send to the CPS 713 a message that may include location information to indicate a location of the LPS 748. The message may request global system policy information from the CPS 713.

In certain representative embodiments, the LPS 748 may receive the global system policy information and may autonomously set (e.g., with human intervention) the enterprise policies using the global system policy information.

In certain representative embodiments, the LPS 748 may receive a subset (e.g., only a subset) of the global system policies associated with the CPS 713. The subset of the global system policies received may be those relevant to the location indicated in the message (e.g. the location associated with the LPS 748).

In certain representative embodiments, the LPS 748 may update a management object (e.g., for managing the local policies) based on the received subset of the global system policies.

FIG. 21 is a flowchart illustrating a representative method 2100 implemented by a local node 747 and/or 748.

Referring to FIG. 21, the representative method 2100 may include the local node (e.g., the E-PCRF 747 and/or the E-ANDSF 748) located in a local network 720 using (e.g., communicating with) a central node (e.g., the PCRF 711 and/or the ANDSF 713). At block 2110, the local node 747/748 may receive a notification that a WTRU 102 is in a vicinity of the local network (e.g., enterprise network 720). At block 2120, the local node 747/748 may determine whether a policy record or profile associated with the WTRU 102 exists in the local network 720. If not (e.g., on a condition that the policy record or profile for the WTRU 102 does not exist in the local network 720), the local node 747/748 may request from the central node 711/713 a policy record and/or profile associated with the WTRU 102. At block 2130, the local node 747/748 may receive from the central node 711/713 a response including the policy information and/or profile information associated with the WTRU 102.

In certain representative embodiments, the central node 711/713 may be located in the core network (e.g., mobile core network 710) and may include the ANDSF 713 and/or the local node 747/748 may include an enterprise ANDSF 748.

In certain representative embodiments, the central node 711/713 may include the PCRF 711 and/or the local node 747/748 may include an enterprise PCRF 747.

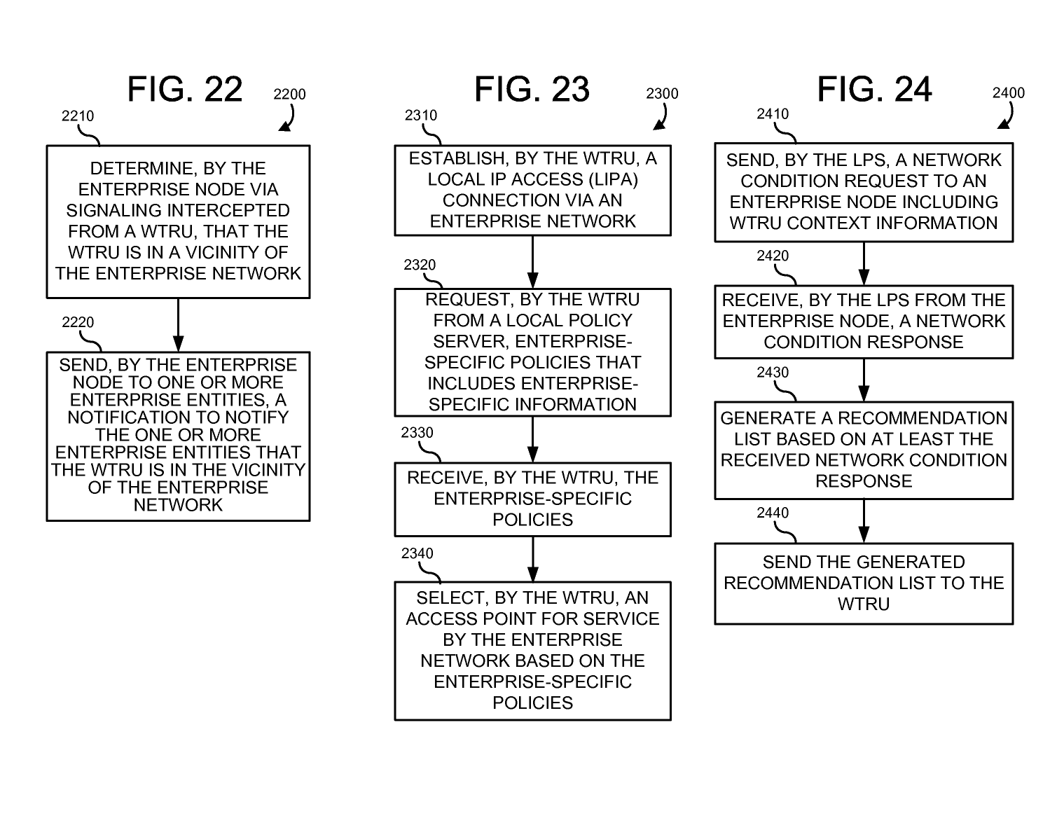

FIG. 22 is a flowchart illustrating a representative method 2200 implemented by an enterprise node.

Referring to FIG. 22, the representative method 2200 may include the enterprise node (e.g., E-CGW 735) located in the enterprise network 720. At block 2210, the enterprise node 735 may determine via signaling intercepted from a WTRU 102 (for example, via deep packet inspection of packets traversing the enterprise node 735) that the WTRU 102 is in a vicinity of the enterprise network 720. At block 2220, the enterprise node 735 may send to one or more enterprise entities (e.g., E-SPR 746 and/or E-PCRF 747), a notification to notify the one or more enterprise entities 746/747 that the WTRU 102 is in the vicinity of the enterprise network 720. In certain representative embodiments, the signaling may be sent (e.g., sent directly to the enterprise node 735 for notification of other enterprise resources).

FIG. 23 is a flowchart illustrating a representative method 2300 implemented by a WTRU 102.

Referring to FIG. 23, the representative method 2300 may include, at block 2310, the WTRU 102 establishing a local IP access (LIPA) connection via an enterprise network 720. At block 2320, the WTRU 102 may request from a LPS (e.g., E-ANDSF 748), enterprise-specific policies that may include enterprise-specific information. At block 2330, the WTRU 102 may receive the enterprise-specific policies. At block 2340, the WTRU 102 may select an access point for service by the enterprise network 720 based on the enterprise-specific policies.

In certain representative embodiments, the request from the LPS 748 may include a request for access point selection and IP flow routing policies that may be based on operational information from one or more enterprise nodes (e.g., network conditions, for example from the enterprise AN monitor 736) and/or visibility information from the WTRU 102.

FIG. 24 is a flowchart illustrating a further representative method 2400 implemented by a LPS 748.

Referring to FIG. 24, the representative method 2400 may include, at block 2410, the LPS 748 sending a network condition request to an enterprise node (e.g., E-AN monitor 736. The network condition request may include WTRU context information (for example, a WTRU identifier, the WTRU location, and/or other information or characteristics of the WTRU 102, among others). At block 2420, the LPS 748 may receive from the enterprise node 736, a network condition response providing information regarding the state of the network including congestion information loading, and/or load-balancing, among others. At block 2430, the LPS 748 may generate a recommendation list based at least the received network condition response. At block 2440, the LPS 748 may send the generated recommendation list to the WTRU 102. The recommendation list may include a list of recommended networks for attachment and a preferred network for attachment. In certain representative embodiments, the list may be in priority order.

In certain representative embodiments, the LPS 748 may send to the WTRU 102, a request for an access network visibility list indicating one or more access networks in a vicinity of the WTRU 102 and/or may receive from the WTRU 102, the visibility list. For example, the recommendation list may be generated based on at least the network conditions response and/or the visibility list (e.g., received visibility list).

In certain representative embodiments, the LPS 748 may receive one of: (1) a request for enterprise-specific policies from the WTRU 102 or subscription information and corresponding policies from one or more other enterprise nodes.

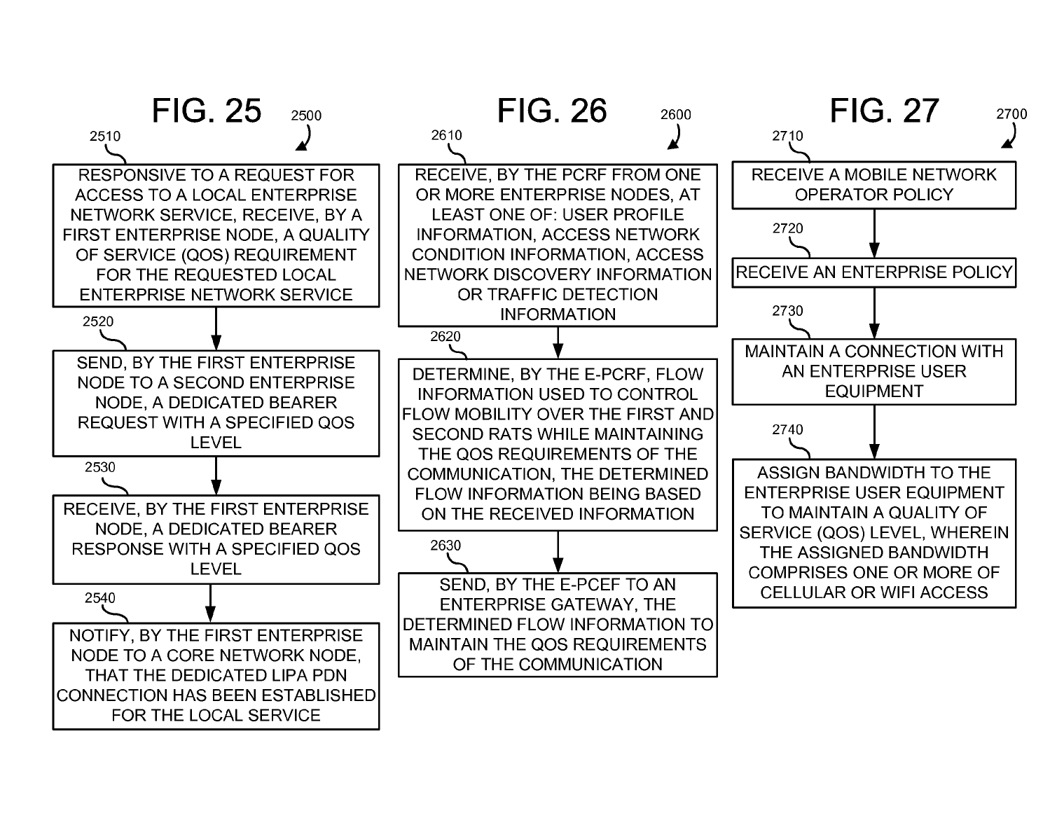

FIG. 25 is a flowchart illustrating another representative method 2500 implemented by an enterprise node.

Referring to FIG. 25, the representative method 2500 may enable the enterprise node to establish a dedicated local IP access (LIPA) packet data network (PDN) connection for a local service. At block 2510, responsive to a request for access to a local enterprise network service, the enterprise node (e.g., a first enterprise node and/or E-PCRF/E-SPR 747 and/or 746) may receive (e.g., from application function (AF) 750) a quality of service (QoS) requirement for the requested local enterprise network service. At block 2520, the first enterprise node 747/746 may send to a second enterprise node (e.g., E-PCEF 738), a dedicated bearer request with a specified QoS level (for example, with packet filters and associated QoS rules). At block 2530, the first enterprise node 747/746 may receive a dedicated bearer response with a specified QoS level (e.g., from the second enterprise node 738). At block 2540, the first enterprise node 747/746 may notify a core network node (e.g., HSS/PCRF 718/711 that the dedicated LIPA PDN connection has been established for the local service (e.g., between the WTRU 102 and the E-CGW 735).

In certain representative embodiments, the first enterprise node 747/746 may send to the core network node 718 and/or 711 a bearer change notification indicating one or more of: (1) a bearer establishment event; (2) a bearer modification event; and/or (3), a bearer release event and may receive from the core network node 718/711 a command to enable or disable the dedicated LIPA PDN connection.

In certain representative embodiments, the core network node 718/711 may include a PCRF 711 and the first enterprise node 747/746 may include an enterprise PCRF (E-PCRF) 747.

FIG. 26 is a flowchart illustrating a representative method 2600 implemented by an E-PCRF 747.

Referring to FIG. 26, the representative method 2600 may include the E-PCRF 747 for managing flows of a communication over at least first and second radio access technologies (RATs). At block 2610, the E-PCRF 747 may receive from one or more enterprise nodes, at least one of: user profile information, access network condition information, access network discovery information, and/or traffic detection information. For example, the E-PCRF 747 may receive user profile information from the E-SPR 746, access network condition information from the E-ANM 736, access network discovery information from the E-ANDSF 748 and/or traffic detection information from the E-PCEF/TDF 738/739. At block 2620, the E-PCRF 747 may determine flow information used to control flow mobility over the first and second RATs while maintaining the QoS requirements of the communication. The flow information may be determined based on the received information in block 2610. At block 2630, the E-PCRF 747 sends to an enterprise gateway (e.g., E-CGW 735), the determined flow information to maintain the QoS requirements of the communication.

In certain representative embodiments, a default local IP access (LIPA) packet data network (PDN) connection may be established via the first RAT (for example, with no guaranteed QoS level for the default LIPA connection). The E-PCRF 747 may control the flow information to enable one or more other RATs to carry flows associated with a communication while maintaining the appropriate composite QoS level for the RATs used for the communication including, for example, the default LIPA connection that does not include any QoS level guarantees.

In certain representative embodiments, the flow information may include one or more packet filters and/or QoS levels associated with particular RATs.

In certain representative embodiments, the flow information may be based on an enterprise policy, which is configured to discriminate between users and/or traffic flows of the users.

FIG. 27 is a flowchart illustrating a representative bandwidth assignment method 2700.

Referring to FIG. 27, the representative method 2700 method may implement hierarchical policies and may include, at block 2710, the receiving a mobile network operator policy. At block 2720, the UE 102 may receive an enterprise policy. At block 2730, a connection with enterprise user equipment may be maintained. At block 2740, bandwidth to the enterprise user equipment may be assigned to maintain a quality of service (QoS) level. For example, the assigned bandwidth may comprise one or more of cellular and/or WiFi access.

In certain representative embodiments, the bandwidth may be assigned according to the enterprise policy when the enterprise policy does not conflict with the mobile network operator policy.

In certain representative embodiments, the QoS level may be determined based on an activity type, (e.g., the activity type may be one of a business activity or a personal activity).

In certain representative embodiments, the bandwidth may be assigned according to the mobile network operator policy when the enterprise policy conflicts with the mobile network operator policy and the bandwidth may be assigned according to the local policy when the enterprise policy does not conflict with the mobile network operator policy.

In certain representative embodiments, the bandwidth may be assigned based on a user identity, (e.g., which may be tracked via the maintained connection).

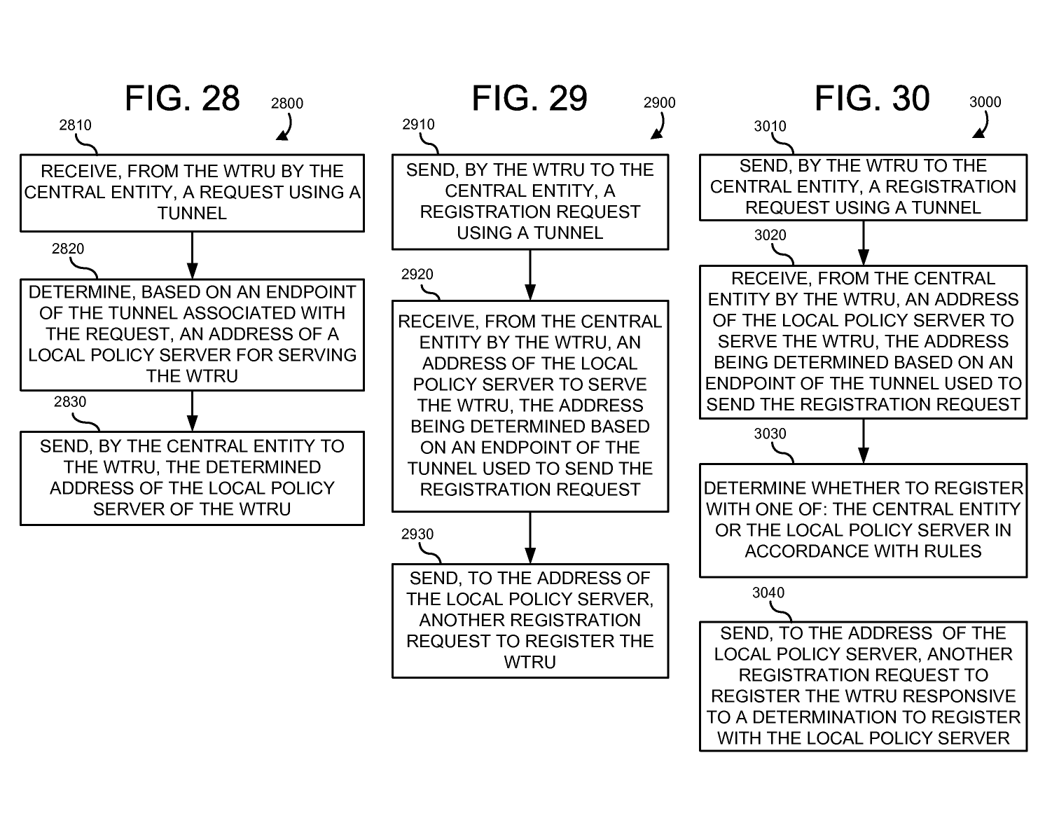

FIG. 28 is a flowchart illustrating a representative method 2800 of local policy server discovery.

Referring to FIG. 28, the representative method 2800 may use a central entity (e.g., CPS 1413) and may include, at block 2810, the central entity 1413 receiving from the WTRU 102, a request using a tunnel At block 2820, the central entity may determine, based on an endpoint of the tunnel associated with the request, an address of a LPS 1448 for serving the WTRU 102. At block 2830, the central entity 1413 may send to the WTRU the determined address of the LPS 1448 serving the WTRU 102.

In certain representative embodiments, the triggering of the LPS discovery may be by a global registration to the central entity 1413 or a periodic update issued by the WTRU 102.

In certain representative embodiments, a secure tunnel may be established between the central entity 1413 and a local gateway 1435.

In certain representative embodiments, the central entity 1413 may send an IP address of the LPS 1448 and an identifier of the WTRU 102 generated by the central entity 1413.

In certain representative embodiments, the central entity 1413 may also send to the LPS 1448, the identifier of the WTRU 102 generated by the central entity 1413 for matching with the identifier sent to the WTRU 102.

In certain representative embodiments, the request may be a request for registration to a policy server and the LPS 1448 may be associated with at least one location or region.

In certain representative embodiments, a re-registration of the WTRU 102 may be triggered, when the WTRU 102 roams outside of the associated location or region and/or responsive to the WTRU 102 roaming outside of the associated location or region. For example, if the WTRU 102 roams outside of a validity area associated with a local policy, the WTRU 102 may be triggered to re-register.

In certain representative embodiments, an expiration time of a registration may be set, when the WTRU 102 is registered with the LPS 1448 (e.g., responsive to the WTRU registering with the LPS 1448) and re-registration of the WTRU 102 may be triggered, responsive to a time since the original registration exceeding the expiration time.

In certain representative embodiments, a central policy associated with the WTRU 102 sent from the central entity 1413 may be different from a local policy associated with the WTRU 102 sent from the local policy server. For example, the central policy may provide appropriate bounds for the local policy such that the rules associated with the local policy are not in conflict with the rules associated with the central policy.

In certain representative embodiments, the central entity 1413 may be an ANDSF server that may send the address of the LPS 1448 to the WTRU 102 over an S14 interface (e.g., using a Simple Object Access Protocol (SOAP)).

In certain representative embodiments, a message (e.g. a SOAP message) to the WTRU 102 may include any of: (1) a validity area field to identify a list of locations where a session is valid, (2) a Redirect_to field to identify the local policy server that the WTRU is preferred to register with; and/or (3) a temporary_id field to identify a temporary identifier for the WTRU used in the redirection.

FIG. 29 is a flowchart illustrating a representative method 2900 using a central entity.

Referring to FIG. 29, the representative method 2900 may use a central entity (e.g., CPS 1413) and may include, at block 2910, the WTRU 102 sending to the central entity 1413 a registration request using a tunnel At block 2920, the WTRU 102 may receive from the central entity 1413 an address of the LPS 1448 to serve the WTRU 102. For example, the address may be determined based on an endpoint of the tunnel used to send the registration request. At block 2930, the WTRU may send to the address of the LPS 1448 another registration request to register the WTRU 102.

In certain representative embodiments, the WTRU 102 may receive a confirmation message confirming registration by the LPS 1448.

In certain representative embodiments, the LPS 1448 may receive an identifier of the WTRU generated by the central entity 1413 and the WTRU 102 may receive an IP address of the LPS 1448 and the identifier of the WTRU 102 generated by the central entity 1413. The WTRU 102 may send the identifier of the WTRU 102 generated by the central entity 1413 to register the WTRU 102 with the LPS 1448.

In certain representative embodiments, the registration request may be sent using a SOAP and may include a SOAP message to the central entity 1413 that may include any of: (1) a Redirect_by field to identify the central entity 1413 that is redirecting the WTRU 102; and/or (3) a temporary_id field to identify an identifier for the WTRU 102 used in the redirection.

In certain representative embodiments, a local gateway 1435 used to manage traffic of the WTRU 102 may be collocated with the LPS 1448.

In certain representative embodiments, the WTRU 102 may select one of the following modes of operation: (1) a localized mode in which requests are sent by the WTRU 102 to the LPS 1448; (2) a centralized mode in which requests are sent by the WTRU 102 to the central entity 1413; and/or (3) a bypass mode in which the WTRU requests are sent to the central entity 1413 regardless of whether the WTRU 102 receives redirection information.

In certain representative embodiments, the WTRU 102 may fall back to registering with the central entity 1413 responsive to failure of the LPS 1448 to respond to a WTRU request.

FIG. 30 is a flowchart illustrating another representative method 3000 using a central entity.

Referring to FIG. 30, the representative method 3000 may use a central entity (e.g., CPS 1413) and may include, at block 3010, the WTRU 102 sending to the central entity 1413, a registration request using a tunnel At block 3020, the WTRU 102 may receive from the central entity 1413 an address of the LPS 1448 to serve the WTRU 102. For example, the address may be determined based on an endpoint of the tunnel used to send the registration request. At block 3030, the WTRU 102 may determine whether to register with one of: the central entity 1413 and/or the LPS 1448 in accordance with rules. At block 3040, the WTRU may send to the address of the LPS 1448, another registration request to register the WTRU 102 responsive to a determination to register with the LPS 1448.

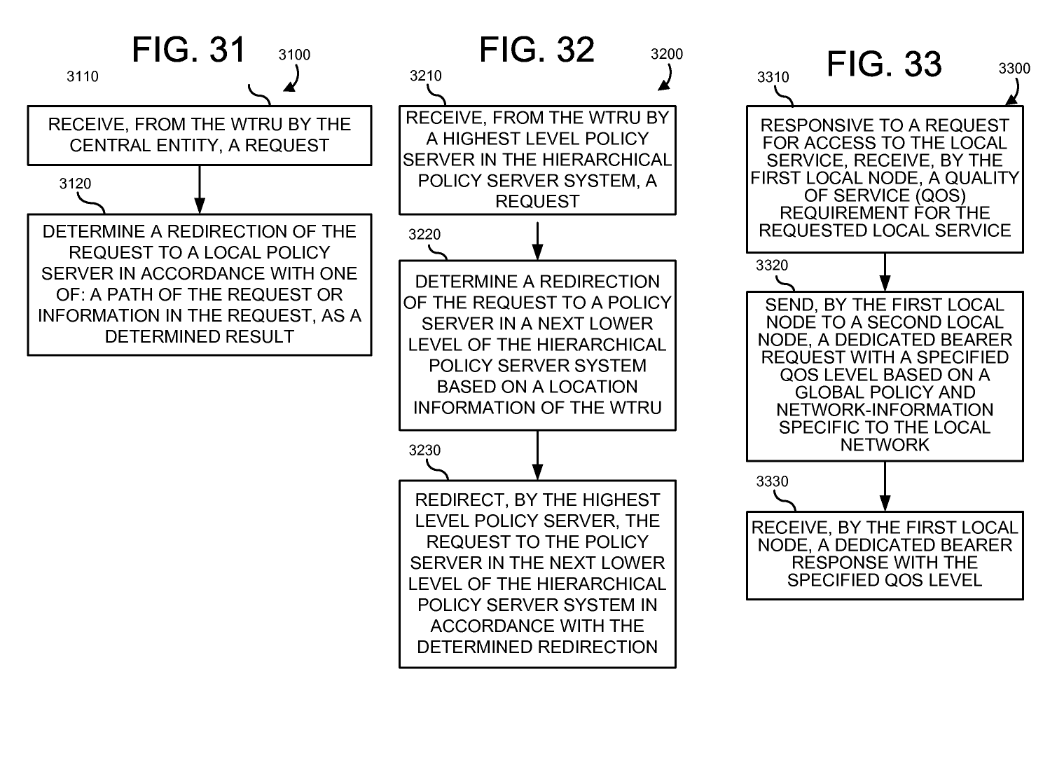

FIG. 31 is a flowchart illustrating a representative method 3100 using a central entity.

Referring to FIG. 31, the representative method 3100 may use a central entity (e.g., CPS 1413) and may include, at block 3110, the central entity 1413 receiving, from the WTRU 102, a request. At block 3120, the central entity may determine a redirection of the request to a LPS 1448 in accordance with one of: a path of the request or information in the request (e.g., as a determined result).

In certain representative embodiments, the central entity 1413 may redirect the request to the LPS 1448 in accordance with the determined result.

In certain representative embodiments, the central entity 1413 may send the redirection request to the WTRU 102 along with location information that identifies where the WTRU 102 is able to roam without triggering re-registration of the WTRU 102.

FIG. 32 is a flowchart illustrating a representative method 3200 using a hierarchical policy server system 1700.

Referring to FIG. 32, the representative method 3200 may include, at block 3210, a highest-level policy server 1710 in the hierarchical policy server system 1700 receiving a request from the WTRU 102.

At block 3220, the highest-level policy server 1710 may determine a redirection of the request to a policy server 1720A/1720B in a next lower level of the hierarchical policy server system 1700 based on location information of the WTRU 102. The highest-level policy server may redirect the request to the policy server (e.g., the first local policy server 1720A) in the next lower level of the hierarchical policy server system 1700 in accordance with the determined redirection.

Although not shown in FIG. 17, it is contemplated that the hierarchal policy server system 1700 may include any number of further levels of policy servers.

It is also contemplated that the redirection of the request may continue from a higher level policy server to a policy server in a next level down and the redirections may be repeated any number of times or until reaching the lowest level policy server (e.g., the local policy server).

It is contemplated that the WTRU 102 may select one or more of the policy servers it was redirected to for registration.

In a representative embodiment, discovery of the local policy server may be triggered by a global registration to the highest-level policy server 1710 or a periodic update issued by the WTRU 102.

In certain representative embodiments, an expiration time of a registration may be set, when the WTRU 102 is registered with any policy server 1720A or 1720B below the highest-level policy server 1710 and a re-registration of the WTRU 102 may be triggered responsive to a time since the registration exceeding the expiration time.

In certain representative embodiments, a policy associated with the WTRU 102 sent from a policy server at a first level of the hierarchical policy server system 1700 may be different from another policy associated with the WTRU 102 sent from a policy server at a second level of the hierarchical policy server system 1700.

In certain representative embodiments, an address of the policy server (e.g., 1720A) in the next lower level may be notified to the WTRU 102 and the determination, redirection and notification may be repeated until notification occurs of the redirection request to a lowest level policy server in the hierarchical policy server system 1700 that manages the location or a region of the WTRU 102.

In certain representative embodiments, the WTRU 102 may determine which one of the notified addresses to use to register with one of the policy servers 1710, 1720A, and 1720B of the hierarchical policy server system 1700.

In certain representative embodiments, the location information associated with some or each policy server 1710, 1720A, and/or 1720B may identify locations or regions where the WTRU 102 may roam without re-registering to another policy server.

In certain representative embodiments, the location of a policy server of a lower level hierarchically below a policy server of a higher level are a subset of the location of the policy server of the higher level.

FIG. 33 is a flowchart illustrating a representative method 3300 using a local node to establish a dedicated local IP access (LIPA) packet data network (PDN) connection for a local service provided via a local network.

Referring to FIG. 33, the representative method 3300 may include, at block 3310, responsive to a request for access to the local service, receiving, by the local node (e.g., an E-PCRF 747), a quality of service (QoS) requirement for the requested local service. At block 3320, the local node 747 may send to a second local node (e.g., E-CGW 735) a dedicated bearer request with a specified QoS level based on a global policy and network-information specific to the local network (e.g., enterprise network 720). At block 3330, the local node may receive a dedicated bearer response with the specified QoS level.

In certain representative embodiments, the global policy may be associated with and may set rules for operation of a WTRU 102 in a global network and the local network 720 may be a part (e.g., a subset) of the global network.

In certain representative embodiments, the local node 747 may notify a core network node (e.g., PCRF 711) that the dedicated LIPA PDN connection has been established for the local service.

In certain representative embodiments, the local node 747 may send to the core network node 711, a bearer change notification indicating one of: (1) a bearer establishment event; (2) a bearer modification event; or (3) a bearer release event; and may receive from the core network node 711, a command to enable or disable the dedicated LIPA PDN connection.

In certain representative embodiments, the core network node 711 may include a policy charging and rules function (PCRF) and the local node 747 may include a local PCRF (L-PCRF).

In certain representative embodiments, the L-PCRF 747 may receive from one or more local nodes 736/737/738/739/740/746, any of: user profile information, access network condition information, access network discovery information or traffic detection information, may determine flow information used to control flow mobility over the dedicated LIPA PDN connection and at least one other connection while maintaining the QoS requirement of the local service. The determined flow information may be based on the received information. The L-PCRF 747 may send to a local gateway 735, the determined flow information.

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer readable medium for execution by a computer or processor. Examples of non-transitory computer-readable storage media include, but are not limited to, a read only memory (ROM), random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU 102, UE, terminal, base station, RNC, or any host computer.

Moreover, in the embodiments described above, processing platforms, computing systems, controllers, and other devices containing processors are noted. These devices may contain at least one Central Processing Unit (“CPU”) and memory. In accordance with the practices of persons skilled in the art of computer programming, reference to acts and symbolic representations of operations or instructions may be performed by the various CPUs and memories. Such acts and instructions may be referred to as being “executed,” “computer executed” or “CPU executed.”

One of ordinary skill in the art will appreciate that the acts and symbolically represented operations or instructions include the manipulation of electrical signals by the CPU. An electrical system represents data bits that can cause a resulting transformation or reduction of the electrical signals and the maintenance of data bits at memory locations in a memory system to thereby reconfigure or otherwise alter the CPU's operation, as well as other processing of signals. The memory locations where data bits are maintained are physical locations that have particular electrical, magnetic, optical, or organic properties corresponding to or representative of the data bits.

The data bits may also be maintained on a computer readable medium including magnetic disks, optical disks, and any other volatile (e.g., Random Access Memory (“RAM”)) or non-volatile (“e.g., Read-Only Memory (“ROM”)) mass storage system readable by the CPU. The computer readable medium may include cooperating or interconnected computer readable medium, which exist exclusively on the processing system or are distributed among multiple interconnected processing systems that may be local or remote to the processing system. It is understood that the representative embodiments are not limited to the above-mentioned memories and that other platforms and memories may support the described methods.

Moreover, the claims should not be read as limited to the described order or elements unless stated to that effect. In addition, use of the term “means” in any claim is intended to invoke 35 U.S.C. §112, ¶6, and any claim without the word “means” is not so intended.

The contents of each of the following references: (1) 3GPP TS 24.302 entitled “Access to the 3GPP Evolved Packet Core (EPC) via non-3GPP access networks Stage 3 (Release 10)”, V10.4.0; (2) IETF RFC 6153 entitled “DHCPv4 and DHCPv6 Options for Access Network Discovery and Selection Function (ANDSF) Discovery”; (3) 3GPP TS 23.402, “Architecture enhancements for non-3GPP accesses (Release 10)”, V10.2.1; (4); and 3GPP TS 33.402 entitled “Security aspects of non-3GPP accesses (Release 10)”, V10.3.0 are incorporated by reference herein.

Suitable processors include, by way of example, a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Application Specific Standard Products (ASSPs); Field Programmable Gate Arrays (FPGAs) circuits, any other type of integrated circuit (IC), and/or a state machine.

A processor in association with software may be used to implement a radio frequency transceiver for use in a wireless transmit receive unit (WTRU), user equipment (UE), terminal, base station, Mobility Management Entity (MME) or Evolved Packet Core (EPC), or any host computer. The WTRU may be used m conjunction with modules, implemented in hardware and/or software including a Software Defined Radio (SDR), and other components such as a camera, a video camera module, a videophone, a speakerphone, a vibration device, a speaker, a microphone, a television transceiver, a hands free headset, a keyboard, a Bluetooth® module, a frequency modulated (FM) radio unit, a Near Field Communication (NFC) Module, a liquid crystal display (LCD) display unit, an organic light-emitting diode (OLED) display unit, a digital music player, a media player, a video game player module, an Internet browser, and/or any Wireless Local Area Network (WLAN) or Ultra Wide Band (UWB) module.

Although the invention has been described in terms of communication systems, it is contemplated that the systems may be implemented in software on microprocessors/general purpose computers (not shown). In certain embodiments, one or more of the functions of the various components may be implemented in software that controls a general-purpose computer.

In addition, although the invention is illustrated and described herein with reference to specific embodiments, the invention is not intended to be limited to the details shown. Rather, various modifications may be made in the details within the scope and range of equivalents of the claims and without departing from the invention.

### Representative Embodiments

In at least one embodiment, a method may be implemented by a local policy server (LPS) collocated with a local network using a central policy server (CPS), and may comprise: receiving, by the LPS, a central policy for operation of a wireless transmit/receive unit (WTRU); and generating, by the LPS from the received central policy, a local policy for operation of the WTRU, the local policy being based on at least the central policy and information associated with the local network.

In at least one embodiment, the CPS may include an access network discovery and selection function (ANDSF) and the LPS may include an enterprise (e.g., and/or local) ANDSF.

In at least one embodiment, the method may comprise: receiving, by the LPS from the WTRU, a request for policy information; and sending, by the LPS to the WTRU, the generated local policy for operation of the WTRU when served by the local network.

In at least one embodiment, the central policy (or central policy information) may be for operation of the WTRU in a first region; and the local policy may be for operation of the WTRU in a second region, which is a portion of the first region.

In at least one embodiment, the first region may include a mobile operator network and the second region may include an enterprise network.

In at least one embodiment, the method may comprise: sending, by the LPS to the CPS, a message including location information to indicate a location of the LPS, the message requesting the central policy information that is relevant to the LPS based on the location information; receiving the requested central policy information; and autonomously setting, by the LPS, the local policy using the received central policy information.

In at least one embodiment, the method may comprise: updating, by the LPS, a management object based on the received central policy information.

In at least one embodiment, a method may be implemented by a local policy server (LPS) collocated with an enterprise network using a central policy server (CPS), and may comprise: obtaining, by the LPS, CPS discovery information; and discovering, by the LPS, the CPS using the CPS discovery information.

In at least one embodiment, the method may comprising: requesting, by the LPS from the CPS, central policy information; receiving, by the LPS from a wireless transmit/receive unit (WTRU), a request for policy information; and sending, by the LPS to the WTRU, an enterprise policy associated with the WTRU, which is based on at least the central policy information.

In at least one embodiment, the method may comprise generating the enterprise policy using the central policy information and at least operational information associated with the enterprise network.

In at least one embodiment, the method may comprise sending, by the LPS to the CPS, a message including location information to indicate a location of the LPS, the message requesting global system policy information; receiving the global system policy information; and autonomously setting, by the LPS, the enterprise policies using the global system policy information.

In at least one embodiment, the receiving of global system policies may include receiving a subset of the global system policies associated with the CPS, the subset of the global system policies being relevant to the location indicated in the message, and the method may comprise updating, by the LPS, a management object based on the received subset of the global system policies.

In at least one embodiment, a method may be implemented by a local node located in a local network using a central node, and may comprise: receiving, by the local node, a notification that a wireless transmit/receive unit (WTRU) is in a vicinity of the local network; determining, by the local node, whether a policy record or profile associated with the WTRU exists in the local network; and on a condition that the policy record or profile for the WTRU does not exist in the local network: requesting, by the local node from the central node, a policy record or profile associated with the WTRU, and receiving, by the local node from the central node, a response including the policy information or profile information associated with the WTRU.

In at least one embodiment, the central node may be located in the core network and may include an access network discovery and selection function (ANDSF) and the local node may include an enterprise ANDSF (E-ANDSF).

In at least one embodiment, the central node may be located in the core network, and may include a policy and charging rules function (PCRF) and the local node may include an enterprise PCRF (E-PCRF).

In at least one embodiment, the local network may be any of: (1) a home network, (2) a mall network, (3) a metro network, (4) a campus network, (5) a school network, (6) an urban network, (7) a stadium network, and/or (8) an airport network.

In at least one embodiment, a method may be implemented by an enterprise node located in an enterprise network, and may comprise: determining, by the enterprise node via signaling intercepted from a wireless transmit/receive unit (WTRU), that the WTRU is in a vicinity of the enterprise network; and sending, by the enterprise node to one or more enterprise entities, a notification to notify the one or more enterprise entities that the WTRU is in the vicinity of the enterprise network.

In at least one embodiment, a method implemented by a wireless transmit/receive unit (WTRU) may comprise: establishing, by the WTRU, a local IP access (LIPA) connection via an enterprise network; requesting, by the WTRU from a local policy server, enterprise-specific policies that include enterprise-specific information; receiving, by the WTRU, the enterprise-specific policies; and selecting, by the WTRU, an access point for service by the enterprise network based on the enterprise-specific policies.

In at least one embodiment, the requesting of the enterprise-specific policies having enterprise-specific information may include requesting access point selection and IP flow routing policies that are based on operational information from one or more enterprise nodes.

In at least one embodiment, a method implemented by a local policy server (LPS) may comprise: sending, by the LPS, a network condition request to an enterprise node including WTRU context information; receiving, by the LPS from the enterprise node, a network condition response; generating a recommendation list based at least the received network condition response; and sending the generated recommendation list to the WTRU.

In at least one embodiment, the method may comprise sending, by the LPS to the WTRU, a request for an access network visibility list indicating one or more access networks in a vicinity of the WTRU; and receiving, by the LPS from the WTRU, the requested visibility list, wherein the recommendation list may be generated based on at least the network conditions response and the received visibility list.

In at least one embodiment, the method may comprise receiving, by the LPS, one of: (1) a request for enterprise-specific policies from the WTRU and/or (2) subscription information and corresponding policies from one or more other enterprise nodes.

In at least one embodiment, a method may be implemented by a first enterprise node to establish a dedicated local IP access (LIPA) packet data network (PDN) connection for a local service, and may comprise: responsive to a request for access to a local enterprise network service, receiving, by a first enterprise node, a quality of service (QoS) requirement for the requested local enterprise network service; sending, by the first enterprise node to a second enterprise node, a dedicated bearer request with a specified QoS level; receiving, by the first enterprise node, a dedicated bearer response with a specified QoS level; and notifying, by the first enterprise node, a core network node that the dedicated LIPA PDN connection has been established for the local service.

In at least one embodiment, the method may comprise sending, by the first enterprise node to the core network node, a bearer change notification indicating one of: (1) a bearer establishment event; (2) a bearer modification event; or (3) a bearer release event; and receiving, by the first enterprise node from the core network node, a command to enable or disable the dedicated LIPA PDN connection.

In at least one embodiment, the core network node may include a policy charging and rules function (PCRF) and the first enterprise node may include an enterprise or local PCRF (E-PCRF or L-PCRF).

In at least one embodiment, a method may be implemented by an enterprise policy charging and rules function (E-PCRF) for managing flows of a communication over at least first and second radio access technologies (RATs), and may comprise: receiving, by the PCRF from one or more enterprise nodes, at least one of: user profile information, access network condition information, access network discovery information or traffic detection information; determining, by the E-PCRF, flow information used to control flow mobility over the first and second RATs while maintaining the QoS requirements of the communication, the determined flow information being based on the received information; and sending, by the E-PCRF to an enterprise gateway, the determined flow information to maintain the QoS requirements of the communication.

In at least one embodiment, a default local IP access (LIPA) packet data network (PDN) connection may be established via the first RAT.

In at least one embodiment, the flow information may include at least a packet filter and a QoS level.

In at least one embodiment, the flow information may be based on an enterprise policy, which may be configured to discriminate between users and/or traffic flows of the users.

In at least one embodiment, a method to implement hierarchical policies may comprise: receiving a mobile network operator policy; receiving an enterprise policy; maintaining a connection with an enterprise user equipment; and assigning bandwidth to the enterprise user equipment to maintain a quality of service (QoS) level, wherein the assigned bandwidth may comprise one or more of cellular or WiFi access.

In at least one embodiment, the bandwidth may be assigned according to the enterprise policy when the enterprise policy does not conflict with the mobile network operator policy.

In at least one embodiment, the method may comprise determining the QoS level based on an activity type, wherein the activity type is one of a business activity or a personal activity.

In at least one embodiment, the bandwidth may be assigned according to the mobile network operator policy when the enterprise policy conflicts with the mobile network operator policy.

In at least one embodiment, the bandwidth may be assigned based on a user identity.

In at least one embodiment, the user identity may be tracked via the maintained connection.

In at least one embodiment, a method of local policy server discovery for a Wireless Transmit/Receive Unit (WTRU) may use a central entity, and may comprise: receiving, from the WTRU by the central entity, a request using a tunnel; determining, based on an endpoint of the tunnel associated with the request, an address of a local policy server for serving the WTRU; and sending, by the central entity to the WTRU, the determined address of the local policy server to the WTRU.

In at least one embodiment, the method may comprise triggering discovery of the local policy server by a global registration to the central entity or a periodic update issued by the WTRU.

In at least one embodiment, the method may comprise establishing, as the tunnel, a secure tunnel between the central entity and a local gateway.

In at least one embodiment, the sending of the determined address of the local policy server may include sending an IP address of the local policy server and an identifier of the WTRU generated by the central entity, and the method may comprise: sending, by the central entity to the local policy server, the identifier of the WTRU generated by the central entity for matching with the identifier sent to the WTRU.

In at least one embodiment, the identifier of the WTRU generated by the central entity may be a temporary identifier, wherein the local policy server does not know any other identifier of the WTRU.

In at least one embodiment, the request may be a request for registration to a policy server, and the method may comprise; associating at least one location or region with the local policy server; and triggering a re-registration of the WTRU responsive to the WTRU roaming outside of the at least one associated location or region.

In at least one embodiment, the method may comprise setting an expiration time of a registration, when the WTRU is registered with the local policy server; and triggering a re-registration of the WTRU responsive to exceeding the expiration time.

In at least one embodiment, a central policy associated with the WTRU from the central entity may be different from a local policy associated with the WTRU from the local policy server.

In at least one embodiment, the central entity may be an Access Network Discovery and Selection Function (ANDSF) server; and the sending of the determined address of the local policy server to the WTRU may be over an S14 interface using a Simple Object Access Protocol (SOAP).

In at least one embodiment, the sending of the determined address of the local policy server to the WTRU may include sending a SOAP message to the WTRU including any of: (1) a validity area field to identify a list of locations where a session is valid, (2) a Redirect_to field to identify the local policy server that the WTRU is preferred to register with; and/or (3) a temporary_id field to identify a temporary identifier for the WTRU used in the redirection.

In at least one embodiment, a method of Wireless Transmit/Receive Unit (WTRU) management may use a central entity, and may comprise: sending, by the WTRU to the central entity, a registration request using a tunnel; receiving, from the central entity by the WTRU, an address of the local policy server to serve the WTRU, the address being determined based on an endpoint of the tunnel used to send the registration request; and sending, to the address of the local policy server, another registration request to register the WTRU.

In at least one embodiment, the method may comprise receiving, by the WTRU, a confirmation message confirming registration by the local policy server.

In at least one embodiment, the local policy server may receive an identifier of the WTRU generated by the central entity; the receiving of the address of the local policy server may include receiving, by the WTRU, an IP address of the local policy server and the identifier of the WTRU generated by the central entity; and the sending of the other registration request to register the WTRU may include sending, by the WTRU, the identifier of the WTRU generated by the central entity to register the WTRU with the local policy server.

In at least one embodiment, the identifier of the WTRU generated by the central entity may be a temporary identifier, wherein the local policy server does not know any other identifier of the WTRU.

In at least one embodiment, the sending of registration request may use a Simple Object Access Protocol (SOAP) and may include sending a SOAP message to the central entity including any of: (1) a Redirect_by field to identify the central entity that is redirecting the WTRU; and/or (3) a temporary_id field to identify an identifier for the WTRU used in the redirection.

In at least one embodiment, the method may include collocating a local gateway used to manage traffic of the WTRU with the local policy server.

In at least one embodiment, the method may comprise selecting, by the WTRU, any one of the following modes of operation: (1) a localized mode in which requests may be sent by the WTRU to the local policy server; (2) a centralized mode in which requests may be sent by the WTRU to the central entity; and (3) a bypass mode in which the WTRU requests may be sent to the central entity regardless of whether the WTRU receives redirection information.

In at least one embodiment, the method may comprise falling back to registering with the central entity responsive to failure of the local policy server to respond to a WTRU request.

In at least one embodiment, a method of Wireless Transmit/Receive Unit (WTRU) management may use a central entity, and may comprise: sending, by the WTRU to the central entity, a registration request using a tunnel; receiving, from the central entity by the WTRU, an address of the local policy server to serve the WTRU, the address being determined based on an endpoint of the tunnel used to send the registration request; determining whether to register with one of: the central entity or the local policy server in accordance with rules; and sending, to the address of the local policy server, another registration request to register the WTRU responsive to a determination to register with the local policy server.

In at least one embodiment, a method of Wireless Transmit/Receive Unit (WTRU) management may use a central entity, and may comprise: receiving, from the WTRU by the central entity, a request; and determining a redirection of the request to a local policy server in accordance with one of: a path of the request or information in the request, as a determined result.

In at least one embodiment, the method may comprise redirecting, by the central entity, the request to the local policy server in accordance with the determined result.

In at least one embodiment, the redirecting of, the request to the local policy server may include sending a redirection request to the WTRU along with location information that identifies where the WTRU is able to roam without triggering re-registration of the WTRU.

In at least one embodiment, a method of Wireless Transmit/Receive Unit (WTRU) management may use a hierarchical policy server system, and may comprise: receiving, from the WTRU by a highest level priority server in the hierarchical policy server system, a request; determining a redirection of the request to a policy server in a next lower level of the hierarchical policy server system based on a location information of the WTRU; and redirecting, by the highest level priority server, the request to the policy server in the next lower level of the hierarchical policy server system in accordance with the determined redirection.

In at least one embodiment, the method may comprise triggering discovery of the local policy server by a global registration to the highest-level policy server or a periodic update issued by the WTRU.

In at least one embodiment, the method may comprise setting an expiration time of a registration, when the WTRU is registered with any policy server below the highest level policy server; and triggering a re-registration of the WTRU responsive to exceeding the expiration time.

In at least one embodiment, a policy associated with the WTRU from a policy server at a first level of the hierarchical policy server system may be different from another policy associated with the WTRU from a policy server at a second level of the hierarchical policy server system.

In at least one embodiment, the method may comprise notifying the WTRU of an address of the policy server in the next lower level, wherein the determination, redirection and notification may be repeated until notification occurs of the redirection request to a lowest level policy server in the hierarchical policy server system that manages the location or a region of the WTRU.

In at least one embodiment, the method may comprise determining, by the WTRU, which one of the notified addresses to use to register with one of the policy servers of the hierarchical policy server system.

In at least one embodiment, the location information associated with each policy server may identify locations or regions where the WTRU can roam without re-registering to another policy server; and the locations of a policy server of a lower level hierarchically below a policy server of a higher level may be a subset of the location of the policy server of the higher level.

In at least one embodiment, a local policy server (LPS) may be collocated with and may manage policies in a local network. The LPS may comprise: a transmit/receive unit configured to receive a central policy from a central policy server (CPS) for operation of a wireless transmit/receive unit (WTRU); and a processor configured to generate from the received central policy a local policy for operation of the WTRU, the local policy being based on at least the central policy and information associated with the local network.

In at least one embodiment, the LPS may include an enterprise access network discovery and selection function (E-ANDSF); the CPS may include an access network discovery and selection function (ANDSF), and the E-ANDSF may be configured to communicate with the ANDSF to request and receive central policies.

In at least one embodiment, the transmit/receive unit may be configured to: receive a request for policy information; and send, towards the WTRU, the generated local policy for operation of the WTRU when served by the local network.

In at least one embodiment, the LPS may be configured to generate the local policy for operation of the WTRU in a region, which is a portion of a region served by the CPS.

In at least one embodiment, a local policy server (LPS) may manage policies in an enterprise network using a central policy server (CPS), and may comprise: a transmit/receive unit configured to obtain CPS discovery information; and a processor configured to discover the CPS using the CPS discovery information.

In at least one embodiment, the transmit/receive unit may be configured to: request from the CPS, central policy information; receive from a wireless transmit/receive unit (WTRU), a request for policy information; and send to the WTRU, an enterprise policy associated with the WTRU, which is based on at least the central policy information.

In at least one embodiment, the processor may be configured to generate the enterprise policy using the central policy information and at least operational information associated with the enterprise network.

In at least one embodiment, the transmit/receive unit may be configured to: send to the CPS, a message including location information to indicate a location of the LPS, the message requesting global system policy information, and receive the global system policy information; and the processor may be configured to autonomously set the enterprise policies using the global system policy information.

In at least one embodiment, the transmit/receive unit may be configured to receive a subset of the global system policies associated with the CPS, the subset of the global system policies being relevant to the location indicated in the message; and the processor may be configured to update a management object based on the received subset of the global system policies.

In at least one embodiment, an enterprise node located in an enterprise network may communicate with a central node, and may comprise: a transmit/receive unit configured to receive a notification that a wireless transmit/receive unit (WTRU) is in a vicinity of the enterprise network; and a processor configured to determine whether a policy record or profile associated with the WTRU exists in the enterprise network, wherein on a condition that the policy record or profile for the WTRU does not exist in the enterprise network, the transmit/receive unit may be configured to request from the central node a policy record or profile associated with the WTRU and to receive from the central node a response including the policy information or profile information associated with the WTRU.

In at least one embodiment, the central node may be located in the core network, and may include an access network discovery and selection function (ANDSF), while the enterprise node may include an enterprise or local ANDSF (E-ANDSF or L-ANDSF)

In at least one embodiment, the E-ANDSF may be configured to communicate with the ANDSF to request and receive central policies.

In at least one embodiment, the central node may be located in the core network and may include a policy and charging rules function (PCRF).

In at least one embodiment, the enterprise node may include an enterprise PCRF (E-PCRF); and the E-PCRF may be configured to communicate with the PCRF to request and receive profile information.

In at least one embodiment, an enterprise node of an enterprise network may comprise: a processor configured to determine via signaling intercepted from a wireless transmit/receive unit (WTRU) that the WTRU is in a vicinity of the enterprise network; and a transmit/receive unit configured to send, to one or more enterprise entities, a notification to notify the one or more local entities that the WTRU is in the vicinity of the enterprise network.

In at least one embodiment, a wireless transmit/receive unit (WTRU), may comprise: a processor configured to: establish a local IP access (LIPA) connection via an enterprise network, and request from a local policy server, enterprise-specific policies that includes enterprise-specific information; and a transmit/receive unit configured to: receive the enterprise-specific policies, and select an access point for service by the enterprise network based on the enterprise-specific policies.

In at least one embodiment, the process may be configured to request access point selection and IP flow routing policies that are based on operational information from one or more enterprise nodes.

In at least one embodiment, a local policy server (LPS) may comprise: a transmit/receive unit configured to: send a network condition request to an enterprise node including WTRU context information, and receive from the enterprise node, a network condition response; and a processor configured to generate a recommendation list based at least the received network condition response, wherein the transmit/receive unit may be configured to send the generated recommendation list to the WTRU.

In at least one embodiment, the transmit/receive unit may be configured to: send, to the WTRU, a request for an access network visibility list indicating one or more access networks in a vicinity of the WTRU; and receive, from the WTRU, the requested visibility list, wherein the recommendation list may be generated based on at least the network conditions response and the received visibility list.

In at least one embodiment, the transmit/receive unit may be configured to receive one of: (1) a request for enterprise-specific policies from the WTRU and/or (2) subscription information and corresponding policies from one or more other enterprise nodes.

In at least one embodiment, an enterprise node for establishing a dedicated local IP access (LIPA) packet data network (PDN) connection for a local service may comprise: a transmit/receive unit configured to: receive a quality of service (QoS) requirement for the requested local enterprise network service, responsive to a request for access to a local enterprise network service; send, to a second enterprise node, a dedicated bearer request with a specified QoS level; receive a dedicated bearer response with a specified QoS level; and notify, to a core network node, that the dedicated LIPA PDN connection has been established for the local service.

In at least one embodiment, the transmit/receive unit may be configured to: send, to the core network node, a bearer change notification indicating one of: (1) a bearer establishment event; (2) a bearer modification event; or (3) a bearer release event; and receive, from the core network node, a command to enable or disable the dedicated LIPA PDN connection.

In at least one embodiment, the enterprise node may include an enterprise PCRF (E-PCRF).

In at least one embodiment, an enterprise policy charging and rules function (E-PCRF) may manage flows of a communication over at least first and second radio access technologies (RATs), and may comprise: a transmit/receive unit configured to receive from one or more enterprise nodes at least one of: user profile information, access network condition information, access network discovery information or traffic detection information; and a processor configured to determine flow information used to control flow mobility over the first and second RATs while maintaining the QoS requirements of the communication, the determined flow information being based on the received information, wherein the transmit/receive unit may be configured to send to an enterprise gateway, the determined flow information to maintain the QoS requirements of the communication.

In at least one embodiment, the flow information may include at least a packet filter and a QoS level and may be based on an enterprise policy, which may be configured to discriminate between users and/or traffic flows of the users.

In at least one embodiment, an enterprise gateway implementing hierarchical policies may comprise: a transmit/receive unit configured to: receive a mobile network operator policy, receive an enterprise policy; and a processor configured to: maintain a connection with an enterprise user equipment, and assign bandwidth to the enterprise user equipment to maintain a quality of service (QoS) level, wherein the assigned bandwidth comprises one or more of cellular or WiFi access.

In at least one embodiment, the processor may be configured to: assign the bandwidth according to the enterprise policy when the enterprise policy does not conflict with the mobile network operator policy; and assign the bandwidth according to the mobile network operator policy when the enterprise policy conflicts with the mobile network operator policy.

In at least one embodiment, the processor may be configured to determine the QoS level based on an activity type, which is one of a business activity or a personal activity.

In at least one embodiment, the processor may be configured to: associate at least one location or region with the local policy server; and trigger a re-registration of the WTRU responsive to the WTRU roaming outside of the at least one associated location or region.

In at least one embodiment, the processor may be configured to: set an expiration time of a registration, when the WTRU is registered with the local policy server; and trigger a re-registration of the WTRU responsive to exceeding the expiration time.

In at least one embodiment, a core network entity may be configured to manage local policy server (LPS) discovery for a wireless transmit/receive unit and may comprise: a transmit/receive unit configured to receive from the WTRU a request using a tunnel; and a processor configured to determine, based on an endpoint of the tunnel associated with the request, an address of a local policy server for serving the WTRU, wherein the transmit/receive unit may be configured to send, to the WTRU, the determined address of the local policy server serving the WTRU.

In at least one embodiment, the processor may be configured to trigger discovery of the local policy server by a global registration to the core network entity or a periodic update issued by the WTRU.

In at least one embodiment, the transmit/receive unit may be configured to communicate via a secure tunnel between the core network entity and an enterprise gateway.

In at least one embodiment, the transmit/receive unit may be configured to: send, to the WTRU, an IP address of the local policy server and an identifier of the WTRU generated by the core network entity; and send, to the local policy server, the identifier of the WTRU generated by the core network for matching with the identifier sent to the WTRU.

In at least one embodiment, the core network entity may be an Access Network Discovery and Selection Function (ANDSF) server communicating over an S14 interface using a Simple Object Access Protocol (SOAP).

In at least one embodiment, a WTRU may comprise: a transmit/receive unit configured to: send, to a central entity, a registration request using a tunnel; receive, from the central entity, an address of a local policy server to serve the WTRU, the address being determined based on an endpoint of the tunnel used to send the registration request; and send, to the address of the local policy server, another registration request to register the WTRU.

In at least one embodiment, the transmit/receive unit may be configured to receive a confirmation message confirming registration by the local policy server.

In at least one embodiment, the processor may be configured to select any one of the following modes of operation: (1) a localized mode in which requests may be sent by the WTRU to the local policy server; (2) a centralized mode in which requests may be sent by the WTRU to the central entity; and (3) a bypass mode in which the WTRU requests may be sent to the central entity regardless of whether the WTRU receives redirection information.

In at least one embodiment, the processor may be configured to fall back to registering with the central entity, responsive to failure of the local policy server to respond to a WTRU request.

In at least one embodiment, a WTRU may be configured to communicate with a central entity, and may comprise: a transmit/receive unit configured to: send, to the central entity, a registration request using a tunnel, and receive, from the central entity, an address of the local policy server to serve the WTRU, the address being determined based on an endpoint of the tunnel used to send the registration request; and a processor configured to determine whether to register with one of: the central entity or the local policy server in accordance with rules, wherein the transmit/receive unit may be configured to send, to the address of the local policy server, another registration request to register the WTRU, responsive to a determination to register with the local policy server.

In at least one embodiment, a core network entity may comprise: a transmit/receive unit configured to receive a request from a wireless transmit/receive unit (WTRU); and a processor is configured to determine a redirection of the request to a local policy server in accordance with one of: a path of the request or information in the request.

In at least one embodiment, the processor may be configured to send a redirection request to the WTRU along with location information that identifies where the WTRU is able to roam without triggering re-registration of the WTRU.

In at least one embodiment, a policy server may communicate with a WTRU, and may comprise: a transmit/receive unit configured to receive, from the WTRU by the policy server as a highest level policy server in the hierarchical policy server system, a request including location information; and a processor configured to: determine a redirection of the request to a policy server in a next lower level of the hierarchical policy server system based on the received location information of the WTRU, and redirect the request to the policy server in the next lower level of the hierarchical policy server system in accordance with the determined redirection.

In at least one embodiment, the processor may be configured to trigger discovery of a lowest level policy server by a global registration to the highest level policy server or a periodic update issued by the WTRU

In at least one embodiment, the processor may be configured to set an expiration time of a registration, when the WTRU is registered with any policy server below the highest-level policy server.

In at least one embodiment, a method may be implemented by a first local node to establish a dedicated local IP access (LIPA) packet data network (PDN) connection for a local service provided via a local network. The method may comprise: responsive to a request for access to the local service, receiving, by the first local node, a quality of service (QoS) requirement for the requested local service; sending, by the first local node to a second local node, a dedicated bearer request with a specified QoS level based on a global policy and network-information specific to the local network; and receiving, by the first local node, a dedicated bearer response with the specified QoS level.

In at least one embodiment, the global policy may be associated with and may set rules for operation of a WTRU in a global network; and the local network may be a part of the global network.

In at least one embodiment, the method may comprise notifying, by the first local node, a core network node that the dedicated LIPA PDN connection has been established for the local service.

In at least one embodiment, the method may comprise: sending, by the first local node to the core network node, a bearer change notification indicating one of: (1) a bearer establishment event; (2) a bearer modification event; or (3) a bearer release event; and receiving, by the first local node from the core network node, a command to enable or disable the dedicated LIPA PDN connection.

In at least one embodiment, the core network node may include a policy charging and rules function (PCRF) and the first local node may include a local PCRF (L-PCRF).

In at least one embodiment, the method may comprise: receiving, by the L-PCRF from one or more local nodes, any of: user profile information, access network condition information, access network discovery information or traffic detection information; determining, by the L-PCRF, flow information used to control flow mobility over the dedicated LIPA PDN connection and at least one other connection while maintaining the QoS requirement of the local service, the determined flow information being based on the received information; and sending, by the L-PCRF to a local gateway, the determined flow information.

In at least one embodiment, a local node for establishing a dedicated local IP access (LIPA) packet data network (PDN) connection for a local service provided via a local network, may comprise: a transmit/receive unit configured to: receive a quality of service (QoS) requirement for the requested local service responsive to a request for access to the local service; send to a second local node a dedicated bearer request with a specified QoS level based on a global policy and network information specific to the local network; and receive a dedicated bearer response with the specified QoS level.

In at least one embodiment, the local node may comprise a processor configured to determine the specified QoS level from the global policy and the network information.

In at least one embodiment, the transmit/receive unit may be configured to notify a core network node that the dedicated LIPA PDN connection has been established for the local service.

In at least one embodiment, the transmit/receive unit is configured to: send to the core network node a bearer change notification indicating one of: (1) a bearer establishment event; (2) a bearer modification event; or (3) a bearer release event; and receive from the core network node a command to enable or disable the dedicated LIPA PDN connection.

In at least one embodiment, the local node may include a local PCRF (L-PCRF).

In at least one embodiment, the transmit/receive unit may be configured to receive from one or more local nodes, any of: user profile information, access network condition information, access network discovery information or traffic detection information; and the processor may be configured to determine flow information used to control flow mobility over the dedicated LIPA PDN connection and at least one other connection while maintaining the QoS requirement of the local service, the determined flow information being based on the received information; and the transmit/receive unit may be configured to send, to a local gateway, the determined flow information.

1. A method implemented by a first local node to establish a dedicated local IP access (LIPA) packet data network (PDN) connection for a local service provided via a local network, the method comprising:
responsive to a request for access to the local service, receiving, by the first local node, a quality of service (QoS) requirement for the requested local service;
sending, by the first local node to a second local node, a dedicated bearer request with a specified QoS level based on a global policy and network-information specific to the local network; and
receiving, by the first local node, a dedicated bearer response with the specified QoS level.

2. The method of claim 1, wherein:
the global policy is associated with and sets rules for operation of a wireless transmit/receive unit (WTRU) in a global network; and
the local network is a part of the global network.

3. The method of claim 1, further comprising notifying, by the first local node, a core network node that the dedicated LIPA PDN connection has been established for the local service.

4. The method of claim 1, further comprising:
sending, by the first local node to the core network node, a bearer change notification indicating one of: (1) a bearer establishment event; (2) a bearer modification event; or (3) a bearer release event; and
receiving, by the first local node from the core network node, a command to enable or disable the dedicated LIPA PDN connection.

5. The method of claim 1, wherein the core network node includes a policy charging and rules function (PCRF) and the first local node includes a local PCRF (L-PCRF).

6. The method of claim 1, further comprising:
receiving, by the L-PCRF from one or more local nodes, any of: user profile information, access network condition information, access network discovery information or traffic detection information;
determining, by the L-PCRF, flow information used to control flow mobility over the dedicated LIPA PDN connection and at least one other connection while maintaining the QoS requirement of the local service, the determined flow information being based on the received information; and
sending, by the L-PCRF to a local gateway, the determined flow information.

7-8. (canceled)

9. The LPS of claim 24, wherein:
the transmit/receive unit is configured to receive from the WTRU, a request for policy information; and send to the WTRU, a generated local policy for operation of the WTRU when served by the local network.

10-17. (canceled)

18. A local node for establishing a dedicated local IP access (LIPA) packet data network (PDN) connection for a local service provided via a local network, comprising:
a transmit/receive unit configured to:
receive a quality of service (QoS) requirement for the requested local service responsive to a request for access to the local service;
send to a second local node a dedicated bearer request with a specified QoS level based on a global policy and network information specific to the local network; and
receive a dedicated bearer response with the specified QoS level.

19. The local node of claim 18, further comprising a processor configured to determine the specified QoS level from the global policy and the network information.

20. The local node of claim 18, wherein the transmit/receive unit is configured to notify a core network node that the dedicated LIPA PDN connection has been established for the local service.

21. The local node of claim 18, wherein the transmit/receive unit is configured to:
send to the core network node a bearer change notification indicating one of: (1) a bearer establishment event; (2) a bearer modification event; or (3) a bearer release event; and
receive from the core network node a command to enable or disable the dedicated LIPA PDN connection.

22. The local node of claim 18, wherein the local node includes an local PCRF (L-PCRF).

23. The local node of claim 18, wherein:
the transmit/receive unit is configured to receive from one or more local nodes, any of: user profile information, access network condition information, access network discovery information or traffic detection information; and
the processor is configured to determine flow information used to control flow mobility over the dedicated LIPA PDN connection and at least one other connection while maintaining the QoS requirement of the local service, the determined flow information being based on the received information; and
the transmit/receive unit is configured to send to a local gateway, the determined flow information.

24. A local policy server (LPS) collocated with and managing policies in a local network, comprising:
a transmit/receive unit configured to receive a central policy from a central policy server (CPS) for operation of a wireless transmit/receive unit (WTRU); and
a processor configured to generate from the received central policy a local policy for operation of the WTRU, the local policy being based on at least the central policy and information associated with the local network.

25. The LPS of claim 24, wherein:
the LPS includes a local access network discovery and selection function (L-ANDSF);
the CPS includes an access network discovery and selection function (ANDSF); and
the L-ANDSF is configured to communicate with the ANDSF to request and receive central policies.

26. The LPS of claim 24, wherein the transmit/receive unit is configured to:
receive a request for policy information; and
send towards the WTRU, the generated local policy for operation of the WTRU when served by the local network.

27. The LPS of claim 24:
wherein:
the processor is configured to determine whether a policy record or profile associated with the WTRU exists in the local network; and
on a condition that the policy record or profile for the WTRU does not exist in the local network, the transmit/receive unit is configured to request from a central policy server central policy record information or profile information associated with the WTRU and receive from the central policy server a response including the central policy record information or profile information associated with the WTRU.

28. (canceled)
